(19) United States
(12) Patent Application Publication
(10) Pub. No.: US 2026/0099552 A1
(43) Pub. Date: Apr. 9, 2026

(54) Computer-Implemented Methods and Systems for Generative Document Merge

(71) Applicant: Quabbin Patent Holdings, Inc., Marlborough, MA (US)

(72) Inventor: Robert Plotkin, Manalapan, NJ (US)

(73) Assignee: Quabbin Patent Holdings, Inc., Marlborough, MA (US)

(21) Appl. No.: 19/338,447

(22) Filed: Sep. 24, 2025

Related U.S. Application Data
(63) Continuation-in-part of application No. 19/054,800, filed on Feb. 15, 2025, now Pat. No. 12,554,924.
(63) Continuation-in-part of application No. 18/995,049, now Pat. No. 12,505,283.
(60) Provisional application No. 63/708,233, filed on Oct. 16, 2024.
(60) Provisional application No. 63/711,078, filed on Oct. 23, 2024.
(60) Provisional application No. 63/712,475, filed on Oct. 27, 2024.
(60) Provisional application No. 63/715,666, filed on Nov. 4, 2024.
(60) Provisional application No. 63/719,137, filed on Nov. 12, 2024.
(60) Provisional application No. 63/817,621, filed on Jun. 4, 2025.

(51) Int. Cl. G06F 16/93

(52) U.S. Cl. CPC G06F 16/93

(57) ABSTRACT

A computer-implemented method and system for recursive generative content generation processes merge templates containing multiple elements within document creation workflows. The method includes receiving a merge template comprising a plurality of elements, and for each element determining whether it is an action definition. If so, the method applies the action definition to generate output by providing a prompt to a language model, and inserts the generated output into a merged document. If not an action definition, the method determines whether the element is a merge field, obtains its value and inserts it into the merged document. Otherwise, the method copies the element into the merged document. The system enables sophisticated document personalization by combining traditional mail merge functionality with AI-driven content generation capabilities.

### CROSS-REFERENCE TO RELATED APPLICATIONS

This application:
claims priority to U.S. Prov. App. No. 63/817,621, filed on Jun. 4, 2025, entitled “Computer-Implemented Methods and Systems for Recursive Generative Content Generation”; and
claims priority to U.S. Prov. App. No. 63/719,137, filed on Nov. 12, 2024, entitled “Computer-Implemented Methods and Systems for Generative Document Revision”; and
claims priority to U.S. Prov. App. No. 63/715,666, filed on Nov. 4, 2024, entitled “Computer-Implemented Methods and Systems for Generative Document Merge”; and
claims priority to U.S. Prov. App. No. 63/712,475, filed on Oct. 27, 2024, entitled “Computer-Implemented Methods and Systems for Generative Text Drag”; all of which are incorporated by reference herein; and
claims priority to U.S. Prov. App. No. 63/711,078, filed on Oct. 23, 2024, entitled “Computer-Implemented Methods and Systems for Generative Text Painter”; and
claims priority to U.S. Prov. App. No. 63/708,233, filed on Oct. 16, 2024, entitled “Computer-Implemented Methods and Systems for Generative Cut and Paste”; all of which are incorporated by reference herein.

This application:
is a continuation-in-part of U.S. application Ser. No. 19/054,800, filed on Feb. 15, 2025, entitled “Computer-Implemented Methods and Systems for Generative Text Painting”; which
is a continuation-in-part of PCT App. No. PCT/US24/50403, filed on Oct. 9, 2024, entitled “Computer-Implemented Methods and Systems for Dynamic Prompt Generation and Integration with Large Language Models for Document Revision”; which
claims priority to U.S. Prov. App. No. 63/588,835, filed on Oct. 9, 2023, entitled “Computer-Implemented Methods and Systems for Dynamic Prompt Generation and Integration with Large Language Models for Document Revision”; all of which are incorporated by reference herein.

This application:
is a continuation-in-part of U.S. application Ser. No. 19/054,800, filed on Feb. 15, 2025, entitled “Computer-Implemented Methods and Systems for Generative Text Painting”; which
claims priority to U.S. Prov. App. No. 63/719,137, filed on Nov. 12, 2024, entitled “Computer-Implemented Methods and Systems for Generative Document Revision”; and
claims priority to U.S. Prov. App. No. 63/715,666, filed on Nov. 4, 2024, entitled “Computer-Implemented Methods and Systems for Generative Document Merge”; and
claims priority to U.S. Prov. App. No. 63/712,475, filed on Oct. 27, 2024, entitled “Computer-Implemented Methods and Systems for Generative Text Drag”; and
claims priority to U.S. Prov. App. No. 63/711,078, filed on Oct. 23, 2024, entitled “Computer-Implemented Methods and Systems for Generative Text Painter”; and
claims priority to U.S. Prov. App. No. 63/708,233, filed on Oct. 16, 2024, entitled “Computer-Implemented Methods and Systems for Generative Cut and Paste”; all of which are incorporated by reference herein.

### BACKGROUND

In an age where technology intertwines with every facet of our lives, the domain of writing is no exception. Traditional pen-and-paper narratives are being augmented and, in some instances, replaced by digital counterparts. With a surge in innovation, various apps have emerged, promising to ease the writing process and enrich the quality of content. But, as with all innovations, while they offer unprecedented advantages, they also come with their own set of challenges.

Modern writing tools encompass a vast spectrum—from basic word processors that mimic the age-old process of manual writing, to advanced AI-driven platforms that can draft entire documents based on a few keywords. These AI platforms, often taking the form of chatbots built on large language models (LLMs), promise to deliver content that is both relevant and coherent, simulating the nuances of human writing. However, their approach often follows a one-size-fits-all methodology, which can miss capturing the unique voice and intent of the individual writer.

While the thrill of getting an entire draft from a chatbot sounds enticing, it often throws writers into a passive role, distancing them from their original vision. Revisions, a cornerstone of the writing process, turn into a cumbersome ordeal, either making writers rewrite vast portions of AI-generated content or revert to demanding a complete rewrite from the bot. Furthermore, chatbots typically follow an “append-only” structure, which limits the dynamic editing and interactive capabilities that writers often seek.

As a result of these constraints, writers find themselves at a crossroads. On one hand, they have access to powerful AI tools that can significantly enhance productivity and inspiration. On the other, they risk losing the personal touch, authenticity, and intricate control over their craft. The available platforms, while useful, tend to box writers into specific workflows, stifling the fluidity and flexibility that the art of writing often demands.

With this backdrop, it becomes evident that while we have made leaps in integrating technology with writing, there is a tangible gap between what is available and what is truly desired and needed.

### SUMMARY

A computer-implemented system and method transform text within documents using a process that enables automated application of action definitions across multiple document elements while maintaining user control. For each element in a document, the system identifies an action definition and applies it to generate output.

The system manifests the generated output to the user for review. Upon user approval of particular outputs, the system revises the corresponding elements based on those outputs. This enables efficient processing of multiple document elements while preserving precise user control over content updates.

The system supports various levels of user involvement in the revision process, from fully automated processing to interactive refinement of generated content. Users can review generated outputs before they are applied to the document, enabling informed decisions about content updates while maintaining document coherence and quality.

The method integrates sophisticated text transformations seamlessly into document creation workflows through a systematic process of identifying applicable action definitions, generating transformed content, and obtaining user approval before implementing revisions. This approach combines the efficiency of automated content generation with the control of manual oversight.

Features include the ability to process multiple document elements systematically, manifest generated content for user review, and selectively apply approved transformations. The system maintains document structure and formatting while enabling complex content transformations through user-configurable action definitions and interactive approval workflows.

The implementation supports both automated and interactive refinement paths, allowing organizations to balance efficiency with the need for precise control over document content and quality. This flexibility enables the system to adapt to different use cases, from high-volume automated document generation to carefully crafted, individually refined documents.

Other features and advantages of various aspects and embodiments of the present invention will become apparent from the following description and from the claims.

### BRIEF DESCRIPTION OF THE DRAWINGS

FIG. 1 is a dataflow diagram of a system for generating text based on a selected document, text, and action definition, and for updating the selected document based on the generated text according to one embodiment of the present invention.

FIG. 2 is a flowchart of a method performed by the system of FIG. 1 according to one embodiment of the present invention.

FIG. 3 is a dataflow diagram of a system for implementing a generative cut and paste feature according to one embodiment of the present invention.

FIG. 4 is a flowchart of a method performed by the system of FIG. 3 according to one embodiment of the present invention.

FIG. 5 is a dataflow diagram of a system for implementing various painting features according to one embodiment of the present invention.

FIG. 6 is a flowchart of a method performed by the system of FIG. 5 according to one embodiment of the present invention.

FIG. 7 is a dataflow diagram of a system for implementing a document merge feature according to one embodiment of the present invention.

FIG. 8 is a flowchart of a method performed by the system of FIG. 7 according to one embodiment of the present invention.

### DETAILED DESCRIPTION

Computer-implemented methods and systems interface with a language model (e.g., a Large Language Model (LLM)) to assist in document revision. The methods and systems allow text to be selected within a document and an action definition to be selected from an action definition library. The text and/or the action definition may be selected using a graphical user interface (GUI). An action defined by the selected action definition is applied to the selected text to generate text. For example, the selected action definition may include a prompt, and the prompt may be combined with the selected text to generate a combined prompt. The combined prompt may be provided as an input to the LLM, which may generate the generated text. The generated text may be integrated into the document.

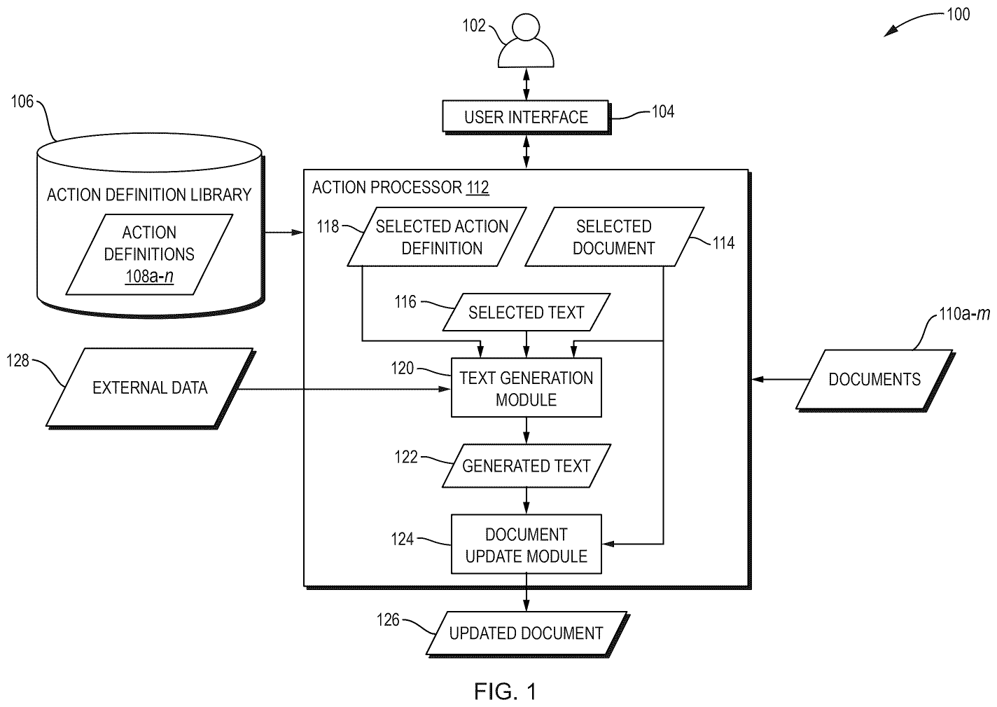

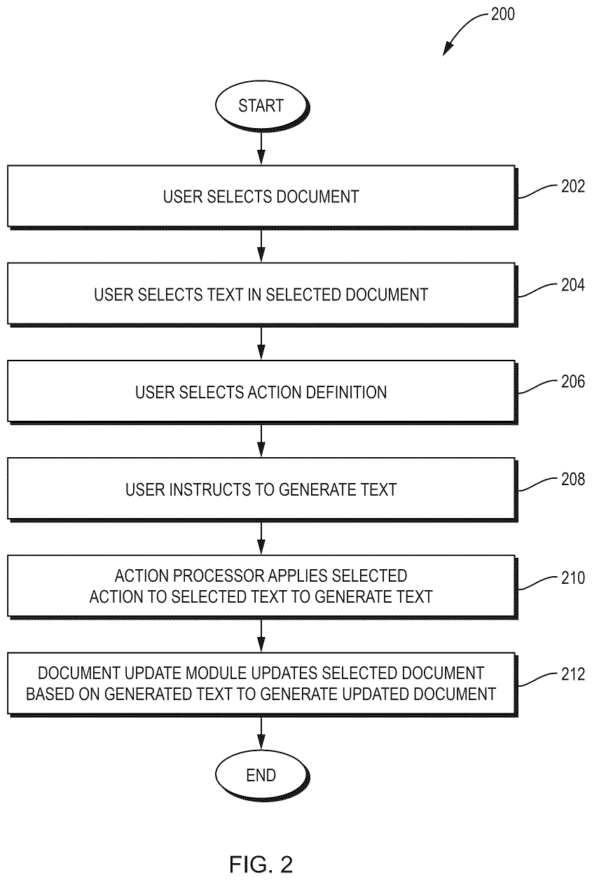

Referring to FIG. 1, a dataflow diagram is shown of a system 100 for generating text based on a selected document, text, and action definition, and for updating the selected document based on the generated text according to one embodiment of the present invention. Referring to FIG. 2, a flowchart is shown of a method 200 performed by the system 100 of FIG. 1 according to one embodiment of the present invention.

The system 100 includes a user 102, who may, for example, be a human user, a software program, a device (e.g., a computer), or any combination thereof. For example, in some embodiments, the user 102 is a human user. Although only the single user 102 is shown in FIG. 1, the system 100 may include any number of users, each of whom may perform any of the functions disclosed herein in connection with the user 102. For example, the functions disclosed herein in connection with the user 102 may be performed by multiple users, such as in the case in which one user performs some of the functions disclosed herein in connection with the user 102 and another user performs other functions disclosed herein in connection with the user 102.

The system 100 also includes a user interface 104, which receives input from the user 102 and provides output to the user 102. The user interface 104 may, for example, include a textual interface (which may, for example, receive textual input from the user 102 and/or provide textual output to the user 102), a graphical user interface (GUI), a voice input interface, a haptic interface, an Application Program Interface (API), or any combination thereof. Although only the single user interface 104 is shown in FIG. 1, the system 100 may include multiple user interfaces, in which case some of the functions disclosed herein in connection with the user interface 104 may be performed by one user interface, and other functions disclosed herein in connection with the user interface 104 may be performed by another user interface.

Although the disclosure herein provides certain examples throughout of inputs that may be received from the user 102 via the user interface 104, such examples are merely provided as illustrations and do not constitute limitations of the present invention. It should be understood for example, that any particular example of an input from the user 102 that is in a particular mode (e.g., text input or interaction with a graphical element in a GUI) may alternatively be implemented by an input from the user 102 in a different mode (e.g., voice).

Because the user 102 may be non-human (e.g., software or a device), the user interface 104 may receive input from, and provide output to, a non-human user. As this implies, the user interface 104 is not limited to interfaces, such as graphical user interfaces, that are conventionally referred to as “user” interfaces. For example, if the user 102 is a computer program, the user interface 104 may provide receive input from and provide output to such a computer program using an interface, such as an API, that is not conventionally referred to as a user interface, and that may not even manifest any output to a human user or that is perceptible directly by a human user.

The term “manifest,” as used herein, refers to generating any output to the user 102 via the user interface 104 in any form based on any data, such as any of the data shown in FIG. 1. The result of manifesting any particular data is referred to herein as a “manifestation” of that data. Manifesting data may include, for example, generating visual (e.g., textual, image, and/or video) output, audio output, and/or haptic output, in any combination. Therefore, any reference herein to generating output to the user 102 via the user interface 104 should be understood to include manifesting that output in any way, even if such a reference refers only to a particular kind of manifesting/manifestation (e.g., “displaying” or “showing” the output to the user 102).

The system 100 includes a plurality of documents 110a-m. Although the system 100 may include only a single document, the plurality of documents 110a-m is shown and described herein for the sake of generality. It should be understood, however, that features disclosed herein may be applied to a single document, rather than to the plurality of documents 110a-m.

The term “document” as used herein refers to any data structure that includes text. For example, a document may include, but is not limited to:
Text within social media interfaces, such as post composition windows, comment/reply interfaces, and profile editors
Text entry fields in communication platforms, including email composition interfaces, messaging applications, and collaboration tools
Web-based content creation interfaces, such as content management systems, blog editors, online forms, and wiki page editors
Text fields within professional and productivity tools, including documentation interfaces, project management tools, and code editor comment sections
Mobile application text interfaces, such as note-taking applications, mobile browser input areas, and form entry fields

These examples illustrate some of the many contexts in which the systems and methods disclosed herein may be applied, though the term “document” is not limited to these examples. As described above, a document may be or be part of a file in a file system, a record, a database table, or a database. A document may include data in addition to text, such as audio and/or visual data.

The user interface 104 may take various forms appropriate to the particular text-based interface being used. For example, when implemented within a social media platform, the user interface 104 may integrate with the platform's existing text composition window. When implemented within a messaging application, the user interface 104 may be integrated directly into the message composition field. These implementations leverage the system's ability to provide textual interfaces, graphical user interfaces, voice input interfaces, haptic interfaces, Application Program Interfaces (APIs), or any combination thereof, as appropriate to the specific use case.

This flexible approach to implementation enables embodiments of the present invention to be adapted to a wide variety of text-based environments and use cases. For instance, in a social media platform, the system might integrate directly with the platform's post composition interface. In a messaging application, the system may integrate with the message composition field. In a web-based email client, the system may be implemented as a browser extension. In a mobile note-taking app, the system may leverage the device's native text input capabilities. These examples demonstrate how the system's flexible architecture supports deployment across diverse text-based interfaces while maintaining the core capabilities described herein.

The system 100 also includes an action processor 112. As will be described in more detail below, the action processor 112 may perform a variety of functions. Although the action processor 112 is shown as a single module in FIG. 1, this is merely an example and does not constitute a limitation of the present invention. More generally, any of the functions disclosed herein as being performed by the action processor 112 may be performed by any one or more modules in any combination, which may include, for example, one or more software applications. As merely one example, selection of text within a document by the action processor 112 may be performed by one software application or module (e.g., a word processing application), while generation of text by the action processor 112 may be performed by another software application or module (e.g., a plugin to the word processing application). As this example illustrates, some functions performed by the action processor 112 may be performed by or in cooperation with one or more conventional components (e.g., a conventional word processing application), while other functions performed by the action processor 112 may be performed by one or more non-conventional components that have been implemented in accordance with the disclosure herein.

The user 102 selects a particular document (referred to herein as the selected document 114) within the plurality of documents 110a-m (FIG. 2, operation 202). For example, the user 102 may provide document selection input to the action processor 112 via the user interface 104, in response to which the action processor 112 may select the selected document 114 from among the plurality of documents 110a-m. The user 102 may select the selected document 114 in any of a variety of ways, such as by opening the selected document 114 in any known manner (e.g., double-clicking on an icon representing the selected document 114 in a GUI) or by selecting a window displaying the selected document 114 in a GUI. Although the selected document 114 is shown as a distinct element in FIG. 1, the selected document 114 may be implemented using a pointer, reference, or other data that identifies the selected document 114 within the plurality of documents 110a-m or which otherwise enables the action processor 112 to perform the functions disclosed herein in connection with the selected document 114.

Operation 202 is optional in the method 200. For example, operation 202 may be omitted if there is only one document in the system 100, if the action processor 112 itself has already selected a document, or if the selected document 114 is implicit or automatically-selectable by the action processor 112 without the user 102's input. Furthermore, even if operation 202 is performed, it may, for example, be performed once to select the selected document 114, and then not be performed again during subsequent instances of the method 200, in which case the original selected document 114 may be used during each such instance without being re-selected.

The user 102 selects text (referred to herein as the selected text 116) within the selected document 114 (FIG. 2, operation 204). For example, the user 102 may provide text selection input to the action processor 112 via the user interface 104, in response to which the action processor 112 may select the selected text 116 within the selected document 114. The user 102 may select the selected text 116 in any of a variety of ways, such as by selecting the selected text 116 in any known manner (e.g., dragging across the selected text 116 within a manifestation of the selected document 114 in a GUI) or by typing or speaking some or all of the selected text 116. The selected text 116 may or may not be in the selected document 114 before the user 102 selects the selected text 116. As an example of the latter, the selected document 114 may not contain the selected text 116, and the user 102 may “select” the selected text 116 by inputting (e.g., typing or speaking) the selected text 116, such as by inputting the selected text 116 into the selected document 114 or elsewhere (e.g., into a text field that does not cause the selected text 116 to be added to the selected document 114).

The user 102 may select the selected text 116 in a variety of other ways, such as by uploading a file containing the selected text 116, selecting a file containing the selected text 116, pasting the selected text 116 from a clipboard, or sending a message (e.g., a text message or an email message) containing the selected text 116.

Although the selected text 116 is shown as a distinct element in FIG. 1, the selected text 116 may be implemented using a pointer, reference, or other data that identifies the selected text 116 within the selected document 114 or which otherwise enables the action processor 112 to perform the functions disclosed herein in connection with the selected text 116. For example, the selected text 116 may be implemented using any known techniques for representing selected text within a document in a word processing application or other text editing application.

The selected text 116 may consist of less than all of the text in the selected document 114. As some examples, the selected text 116 may consist of a single character in the selected document 114 (which may include multiple characters), a single word in the selected document 114 (which may include multiple words), a single sentence in the selected document 114 (which may include multiple sentences), or a single paragraph in the selected document 114 (which may include multiple paragraphs). As another example, the selected text 116 may include all of the text in the selected document 114. In any of these cases, the selected text 116 may include or consist of a single contiguous block of text in the selected document 114.

The selected text 116 may include or consist of a plurality of non-contiguous blocks of text (also referred to herein as “text selections”) in the selected document 114, where each such text selection is contiguous within the selected document 114. For example, if the selected document 114 includes contiguous text blocks A, B, and C (i.e., if the selected document 114 includes text block A, followed immediately by text block B, followed immediately by text block C), then the selected text 116 may include text block A and text block C, but not text block B. The selected text 116 may implement such non-contiguous text selections using, for example, any known method for doing so. Similarly, the system 100 may enable the user 102 to select such non-contiguous text selections within the selected text 116 using, for example, any known method for doing so, such as by enabling the user to drag across a first such text selection in a manifestation of the selected document 114 in a GUI and then to drag across a second such text selection in the manifestation of the selected document 114 in the GUI while holding a predetermined key (e.g., CTRL or SHIFT).

The system 100 includes an action definition library 106, which may include one or a plurality of action definitions 108a-n.

The user 102 selects a particular action definition (referred to herein as the selected action definition 118) within the plurality of action definitions 108a-n (FIG. 2, operation 206). For example, the user 102 may provide action definition selection input to the action processor 112 via the user interface 104, in response to which the action processor 112 may select the selected action definition 118 from among the plurality of action definitions 108a-n. The user 102 may select the selected action definition 118 in any of a variety of ways, such as by selecting the selected action definition 118 from a manifested list of some or all of the action definitions 108a-n in any known manner (e.g., clicking or double-clicking on an icon representing the selected action definition 118 in a GUI) or by typing some or all of a label (e.g., short name) associated with the selected action definition 118. Although the selected action definition 118 is shown as a distinct element in FIG. 1, the selected action definition 118 may be implemented using a pointer, reference, or other data that identifies the selected action definition 118 within the plurality of action definitions 108a-n or which otherwise enables the action processor 112 to perform the functions disclosed herein in connection with the selected action definition 118.

As one particular example, the user 102 may select a manifestation of the selected text 116, and the action processor 112 may manifest a list of some or all of the plurality of action definitions 108a-n, such as in the form of a contextual menu. The action processor 112 may, for example, manifest such a list directly in response to the user 102's selection of the selected text 116, or in response to some additional input (e.g., right-clicking on the selected manifestation of the selected text 116) received from the user 102. The user 102 may then select one of the plurality of action definitions 108a-n from the list in any of the ways disclosed herein, thereby selecting the selected action definition 118. In response to that selection, or in response to some additional input from the user 102, the action processor 112 may perform operation 210. More generally, the action processor 112 may perform operation 210 in connection with any kind of selected text 116 disclosed herein.

In some embodiments, operation 206 may be performed once to select the selected action definition 118, and then not performed again during subsequent instances of the method 200, in which case the original selected action definition 118 may be used during each such instance without being re-selected.

The action definitions 108a-n may not take a form that is amenable to being manifested in ways that are conducive to being understood easily or quickly by users, especially users who are not technically sophisticated. For example, as will be described in more detail below, the action definitions 108a-n may include scripts and/or LLM prompts. Embodiments may facilitate user input for selecting the selected action definition 118 in operation 206 in any of a variety of ways. For example, the action processor 112 may manifest, for each of some or all of the action definitions 108a-n, a corresponding action definition label (also referred to herein as an “action definition short name” or merely as a “short name”) which contains less information than the corresponding action definition itself. For example, an action definition that includes an LLM prompt having 500 characters may have a short name that contains fewer characters (e.g., “Summarize” or “Rephrase”). The action processor 112 may, in operation 206, manifest only the short name of each manifested action definition and not the entire action definition. As an example, the action processor 112 may manifest a list (e.g., a menu or set of buttons) containing a plurality of short names corresponding to some or all of the action definitions 108a-n, such as “Summarize|Rephrase|Expand”. As this example illustrates, different ones of the action definitions 108a-n may have different short names.

The user 102 may select the selected action definition 118 in operation 206 by providing input, via the user interface 104, to the action processor 112, which specifies the selected action definition 118. Such input may take any of a variety of forms. For example, the user 102 may provide that input by selecting the selected action definition 118 from a set of manifestations (e.g., short names) representing some or all of the action definitions 108a-n. For example, if the action processor 112 has manifested a plurality of manifestations of some or all of the action definitions 108a-n (e.g., in the form of a menu or a plurality of buttons), the user 102 may provide the input selecting the selected action definition 118 by selecting (e.g., clicking on, tapping on, or speaking a short name of) one of the plurality of manifestations which corresponds to the selected action definition 118.

In some embodiments, the user 102 may provide input selecting the selected action definition 118 in operation 206 even if the action processor 112 has not manifested any manifestations of the plurality of action definitions 108a-n. For example, the user 102 may select the selected text 116 and then provide input selecting the selected action definition 118 even if the action processor 112 has not manifested any manifestations of the plurality of action definitions 108a-n, such as by speaking or typing input that selects the selected action definition 118 (e.g., a short name of the selected action definition 118).

The user 102 instructs the action processor 112 to generate text that is referred to herein as the generated text 122 (FIG. 2, operation 208). The user 102 may provide this instruction by providing input, via the user interface 104, to the action processor 112, which instructs the action processor 112 to generate the generated text 122. Such input may take any of a variety of forms, such as speaking a voice command, typing a textual command, or providing any kind of input in connection with a GUI element, such as pressing a button or selecting a menu item.

In some embodiments, operation 208 may be omitted or combined with operation 206. For example, the action processor 112 may interpret the user 102's selection of the selected text 116 and/or the user 102's selection of the selected action definition 118 as an instruction to generate the generated text 122, or may otherwise generate the generated text 122 in response to the user 102's selection of the selected text 116 and/or the selected action definition 118, as a result of which the user 102 may not provide any distinct input instructing the action processor 112 to generate the generated text 122. For example, in response to the user 102 selecting the selected text 116 and selecting a short name of one of the action definitions 108a-n, the action processor 112 may generate the generated text 122 (operation 208) without receiving any additional input from the user 102 representing an instruction to generate the generated text 122.

In some embodiments, operation 208 may be performed once to receive an instruction from the user 102 to generate the generated text 122, and then not be performed again during subsequent instances of the method 200. For example, if the selected document 114 and the selected action definition 118 have been selected, the user 102 may provide input, via the user interface 104, to the action processor 112, instructing the action processor 112 to enter an “action mode.” While in the action mode, the action processor 112 may, in response to any text in the selected document 114 being selected as an instance of the selected text 116, perform an action represented by the selected action definition 118 on that instance of the selected text 116 to generate a corresponding instance of the generated text 122, without the user 102 providing an instruction to generate each such instance of the generated text 122. Such an action mode enables the user to select the selected document 114 and selected action definition 118 once, and then to apply an action represented by the selected action definition 118 to a plurality of instances of the selected text 116 in the selected document 114 quickly and easily, without having to select the selected action definition 118 each time and without having to issue an instruction to perform an action represented by the selected action definition 118 each time.

Although certain operations are shown in a particular order in the method 200 of FIG. 2, this order is merely an example and does not constitute a limitation of the present invention.

Operations in the method 200 may be performed in other orders. As some examples:
The user 102 may select the selected text 116 (operation 204) after selecting the selected action definition 118 (operation 206).
The user 102 may select the selected action definition 118 before selecting the selected text 116 (operation 204).
The user 102 may select the selected action definition 118 before selecting the selected document 114 (operation 202).

The system 100 includes a text generation module 120, which applies an action defined by the selected action definition 118 (referred to herein as the “selected action” or a “corresponding action” of the selected action definition 118) to the selected text 116 to generate the generated text 122 (FIG. 2, operation 210). The generated text 122 may include at least some text that is not in the selected text 116. For example, none of the text in the generated text 122 may be in the selected text 116. As another example, the generated text 122 may include some text that is in the selected text 116 and some text that is not in the selected text 116. For example, if the selected text 116 includes text A followed immediately by text B, the generated text 122 may include text A followed immediately by text C, where text B differs from text C. As another example, if the selected text 116 includes text A followed immediately by text B, the generated text 122 may include text C followed immediately by text B, where text A differs from text C. The generated text 122 may include (e.g., consist of) text that is not in the selected document 114.

The system 100 may also include a variety of external data 128. The external data may be external in the sense that it is not contained in the documents 110a-m or in the selected document 114. The external data 128 may, however, be contained within the action processor 112 and/or be outside the action processor 112. The external data 128 may, for example, include data stored in any combination of the following: one or more data structures, files, records, databases, and/or websites. The external data 128 may include static data and/or dynamically-generated data, such as data that is generated dynamically in response to a request from the system 100 (e.g., the action processor 112).

The text generation module 120 may receive some or all of the external data 128 as input and apply the action corresponding to the selected action definition 118 to both the selected text 116 and to some or all of the external data 128. For example, as described in more detail below, the text generation module 120 may modify and/or generate a prompt based on the external data 128, such as by including some or all of the external data 128 in the prompt (e.g., by using some or all of the external data 128 as a value for one or more tokens in the prompt). As another example, the text generation module 120 may include some or all of the external data 128 in the generated text 122, whether or not the text generation module 120 includes that data in a prompt that is used to generate the generated text 122. As an example, the text generation module 120 may use a prompt (which does not include any of the external data 128) to generate the generated text 122 and then update the generated text 122 based on some or all of the external data 128, such as by including some or all of the external data 128 in the generated text 122.

The system 100 may utilize Retrieval Augmented Generation (RAG) to enhance its ability to generate and process text. RAG is a technique that combines the power of large language models with the ability to retrieve and incorporate relevant information from external sources. For example, when creating a prompt based on the selected text 116 and the selected action definition 118, the text generation module 120 may use RAG to retrieve relevant information from the documents 110a-m and/or external data 128. The text generation module 120 may incorporate such retrieved information incorporated into the prompt to provide additional context or guidance to the language model.

As another example, when processing the output generated by the text generation module 120 (e.g., the generated text 122), the text generation module 120 may use RAG to fact-check, augment, and/or refine such output based on information retrieved from trusted sources. The results of such processing may be used to modify the generated text 122 before providing the generated text 122 as output to the user 102. As yet another example, the document update module 124 updates the selected document 114 based on the generated text 122, the document update module 124 may use RAG to ensure consistency with other parts of the document or to incorporate relevant information from related documents.

RAG is merely one example of a variety of techniques that the system 100 may use to improve the output of language models, such as for the purpose of making the generated text 122 as relevant to the user 102 as possible. These techniques aim to customize and enhance the operation of language models to better suit the specific needs of the user 102 and the context of the document being edited. Some examples of such techniques include:
Fine-tuning: The system 100 may use fine-tuned language models that have been further trained on domain-specific data or the user 102's own writing style. The system 100 itself may perform such fine-tuning.
Few-shot learning: By providing the language model with a few relevant examples within the prompt, the system 100 can guide the model to generate more appropriate and contextually relevant text.
LARA (Light and Anti-overfitting Retraining Approach): The system 100 may employ LARA to fine-tune language models in a way that reduces overfitting and maintains the model's general knowledge while adapting it to specific tasks or domains. This can help produce more reliable and contextually appropriate generated text 122.
Prompt engineering: The system 100 may employ advanced prompt engineering techniques, such as chain-of-thought prompting or self-consistency, to elicit more coherent and relevant responses from the language model.
Ensemble methods: The system 100 may combine outputs from multiple language models or multiple runs of the same model to produce more robust and diverse generated text 122.
Context windowing: For longer documents, the system 100 may use sliding context windows to provide the language model with the most relevant surrounding text, ensuring that the generated text 122 maintains coherence with the broader document.

These techniques, either individually or in combination, may be applied by the text generation module 120 and the system 100 more generally to enhance the relevance and quality of the generated text 122. The specific techniques used may depend on factors such as the selected action definition 118, the nature of the selected document 114, and user preferences.

The system 100 includes a document update module 124, which updates the selected document 114 based on the generated text 122 to generate an updated document 126 (FIG. 2, operation 212). The document update module 124 may perform operation 212 in any of a variety of ways. For example, the document update module 124 may perform operation 212 by:
replacing the selected text 116 in the selected document 114 with the generated text 122;
modifying the selected text 116 in the selected document 114 based on the generated text 122; or
adding the generated text 122 to the selected document 114, without modifying the selected text 116 in the selected document 114.

As the above implies, as a result of operation 212, the updated document 126 may include some or all of the generated text 122, even if the selected document 114 did not include the generated text 122.

The system 100 may enable the user 102 to select the update mode of the document update module 124 from among a plurality of update modes (e.g., from the “replace,” “modify,” and “add” modes described above). This feature allows the user 102 to choose how the generated text 122 will be integrated into the selected document 114.

To implement such a user-selectable document update mode, the system 100 may receive document update mode selection input from the user 102, e.g., via the user interface 104. As one example, the system 100 may manifest output, via the user interface 104, representing a plurality of available document update modes, and the user 102 may provide document update mode selection input selection one of the available document update modes (the “selected document update mode”). At any later time, the document update module 124 may perform operation 212 using the selected document update mode.

As another example, the action definitions 108a-n in the action definition library 106 may include a parameter specifying the default update mode for each action definition. The user 102 may be able to override this default setting when selecting an action definition. In any case, when the document update module 124 performs operation 212, the document update module 124 may identify the update mode (e.g., the default update mode or user-overridden update mode) associated with the selected action and perform operation 212 using the identified update mode. As yet another example, the system 100 may include a global setting that determines the default update mode, which the user 102 can override, such as by using a settings menu in the user interface 104. In any case, when the document update module 124 performs operation 212, the document update module 124 may identify the system-wide update mode (e.g., the default system-wide update mode or user-overridden system-wide update mode) and perform operation 212 using the identified update mode.

The document update module 124 may perform operation 212 directly or indirectly on the selected document 114 in any of a variety of ways. For example, the document update module 124 may directly update the selected document 114 in any of the ways disclosed herein to generate the updated document 126, which may be an updated version of the selected document 114, such as in embodiments in which the user 102 edits the selected document 114 in a software application via the user interface 104, and in which the document update module 124 has direct access to the selected document 114. Alternatively, for example, the document update module 124 may provide output (not shown), which specifies modifications to be made to the selected document 114, to another component (not shown), such as a text editing application (e.g., word processing application), which has direct access to the selected document 114, in which case that other component (e.g., text editing application) may update the selected document 114 in the manner specified by the output from the document update module 124 to generate the updated document 126.

Although the updated document 126 is shown distinctly from the selected document 114 in FIG. 1 for ease of illustration, the updated document 126 may be an updated version of the selected document 114, such that no document separate from the selected document 114 is generated by operation 212. Alternatively, for example, operation 212 may generate the updated document 126 as a document that is distinct from the selected document 114, such that, as a result of operation 212, the selected document 114 and the updated document 126 both exist simultaneously (e.g., as distinct documents in a file system), and the selected document 114 may remain unchanged by operation 212.

Regardless of how operation 212 is performed, once the updated document 126 has been generated, the user interface 104 may generate manifest some or all of the updated document 126, thereby generating a manifestation of the updated document 126, which may be provided to the user 102 via the user interface 104. For example, the user interface 104 may manifest (e.g., display) some or all of a portion of the updated document 126 containing the generated text 122 to the user 102.

As mentioned above, operation 212 may include inserting some or all of the generated text 122 into the selected document 114. More generally, the action processor 112 may identify a location (referred to herein as “the selected output location”), whether in the selected document 114 or in another one of the documents 110a-m, and insert the generated text 122 at the selected output location, or otherwise update the selected document 114 at the selected output location based on the generated text 122. The action processor 112 may identify the selected output location in any of a variety of ways, such as automatically or by receiving input from the user 102 via the user interface 104, which specifies the selected output location.

The action processor 112 may receive such input from the user 102 specifying the selected output location in any of a variety of ways. For example, the user 102 may specify the selected output location, such as by clicking or tapping on a manifestation of the selected output location (e.g., in a manifestation of the selected document 114 or another one of the documents 110a-m). The user 102 may provide input specifying the selected output location at any of a variety of times, such as before operation 202; after operation 202 and before operation 204; after operation 204 and before operation 206; after operation 206 and before operation 208; after operation 208 and before operation 210; or after operation 210 and before operation 212. As a particular example, the action processor 112 may perform operation 210 to generate the generated text 122 and then receive input from the user 102 specifying the selected output location. The action processor 112 may, for example, manifest a preview of the updated document 126 to the user 102, showing how the updated document 126 would appear if it were updated based on the user 102's selected output location, and enable the user 102 to accept or reject that version of the updated document 126. If the user 102 rejects that version of the updated document 126, the system 100 may enable the user 102 to select an alternative selected output location, in response to which the action processor 112 may manifest a preview of the updated document 126 to the user 102 based on the alternative selected output location and repeat the process just described. This process may repeated any number of times until the user 102 accepts an output location, at which point the latest version of the updated document 126 is output by the action processor 112 in operation 212.

The selected output location may, but need not be, within the selected document 114 or within any of the documents 110a-m. As another example, the selected output location may be in a new document/window/panel, in which case the action processor 112 may, as part of or after operation 212, generate a new document/window/panel and insert the generated text 122 into the new document/window/panel, which is an example of the updated document 126.

In some embodiments, the document update module 124 uses a language model (e.g., a large language model (LLM)) in the performance of operation 212. For example, each of some or all of the action definitions 108a-n may include, refer to, or otherwise specify one or more corresponding prompts suitable for being provided as input to a language model. Different ones of the action definitions 108a-n may include, refer to, or otherwise specify different corresponding prompts. For any particular action definition, the prompt(s) that the particular action definition includes, refers to, or otherwise specifies is referred to herein as the particular action definition's “corresponding prompt” (even if there are a plurality of such prompts). The selected action definition 118 may have a particular corresponding prompt. Applying the selected action definition 118 to the selected text 116 may include, for example, providing the selected action definition 118's corresponding prompt as an input to a language model to generate some or all of the generated text 122, or otherwise to generate output which the action processor 112 processes to generate some or all of the generated text 122 (whether or not the generated text 122 includes any of the output of the language model).

Before providing input to a language model, the action processor 112 may, for example, generate a prompt based on the selected action definition 118 and the selected text 116 (and, optionally, the selected document 114 and/or the external data 128). Although more examples of how the action processor 112 may generate such a prompt will be described in more detail below, the action processor 112 may, for example, generate a prompt (referred to herein as a “combined prompt”) which includes both some or all of the selected action definition 118's corresponding prompt and some or all of the selected text 116, such as by concatenating the selected action definition 118's corresponding prompt with some or all of the selected text 116. As a particular example, the combined prompt may include or consist of the selected action definition 118's corresponding prompt followed immediately by the selected text 116, or the selected text 116 followed immediately by the selected action definition 118's corresponding prompt. The action processor 112 may provide such a combined prompt to a language model to generate output (e.g., the generated text 122) in any of the ways disclosed herein.

More generally, the action processor 112 may perform any of a variety of actions to generate the combined prompt based on the select action definition 118's corresponding prompt and (optionally) additional data, such as any one or more of the selected text 116, the selected document 114, the documents 110a-m, or the external data 128. As described in more detail below, the actions that the action processor 112 performs to generate the combined prompt may include one or more actions other than “combining” the selected action definition 118's corresponding prompt. As a result, although the resulting prompt is referred to herein as the “combined prompt,” this prompt may also be understood as a “processed prompt” or “final prompt,” meaning that it results from processing the selected action definition 118's corresponding prompt and (optionally) additional data, whether or not such processing is characterizable as “combining” the selected action definition 118's corresponding prompt with other information. Merely one example of such processing is to use a trained model, such as an LLM, to generate the combined prompt based on the selected action definition 118's corresponding prompt and (optionally) additional data.

As implied by the description herein, embodiments of the system 100 may enable the user 102 to cause the action processor 112 to provide the combined prompt to the language model without the user 102 typing or otherwise inputting the combined prompt (or at least the entirety of the combined prompt) to the action processor 112. The action processor 112 may not even manifest the combined prompt (or at least the entirety of the combined prompt) to the user 102. For example, the user 102 may select the selected text 116 and select a short name of the selected action definition 118, which may contain only a small amount of text (e.g., “Summarize”), without inputting (e.g., typing or speaking) the corresponding prompt of the selected action definition 118 (which may contain a large amount of text that is not manifested by the action processor 112 to the user 102), and thereby cause the action processor 112 to: (1) generate a combined prompt based on the corresponding prompt of the selected action definition 118 and the selected text 116; (2) provide the combined prompt as input to a language model to generate output (e.g., the generated text 122); and (3) generate the updated document 126 based on output (e.g., the generated text 122) generated by the language model. Such a process enables the user 102 to leverage the power of a language model to generate the generated text 122, and to generate the updated document 126 based on the generated text 122, without having to manually create or input a prompt to the language model based on the selected text 116, and without having to manually update the selected document 114 based on the output of the language model. Instead, the action processor 112 may perform these operations automatically, thereby not only saving the user 102 manual time and effort, but also increasing the processing efficiency of the system 100 as a whole by enabling it to generate the generated text 122 and to generate the updated document 126 in fewer operations, and more quickly, than would be possible using a conventional chatbot-based approach.

Any language model referred to herein may be of any type disclosed herein. Any language model referred to herein may be contained within the system 100 (e.g., within the action processor 112) or be external to the system 100 (e.g., external to the action processor 112), in which case the system 100 (e.g., the action processor 112) may provide input to and receive output from the language model using a suitable interface, such as an API.

Although the disclosure herein may refer to “a language model,” it should be understood that embodiments of the present invention may use a plurality of language models. As a result, any disclosure herein of performing multiple operations using a language model (e.g., generating a first instance of the generated text 122 using a language model and generating a second instance of the generated text 122 using a language model) should be understood to include either using the same language model to perform those multiple operations or to using different language models to perform those multiple operations. Embodiments of the present invention may select a particular language model to perform any operation disclosed herein in any suitable manner, such as automatically or based on input from the user 102 which selects a particular language model for use.

Any language model disclosed herein may (unless otherwise specified) include one or more language models, such as any one or more of the following, in any combination:
a unigram language model;
an n-gram language model;
an exponential language model;
a generative language model;
an autoregressive language model; and
a neural network language model.

Any language model disclosed may, unless otherwise specified, include at least 1 billion parameters, at least 10 billion parameters, at least 100 billion parameters, at least 500 billion parameters, at least 1 trillion parameters, at least 5 trillion parameters, at least 25 trillion parameters, at least 50 trillion parameters, or at least 100 trillion parameters.

Any language model disclosed herein may, unless otherwise specified, have a size of a least 1 gigabyte, at least 10 gigabytes, at least 100 gigabytes, at least 500 gigabytes, at least 1 terabyte, at least 10 terabytes, at least 100 terabytes, or at least 1 petabyte.

Any language model disclosed herein may, for example, include one or more of each of the types of language models above, unless otherwise specified. As a particular example, any language model disclosed herein may, unless otherwise specified, be or include any one or more of the following language models, in any combination:
Any language model in the GPT-n series of language models (such as any language model in the GPT-1, GPT-2, GPT-3, or GPT-4 families) available from OpenAI Incorporated of San Francisco, California;
any version of the Language Model for Dialogue Applications (LaMDA), Generalist Language Model (GLaM), Pathways Language Model (PaLM), or Gemini, available from Google LLC of Mountain View, California;
any version of the Gopher language model, available from DeepMind Technologies of London, United Kingdom;
any version of the Turing-NLG (Turing Natural Language Generation) language model, available from Microsoft Corporation of Redmond, Washington;
any version of the Megatron Language Model (Megatron-LM), available from Nvidia Corporation of Santa Clara, California; and
any version of the Large Language Model Meta AI (LLaMA), available from Meta Platforms, Inc. of Menlo Park, California.

The action definitions 108a-n may take any of a variety of forms, some of which will now be described. Different ones of the action definitions 108a-n may be of different types. In other words, the types of action definitions 108a-n disclosed herein may be mixed and matched within the action definition library 106. Any particular embodiment of the present invention may implement some or all of the action definition types disclosed herein. Types of action definitions 108a-n may include, for example, any one or more of the following, in which the examples of prompts and user interfaces are merely examples and do not constitute limitations of embodiments disclosed herein:
Simple Text Prompts:
   Description: These are plain text prompts with no dynamic content (e.g., tokens or scripts). Examples are: “Expand on the following text:”, “Summarize the following text:”, and “Rewrite the following text to be understandable by a five year-old:”.
   UI/UX Approach: Each simple text prompt may, for example, be displayed as a corresponding UI element (e.g., list item or button) with a distinct label, such as the corresponding action definition's short name. Clicking such a UI element causes the corresponding action definition to be selected as the selected action definition 118.
      Selection: Single-click.
      Viewing: Hovering over the UI element may display a tooltip with details (e.g., a description of the corresponding prompt and/or the full text of the corresponding prompt).
      Editing: Right-click or a small adjacent “edit” icon opens a simple text box, which enables the user 102 to edit the corresponding prompt and then save the edits.
Tokenized Prompts:
   Description: Prompts that contain placeholders (tokens) that can be dynamically replaced with content from any of a variety of sources, such as the selected text 116, the selected document 114, the documents 110a-m, input from the user 102 via the user interface 104, and/or external data 128.
   UI/UX Approach: Displayed similarly to simple text prompts, but with indications (e.g., colored/italicized) to suggest dynamic content.
      Selection: Single-click.
      Viewing: Tokens highlighted or underlined. Hovering over them shows a tooltip with details.
      Editing: Clicking on the token allows the user to select an alternative or input their own.
Alternative Take Prompts (an example of “compound prompts”):
   Description: Multiple prompts, bundled in one prompt, representing alternatives for producing varied outputs. Each prompt within an alternative take prompt is an example of what is referred to herein as a “component prompt.” Each component prompt within an alternative take prompt may be of any of the prompt types disclosed herein (e.g., simple, tokenized, compound, or scripted). When the action processor 112 executes an alternative take prompt, the action processor 112 performs operation 210 once for each of some or all of the alternative take prompt's component prompts in connection with the selected text 116, thereby generating a plurality of instances of the generated text 122 (one for each of some or all of the alternative take prompt's component prompts). The action processor 112 then enables the user 102 to select one or more of the plurality of instances of the generated text 122, in response to which the action processor 112 performs operation 212 on each instance of the generated text 122 selected by the user 102.
   UI/UX Approach: Displayed as a dropdown or expandable list.
      Selection: Clicking the compound prompt reveals components.
      Viewing: Expandable sections allow users to see each alternative.
      Editing: Users can add, remove, or modify each component prompt.
Chained Prompts (an Example of “Compound Prompts”):
   Description: Multiple prompts, bundled in one prompt, which are sequenced to execute in a specific order. Each prompt within a chained prompt is an example of a component prompt. Each component prompt within a chained prompt may be of any of the prompt types disclosed herein (e.g., simple, tokenized, compound, or scripted). When the action processor 112 executes a chained prompt, the action processor 112 performs operation 210 on the first of the chained prompt's component prompts in connection with the selected text 116, thereby generating a first instance of the generated text 122. The action processor 112 then performs operation 210 again, but uses the first instance of the generated text 122 to play the role of the selected text 116, thereby generating a second instance of the generated text 122. In other words, the action processor 112 uses the output of one instance of operation 210 as an input to the next instance of operation 210. This continues for all of the chained prompt's component prompts in order, at which point the most recent instance of the generated text 122 is used as the generated text 122 in operation 212.
   UI/UX Approach: Displayed as a list with visual indications of the sequence (numbers/arrows).
      Selection: Single-click to apply the sequence.
      Viewing: Steps could be expandable or displayed with details on hover.
      Editing: Drag-and-drop for rearranging. Individual step editing similar to simpler prompt types.
Scripted Prompts:
   Description: Prompts, written in a scripting language, which may contain any one or more of the following, in any combination: prompts of any of the types disclosed herein, conditions, loops, and multifaceted logic. A scripted prompt may include at least one instruction to apply a corresponding action of the selected action definition 118 to the selected text 116, and may include: any number of instructions that perform actions other than the corresponding action of the selected action definition 118; and any number of instructions that perform actions that do not apply to the selected text 116. More generally, a scripted prompt may include instructions for performing any arbitrary action, whether or not related to the selected document 114, the selected text 116, or the selected action definition 118. As this implies, if the selected action definition 118 includes or otherwise specifies a scripted prompt, then operation 210 may include executing the script in that scripted prompt. As this implies, operation 210 is not limited to providing a prompt as input to a language model, but may include executing a script, which may include performing operations other than providing a prompt as input to a language model and operations other than performing inferencing using a language model.
UI/UX Approach: These may, for example, be represented with unique icons or visuals to distinguish their complexity.
   Selection: Single-click, but with warnings or confirmations due to their complexity.
   Viewing: A dedicated “view mode” that expands the script in a readable, perhaps even flowchart-like format.
   Editing: A specialized script editor, potentially with hints, autofill, or predefined logic blocks to assist less technically inclined users.

What is described herein as an “alternative take prompt” may be implemented in any of a variety of ways. For example, a plurality of component prompts may be stored within a single action definition, in which case the action processor 112 may perform operation 210 once for each of some or all of the plurality of stored component prompts. As another example, the system 100 may enable the user 102 to select a plurality of component prompts using any of the techniques disclosed herein for selecting the selected action definition 118. The action processor 112 may perform operation 210 once for each of the plurality of component prompts selected by the user 102, whether or not those component prompts are stored within an action definition or the action definition library 106. Such an “on the fly” or “one time use” alternative take prompt may provide the user 102 with convenience and flexibility in executing alternative take prompts without the need to define and store such prompts in the action definition library 106 in advance.

An alternative take prompt may be implemented by executing even a single instance of the selected action definition 118, in any of the ways disclosed herein, a plurality of times to produce a plurality of instances of the generated text 122. Such instances of the generated text 122 may differ from each other because, for example, of the stochastic nature of LLMs and other models that may be used by the text generation module 120 to perform operation 210. As this example illustrates, an alternative take prompt may, but need not, include a plurality of prompts in order to achieve the effect of alternative takes.

The system 100 may handle the multiple outputs generated by an alternative take prompt in at least two different ways. As another example, the system 100 may provide all of the outputs to the user 102 for review via the user interface 104. The user 102 may then select one or more of these outputs, and the system 100 may use the selected output(s) to update the selected document 114 in operation 212. This approach allows for maximum user control and decision-making in the document revision process.

Alternatively, for example, the text generation module 120 may process the plurality of outputs generated using an alternative take prompt internally to produce a single instance of the generated text 122. The text generation module 120 may employ various methods to process multiple outputs internally, such as any one or more of the following:
Concatenation: The text generation module 120 may combine all outputs sequentially to create a single, comprehensive instance of the generated text 122.
Best Output Selection: The text generation module 120 may use one or more predefined criteria or machine learning algorithms to evaluate and select the “best” output among the alternatives. This may, for example, be based on factors such as relevance, coherence, or alignment with the user 102's writing style.
Synthesis: The text generation module 120 may analyze the multiple outputs and create a new, synthesized text that incorporates the most relevant and/or high-quality elements from each alternative.
Voting or Consensus: If the alternative take prompt generates similar ideas across multiple outputs, the text generation module 120 may identify common themes or phrases and construct a single output based on the most frequently occurring elements.

Any of the methods described above for generating a single instance of the generated text 122 based on multiple outputs of an alternative take prompt may, for example, include using a language model (e.g., an LLM) to generate that single instance of the generated text 122.

The method for handling multiple outputs of an alternative take prompt may, for example, be configured as a system-wide setting, specified within individual action definitions, or selected by the user 102 on a case-by-case basis through the user interface 104. This flexibility allows the system 100 to adapt to different user preferences and document revision scenarios, maintaining a balance between automated efficiency and user control.

As the types of prompts disclosed above illustrate, the text generation module 120 may act as a function which takes the selected text 116 as an input to the function, and which evaluates the function on the selected text 116 to generate the generated text 122. Such a function may have, as inputs, not only the selected text 116 but also one or more other inputs, such as any of the other values disclosed herein. For example, the selected text 116 may include or consist of a plurality of non-contiguous text selections in the selected document 114. Each of those non-contiguous text selections may be inputs to a single functions that is evaluated by the text generation module 120 to generate the generated text 122. As a particular example, if a tokenized prompt includes two tokens, then a first of the text selections in the selected text 116 may serve as the value for a first one of the two tokens in the tokenized prompt, and a second one of the text selections in the selected text 116 may serve as the value for a second one of the two tokens in the tokenized prompts. The text generation module 120 may generate the generated text 122 based on the resulting tokenized prompt (with the first and second text selections substituted into it).

As used herein, the term “prompt” includes not only prompts that are suitable to be provided to a language model, but more generally to any kind of action definition described herein, whether or not such an action definition includes or consists of content (e.g., text) that is suitable for being provided to a language model. For example, as used herein, the term “prompt” includes not only literal text prompts that are suitable to be provided directly to a language model, but more generally encompasses any form or representation of an action definition that can be used to generate output from a language model or other text generation system. This includes, but is not limited to:
Vector representations or embeddings derived from or representing prompts
Transformed or processed versions of prompts
Numerical or mathematical representations of prompts
Compressed or encoded forms of prompts
Any intermediate representations generated during processing
Any combination of the above forms

Embodiments of the present invention may, for example, transform prompts into any such alternative representations before using them to generate output. Such transformations may occur at any stage of processing, whether during action definition creation, storage, or execution. The system may store and use prompts in their original form, in transformed forms, or both.

This broad definition of prompts aligns with the system's support for sophisticated processing approaches, including multi-stage transformations, hybrid processing combining language model and non-language model stages, and various technical implementations across distributed systems. The system may process prompts using any combination of: traditional language model interactions, vector/embedding-based processing, fine-tuned model approaches, few-shot learning techniques, ensemble methods, context-aware processing, and/or any other suitable technical approach for generating output based on prompts in any form.

As mentioned above, a tokenized prompt may include one or more tokens. Similarly, a compound prompt or scripted prompt may include one or more tokens. Any particular prompt may include one or more tokens of any type(s), in any combination. Examples of token types include the following:
Selected Text Token:
   Represents the selected text 116.
   An example of a prompt that includes a selected text token is: “Summarize the following text: {selected_text}.”
Contextual Tokens:
   Pulls from a broader context within or related to the selected document 114, such as the paragraph before/after the selected text, a specified portion (e.g., sentence, paragraph, or section) of the selected document 114, a specified feature (e.g., title) of the selected document 114, or specified metadata (e.g., creation date, last modified date, owner) of the selected document 114.
   An example of a prompt that includes a contextual token is: “Considering the following: {previous_paragraph}, elaborate on {selected_text}.”
Date & Time Tokens:
   Automatically fetches a date and/or time, such as the current date and/or time.
   An example of a prompt that includes a date and time token is: “In the context of {selected_text}, what have been its impacts until {today}?”
User Profile Tokens:
   Refers to user's stored information, such as name, preferences, or writing style.
   An example of a prompt that includes a user profile token is: “Rephrase {selected_text} in the following writing style: {user_writingstyle}.”
Document Metadata Tokens:
   Refers to metadata of the selected document 114 and or the documents 110a-m, such as document title, author, or word count. Such metadata may, for example, include any metadata that may be defined, generated, and accessed via a Document Object Model (DOM) or similar structure(s) that represent document data and metadata in an accessible and modifiable form.
   An example of a prompt that includes a document metadata token is: “Incorporate {selected_text} into the theme of {document_title}.”
Genre/Style Tokens:
   Offers a tone or style shift based on genres such as humor, academic, journalistic, or romance.
   An example of a prompt that includes a user genre/style token is: “Rewrite {selected_text} in a {genre} tone.”
Reference Tokens:
   For cases where users want to correlate selected text with external references or sources.
   An example of a prompt that includes a reference token is: “Compare {selected_text} with known literature on {reference_topic}.”
Numeric Tokens:
   For representing specific numbers or numerical ranges.
   An example of a prompt that includes a numeric token is: “Summarize {selected_text} in no more than {max_words} words.”
Language Tokens:
   For representing identifiers of particular languages.
   An example of a prompt that includes a language token is: “Translate {selected_text} into {specified_language}.”
Location Tokens:
   Refers to specific locations or regions, potentially useful for location-based content.
   An example of a prompt that includes a location token is: “Adapt {selected_text} for an audience in {specified_location}.
Historical/Temporal Tokens:
   For referencing specific historical periods or future predictions.
   An example of a prompt that includes a historical/temporal token is: “How might {selected_text} have been written in the {specified_era}?”
Feedback Loop Tokens:
   A token that allows users to refer to previous outputs or iterations in the current session/chat/iteration of the method 200.
   An example of a prompt that includes a feedback loop token is: “Considering my last request, refine {selected_text}.
Emotion Tokens:
   Adjusts content based on specified emotions or feelings.
   An example of a prompt that includes an emotion token is: “Describe {selected_text} in a {mood} mood.”

As the above examples of token types imply, embodiments of the present invention may employ any of a wide variety of token types. A token may appear at any location within a prompt. For example, a token may appear after an instance of plain text in the prompt, before an instance of plain text in the prompt, or between two instances of plain text in the prompt. As another example, two tokens may appear contiguously within a prompt. As these examples indicate, a prompt may include plain text and tokens in sequences such as “<token><plaintext>”, “<plaintext><token>”, “<token><plaintext><token>”, “<plaintext><token><plaintext>”, “<token><token>”, or “<plaintext><token><token>”, merely as examples. The user 102 may use any of the techniques disclosed herein to insert one or more tokens at any desired location(s) within a prompt. These features of tokens are applicable not only to the “tokenized prompt” action definition type disclosed herein, but to any type of action definition that is capable of including one or more tokens.

When performing operation 210, the action processor 112 may, for each token in the prompt to be provided as input to the language model, obtain a value for that token and replace the token with the obtained value in the prompt. The action processor 112 may then provide the resulting resolved prompt (which is an example of a “combined prompt” as that term is used herein) to the language model in operation 210.

In addition to simple tokens that are replaced with a single value, the system 100 may support tokens with multiple replaceable parameters. These multi-parameter tokens allow for more complex and flexible token replacement within prompts. A multi-parameter token may take the following general form:
{token_name(param1, param2, . . . , paramN)}
   where “token_name” is the identifier for the token, and “param1” through “paramN” are individual parameters that can each be replaced with their own values.

For example, a date range token might look like this:
{date_range(start_date, end_date, format)}

When processing such a token, the text generation module 120 may replace each parameter with its corresponding value. The action processor 112 may obtain values for each parameter using any of the methods described for single-value tokens, including automatic retrieval, user input, or derivation from other data sources.

The action processor 112 may obtain such token values in any of a variety of ways. For example, the action processor 112 may obtain a value of any particular token automatically, such as by using any of a variety of known techniques. For example, certain tokens, such as the user's preferred genre, may be stored in a variable of a data structure, from which the action processor 112 may retrieve the token's value automatically. As another example, certain tokens, such as a token representing the current date, may have values that the action processor 112 may obtain by executing a function associated with the token. As another example, the action processor 112 may generate a token's value using a trained model, such as a large language model (LLM). The model used to generate a token's value may be the same as or different from the model used by the text generation module 120 to generate the generated text 122. Once the action processor 112 has obtained or generated the token's value, it may substitute the token with the resulting value.

As yet another example, certain tokens may be designated as having a “manual input” property, while other tokens may be designated as having an “automatic input” property. A single prompt may include both one or more “manual input” tokens and one or more “automatic input” tokens. When the action processor 112 encounters a token that has the manual input property in operation 210, the action processor 112 may elicit input from the user 102, such as by displaying a popup window or dialog box requesting a value for the token from the user 102. In response, the user 102 may provide input representing or otherwise specifying such a value in any manner (such as by typing, speaking, or selecting such a value from a list). The action processor 112 may then use the value received from the user 102 as the value for the token, or may derive a value for the token from the value received from the user 102, and may then use that value in any of the ways disclosed herein in connection with operation 210.

Assigning properties such as “manual input” and “automatic input” to tokens is merely one way to implement the system 100 and is not a limitation of the present invention. Alternatively, for example, the action processor 112 may, at the time of performing operation 210, ask the user 102 to indicate, for each token in the prompt to be provided to the language model, whether the value for that token should be obtained automatically by the action processor 112 or be input manually by the user 102, in response to which the action processor 112 may obtain each token value in accordance with the user's indications.

As yet another example, however the action processor 112 generates the prompt to be provided to the language model, including obtaining initial values for any tokens within that prompt, the action processor 112 may manifest the prompt to the user 102 via the user interface 104, thereby providing the user 102 with an overridable preview of that prompt, which is referred to herein as an “initial prompt.” The user 102 may then provide, via the user interface 104, any of a variety of input to revise the initial prompt and thereby generate a final prompt, such as by revising token values in the initial prompt and/or revising non-token text in the initial prompt. The action processor 112 may then provide the final prompt to the language model within operation 210.

Prompts of the various kinds disclosed herein may be created to perform a wide range of functions. Some particular, non-limiting examples of use cases for tokenized prompts include:
Rewrite Sentence as a Question:
   Tokenized Prompt: “Rewrite the following sentence as a question: {sentence}”
   Use Case: This is particularly useful when writers are framing research questions or looking to introduce more interactive or engaging language in their writing. It can help transform declarative statements into questions for effect.
Summarize Paragraph:
   Tokenized Prompt: “Summarize the following paragraph: {paragraph}”
   Use Case: Useful for condensing information, this prompt would benefit academic writers, journalists, or anyone who needs to distill long pieces of text into shorter versions without losing essential meaning.
Generate Title:
   Tokenized Prompt: “Create a title for the following blog post: {first_sentence_of_post}”
   Use Case: Bloggers or content creators could use this to come up with catchy, relevant titles for their articles based on the opening sentence or thesis.
Compare and Contrast:
   Tokenized Prompt: “Compare and contrast {entity1} with {entity2}”
   Use Case: Students writing essays or analysts preparing reports can use this prompt to generate comprehensive compare-and-contrast analyses. It could help structure arguments or evaluations in an organized manner.
Thesaurus Substitute:
   Tokenized Prompt: “Provide synonyms for the following word: {word}”
   Use Case: For any writer looking to diversify vocabulary in their text, this prompt can offer alternate word choices to replace repetitive or simplistic terms.
Generate Conclusion:
   Tokenized Prompt: “Based on the following arguments, generate a conclusion: {arguments_list}”
   Use Case: Academic writers or report writers who have outlined their primary points can use this to generate a compelling conclusion that ties all arguments together.
Elaborate Idea:
   Tokenized Prompt: “Elaborate on the following idea: {idea}”
   Use Case: Writers who have a basic concept or notion can use this prompt to flesh out more details, perspectives, or examples to better express and expand upon their initial thought.
Suggest Next Steps:
   Tokenized Prompt: “What are the next steps after {action}?”
   Use Case: Helpful in both project planning and narrative construction, this prompt can guide the writer through logical sequels or action points.

Some particular, non-limiting examples of use cases for tokenized prompts having multiple tokens include:
Context-Aware Style Suggestions:
   Multi-Token Prompt: “Based on {genre} and {audience}, suggest an appropriate writing style.”
   Use Case: Writers who are creating a story that spans multiple genres or addresses multiple audiences may need nuanced advice on how to modulate their style. For example, a young adult sci-fi novel would have a different tone than an academic sci-fi analysis.
Dialog Consistency Check:
   Multi-Token Prompt: “Check if character {character_name} in scene {scene_number} maintains a consistent tone and language.”
   Use Case: Consistency is key in storytelling. This prompt can help ensure that a character's dialogue remains consistent across different scenes, aiding in character development and narrative coherence.
Revision Helper:
   Multi-Token Prompt: “Revise this {paragraph/sentence} to match a {formal/informal} tone, limit to {word_count} words, and incorporate {keyword}.”
   Use Case: This prompt can be a lifesaver during revisions, helping writers efficiently refine their text based on several constraints.
Structured Brainstorming:
   Multi-Token Prompt: “Generate {x} ideas for plot points involving {character_name} in a {setting}.”
   Use Case: Writers often need to brainstorm multiple elements simultaneously. This prompt could help them generate plot points specifically focused on a character and a setting.
Summary and Expansion:
   Multi-Token Prompt: “If the paragraph is shorter than {min_word_count}, expand it. If it's longer than {max_word_count}, summarize it.”
   Use Case: Different writing projects have different length requirements. This prompt helps writers lengthen or condense their work as needed.
Visual Elements Incorporation
   Multi-Token Prompt: “Based on {theme} and {mood}, suggest some visual elements to include.”
   Use Case: Some writers like to incorporate visuals like pictures, graphs, or doodles. This prompt helps them identify what types of visual aids would best suit their work's theme and mood.

Some particular, non-limiting examples of uses of prompts that include conditional statements include:
Genre-Based Style Suggestions:
   Conditional Prompt: “If the genre is {genre}, suggest a writing style.”
   Use Case: This prompt would help writers adapt their language and tone to fit different genres, such as academic, fiction, or journalistic styles.
Audience-Based Language:
   Conditional Prompt: “If the audience is {audience_type}, adapt the following sentence: {sentence}”
   Use Case: Tailoring the language based on the audience (e.g., general public, experts, children) can help make the content more engaging and appropriate.
Length-Based Summary:
   Conditional Prompt: “If the paragraph is longer than {word_count}, summarize it.”
   Use Case: This prompt would automatically trigger a summary for longer paragraphs, aiding in brevity and readability.
Tense Correction:
   Conditional Prompt: “If the tense in the sentence is {tense}, correct it to {desired_tense}.”
   Use Case: Useful for writers who need to maintain consistent tense throughout their document, especially academic or formal writing.
Emotional Tone Suggestions:
   Conditional Prompt: “If the tone is {current_tone}, suggest a way to make it {desired_tone}.”
   Use Case: This can be especially useful for writers who need to adapt the emotional tone of their message, such as switching from a casual tone to a more formal one, or vice versa.
Verbosity Reduction:
   Conditional Prompt: “If the sentence has more than {word_count} words, simplify it.”
   Use Case: For academic or technical writers who may tend to be verbose, this prompt can help simplify sentences to improve readability.
Context-Based Character Actions:
   Conditional Prompt: “If the setting is {setting}, suggest an action for the character {character_name}.”
   Use Case: For fiction writers, this can help in generating context-appropriate actions or dialogues for characters, adding to story depth.
Citation Reminder:
   Conditional Prompt: “If a fact or statistic is mentioned, suggest adding a citation.”
   Use Case: Useful for academic and research writers to ensure that all factual statements are properly cited, maintaining the document's credibility.

Some particular, non-limiting examples of uses of prompts that include loops include the following. Some of these examples leverage the non-deterministic nature of at least some language models, which is expected to result in generating different outputs by applying the same language model multiple times to the same input. Although each example prompt below is phrased as a single, non-looped, statement, it should be assumed that a suitable prompt could be written with a loop syntax (e.g., using a “for” or “do while” construction, including a loop termination criterion) to form a prompt that defines a loop over the example prompt:
Idea Generation Loop:
   Looped Prompt: “Generate a plot idea based on the genre {genre}.”
   Use Case: Writers often struggle with coming up with unique and engaging plot ideas. This looped prompt could generate multiple plot ideas within a specific genre, allowing the writer to choose the most compelling one.
Dialogue Refinement Loop:
   Looped Prompt: “Improve this line of dialogue: {dialogue_line}.”
   Use Case: Dialogue can make or break a story. A looped prompt that iteratively refines dialogue could help writers achieve more natural and engaging exchanges between characters.
Thesaurus Loop:
   Looped Prompt: “Find synonyms for the word {word}.”
   Use Case: When a writer overuses a particular word, it can make the work monotonous. This loop could provide a list of suitable synonyms for a repetitive word, enhancing the writer's vocabulary and the quality of the writing.
Sentence Complexity Loop:
   Looped Prompt: “Rewrite this sentence to make it more complex: {sentence}.”
   Use Case: Some writing, such as academic papers, requires a more complex sentence structure. Looping this prompt can take a simple sentence and make it more nuanced, adding depth to the paper.
Feedback Loop:
   Looped Prompt: “Provide constructive feedback on this paragraph: {paragraph}.”
   Use Case: Writers need to revise and improve constantly. A loop that provides ongoing feedback can give insights into the strengths and weaknesses of a piece, allowing for iterative improvements.

Some particular, non-limiting examples of uses of chained prompts include:
Research Assistant Chain:
   Chained Prompts:
      “Search for articles related to {topic}.”
      “Summarize the top 3 articles.”
      “Provide citation formats for these articles in {citation_style}.”
   Use Case: This would be highly useful for academic writers or journalists who are required to back their points with credible sources. It automates the process from finding sources to summarizing them and even formatting citations.
Character Development Chain:
   Chained Prompts:
      “Generate a basic character profile for {character_name}.”
      “Suggest three key moments in the character's backstory.”
      “Write a dialogue scene that reveals one of these key moments.”
   Use Case: Fiction writers could utilize this chain to create well-rounded characters and integrate them seamlessly into the narrative.
Editing and Refinement Chain:
   Chained Prompts:
      “Identify passive voice in this {paragraph}.”
      “Rewrite sentences in active voice.”
      “Check for readability and suggest improvements.”
   Use Case: Many writers struggle with editing, particularly when it comes to style and readability. This chained prompt sequence could make the editing process more systematic and effective.
Blog Post Creation Chain:
   Chained Prompts:
      “Generate a list of trending topics in {niche}.”
      “Suggest 3 blog post titles for one chosen topic.”
      “Create an outline for the chosen blog post.”
   Use Case: Bloggers or content marketers could use this chain to streamline the initial stages of content creation, from topic selection to outlining.
Screenplay Structuring Chain
   Chained Prompts:
      “Break down the screenplay into three acts.”
      “List key scenes for each act.”
      “Outline a dialogue sequence for one key scene.”
   Use Case: Screenwriters often have to balance complex narratives within the confines of screenplay structure. This chain could guide them through the process, ensuring that key elements are included in each act.

Some particular, non-limiting examples of use cases for scripted prompts include:
Automated Formatting:
   Scenario: A writer is preparing a technical manual with specific formatting requirements.
   Scripting Use: A script could auto-format the document by adjusting headings, inserting table of contents, organizing footnotes, or managing citations, all based on the writer's predefined or selected specifications.
Data Integration & Visualization:
   Scenario: A writer is composing a market research report and wants to integrate live financial data.
   Scripting Use: A script could fetch live market data and integrate it into the document, potentially even producing charts or graphs on the fly.
Content Personalization:
   Scenario: A content creator wants to send personalized emails or newsletters to their subscribers.
   Scripting Use: A script could adjust the content based on subscriber information, personalizing greetings, recommendations, or other content pieces.
Language Translation:
   Scenario: A novelist wants to provide a sample translation of their work for international publishers.
   Scripting Use: With integration to a translation API, a script could auto-translate sections or the entirety of the document to a selected language.
Automated Summary and Metadata Generation:
   Scenario: A researcher is uploading several of their papers to a repository and needs summaries and metadata for each.
   Scripting Use: A script could auto-generate concise summaries, keyword lists, or other metadata based on the content of each paper.
Interactive Elements for Digital Publishing:
   Scenario: A writer is creating an interactive e-book or digital guide.
   Scripting Use: Scripts could embed interactive elements like quizzes, animations, or clickable maps directly within the document.
Document Security:
   Scenario: A business professional is preparing a sensitive report and wants to ensure it's encrypted or watermarked.
   Scripting Use: The app could execute a script that encrypts the document, adds a watermark, or integrates other security measures.
Document Analytics:
   Scenario: A writer wants insights into how readers engage with their digital document.
   Scripting Use: Embedded scripts can track reading time, most engaged sections, or even feedback submissions from readers.
Real-time Collaboration Tools:
   Scenario: Multiple authors are collaborating on a shared document.
   Scripting Use: A script could highlight recent changes, show who is currently viewing or editing the document, or even enable a chat feature within the app.
Grammar & Style Enhancement:
   Scenario: A writer is looking for advanced grammar and style checks beyond the basic ones.
   Scripting Use: Integration with advanced linguistic tools or APIs could provide deeper insights, suggestions, and corrections.

Some particular, non-limiting examples of uses of scripted prompts include:
Character Development Script:
   Scripted Prompt: “If {character_age} is less than 18, suggest ‘childhood trauma’. Else, suggest ‘adult experiences’.”
   Use Case: This script could help writers deepen their character development by providing age-appropriate backstory ideas.
Setting Generation Script:
   Scripted Prompt: “If {genre} is ‘fantasy’, generate a medieval setting. If {genre} is ‘sci-fi’, generate a futuristic city.”
   Use Case: This can help writers quickly generate settings that are appropriate to their story's genre, saving time on research and brainstorming.
Conflict Resolution Script:
   Scripted Prompt: “If {conflict_type} is ‘man vs man’, suggest a duel. If {conflict_type} is ‘man vs nature’, suggest a natural disaster.”
   Use Case: Determining how a conflict resolves in a story can be challenging. This script provides suggestions based on the type of conflict, helping to move the story forward.
Emotional Arc Script:
   Scripted Prompt: “If {character_emotion} starts at ‘happy’, chart an arc that leads to ‘sadness’, then ‘redemption’.”
   Use Case: Emotional arcs are crucial for engaging readers. This script could help plan out a character's emotional journey throughout a story.
Editing and Proofreading Script:
   Scripted Prompt: “Scan {text} for common grammar mistakes. If found, suggest corrections.”
   Use Case: This can be a final check for writers to ensure their work is grammatically sound before publishing or submission.

The action definition library 106 may or may not be fixed. The system 100 may, for example, enable the user 102 to add, modify, and/or delete action definitions 108a-n within the action definition library 106 in any of a variety of ways.

For example, in the case of simple text prompts, the system 100 may enable the user 102 to add, modify, and delete one or more of the action definitions 108a-n by, for example, using a text editor-style interface to add, modify, and delete the text of such prompts and associated metadata, such as descriptions and short names of such prompts. Once the user 102 has added or modified one of the action definitions 108a-n, such an action definition may be used by the system 100 in any of the ways disclosed herein.

The system 100 may enable the user 102 to add, modify, and delete tokenized prompts within the action definition library 106 in any of the ways disclosed herein in connection with simplified text prompts. In addition, the system 100 may facilitate adding, modifying, and deleting tokens within tokenized prompts in the action definition library 106 in any of a variety of ways, such as in any manner that is known from systems for performing such functions using tokens, e.g., in software Integrated Development Environments (IDEs) and source code editors. Merely as one example, the system 100 may manifest to the user 102 a list of available tokens and enable the user 102 to select any of those tokens for inclusion in the action definition currently being edited by the user 102, in response to which the system 100 may insert the selected token into that action definition, e.g., at the current cursor location/insertion point within that action definition. As another example, the system 100 may provide an auto-complete feature that manifests suggested auto-completions for tokens to the user 102 as the user 102 is editing an action definition, in response to which the user 102 may accept an auto-completion by performing a particular action (e.g., hitting the Tab or Enter key), in response to which the system 100 may insert the accepted token into the action definition at the current cursor location/insertion point within that action definition. As the definition of tokenized prompts implies, the prompt editor may enable the user 102 to insert a token at any position within a prompt, such as immediately before non-tokenized (e.g., plain) text and/or immediately after non-tokenized (e.g., plain) text.

The system 100 may enable the user 102 to add, modify, and delete compound prompts (e.g., chained prompts and/or alternative take prompts) within the action definition library 106 in any of the ways disclosed herein in connection with simplified text prompts and tokenized prompts. In addition, the system 100 may facilitate adding, modifying, and deleting compound prompts in any of a variety of ways. For example, the action definition of a compound prompt may include both the compound prompt's component prompts and metadata/settings that define how the compound prompt will be executed in operation 210, and the system 100 may enable the user 102 to add, modify, and delete both the compound prompt's component prompts and such metadata/settings. Some examples of user interface elements that the system 100 may implement to facilitate editing of compound prompts include the following:
Visual Flow Diagrams: The system 100 may use flow diagrams or visual nodes to represent the compound prompt structure. Chained prompts may be visualized as linked nodes in a linear manner, while alternative take prompts may branch out from a common node.
Toggle Modes: When creating or editing a compound prompt, the system 100 may enable the user 102 to toggle between “Chaining Mode” and “Alternative Take Mode,” which will adjust the UI to guide the user 102 in setting up the compound prompt's component prompts according to the user's preferred execution style.
Drag and Drop Interactivity: The system 100 may enable the user 102 to craft compound prompts by dragging individual component prompts into a workspace. Depending on the arrangement or connectors used, the system 100 may recognize the desired execution style.
Descriptive Tooltips: Hovering over a compound prompt in the action definition library 106 may cause the system 100 to show tooltips or brief descriptions of the compound prompt's behavior, making it clear to the user 102 whether the prompt is set up for chaining, alternative takes, or both.

The system 100 may enable the user 102 to add, modify, and delete scripted prompts within the action definition library 106 in any of the ways disclosed herein in connection with simple text prompts, tokenized prompts, and compound prompts. In addition, the system 100 may facilitate adding, modifying, and deleting scripted prompts in any of a variety of ways. For example, the system 100 may provide the user 102 with a script editor having any of the features of a conventional script editor, source code editor, and/or IDE, in combination with any of the features disclosed above in connection with simplified text prompts, tokenized prompts, and compound prompts, to add, modify, and delete action definitions 108a-n in the action definition library 106.

Such scripts may be written using an existing scripting language, using a custom-designed scripting language, or any combination thereof. Non-limiting examples of such languages include JavaScript, Python, Ruby, Lua, TypeScript, Bash, Perl, and PowerShell. The term “scripting language” is used broadly herein to include both languages that are commonly referred to as “scripting languages” and languages that are commonly referred to as “programming languages.” Such a scripting language may, for example, include the use of variables and other data structures, function definitions and function calls, conditional statements, loops, and any other constructs known within scripting languages.

The system 100 may enable the user 102 to utilize the prompt editor feature to add, edit, or delete action definitions at any time relative to the performance of other actions disclosed herein. This flexibility enables a dynamic and iterative process of creating, applying, and refining action definitions.

For example, the user 102 may use the prompt editor to create a new action definition and then, at a later time, apply the created action definition to selected text using the techniques disclosed herein. Subsequently, the user 102 may return to the prompt editor to revise the previously created action definition. At a later time, the user 102 may apply this revised action definition to other selected text within the same document or a different document.

The user 102 is not limited to applying only the action definitions they have personally created or edited. The user 102 may select and apply any action definition available in the action definition library 106 to selected text, regardless of whether the user 102 created that particular action definition.

Furthermore, the system 100 may enable the user 102 to manually edit the text of the selected document 114 at any time, providing complete flexibility in the document creation and revision process. For example, the user 102 may manually edit the text of the selected document 114 before creating or editing an action definition, after creating or editing an action definition, before applying an action definition to the selected text 116, and/or after applying an action definition to the selected text 116. This flexibility allows the user 102 to seamlessly integrate manual editing with the automated assistance provided by the action definitions 108a-n, creating a highly customizable and efficient document revision process.

Although not shown in FIG. 1, the system 100 may store and use any of a variety of settings that may be used within the system 100 and method 200. Furthermore, system 100 may manifest any such settings to the user 102 via the user interface 104 and enable the user 102 to modify any such settings by providing input to the system 100 via the user interface 104, in response to which the system 100 may modify the settings as indicated by the user 102. Some examples of such settings include:
Language model Parameters Configuration: The user 102 may modify settings related to one or more language models used by the system 100. This may include, for example, settings such as the language model's response length, temperature (which affects the randomness of the model's responses), and other parameters that influence the behavior and output of the language model.
Chat Context Selection: The user 102 may have the option to determine how context is managed during interactions with the language model, such as:
   No History: Every prompt is executed without any prior chat history. This ensures each interaction is standalone and not influenced by prior inputs.
   Ongoing History: An ongoing chat context is maintained. This means that consecutive prompt executions can be influenced by previous interactions, allowing for more context-aware responses from the language model.
Prompt Contextualization: The user 102 may configure how prompts are enriched with context during execution:
   Prompt & Selected Text: The language model executes prompts based solely on the content of the prompt itself and any text selected by the user.
   Additional Context: Users may add further context to prompts, either by incorporating more portions of the document or by including text from other sources. This may include, for example, any one or more of the following:
      Manually provided context by the user.
      Context from external data 128, such as one or more databases, files, or web resources.

Some embodiments of the present invention include features related to “track changes” and commenting features found in word processors and text editors. Such features are collectively referred to herein as the “generative track changes” feature, merely for ease of reference and without limitation. In general, by applying one or more of the system 100's action definitions, text generation, and context-aware processing to tracked changes and comments, the track changes feature transforms the typically passive and cumbersome revision process into an intelligent, automated workflow. For example, the system 100 may analyze comment threads, suggest and implement improvements to tracked changes, and/or provide automated explanations of modifications while maintaining document coherence and quality. This approach significantly reduces the cognitive burden on users while preserving their control over the revision process, enabling more efficient and effective document collaboration.

The system 100 may enable automated analysis and implementation of comment threads. For example, when processing one or more comments within a document, the action processor 112 may identify one or more applicable action definitions based on the comment content and context. The text generation module 120 may then apply the identified action definition(s) to generate one or more specific revision suggestions that address the intent of the comments while maintaining document coherence.

For example, the system 100 may analyze a comment thread within a document to identify one or more appropriate revisions for implementing the comment(s) in the comment thread. For example, when processing a comment thread containing one or more comments from one or more users, the action processor 112 may provide a specialized prompt to a language model to identify specific revisions that should be made. For example, the prompt may instruct the language model to analyze the comment thread and identify one or more appropriate modifications to the associated document content.

Based on the output of the language model, the system 100 may identify one or more applicable action definitions from the action definition library 106 that may be used to implement the identified revision(s). The text generation module 120 may then apply the identified action definition(s) to the document text associated with the comment thread using any of the processing techniques disclosed herein.

For each comment or comment thread, the system 100 may analyze the surrounding document context to identify (e.g., generate) one or more appropriate transformations. This context-aware processing ensures that generated revisions integrate seamlessly with existing content while preserving document structure and formatting. The system 100 may process multiple document elements simultaneously, enabling efficient handling of complex comment threads that span different sections.

The system 100 may support both automated and interactive refinement paths, enabling users to review generated changes before implementation. Through real-time preview capabilities and/or side-by-side comparisons, users can evaluate potential improvements and make informed decisions about content updates. When a user approves a suggestion, the document update module 124 may implement the refined change(s) while preserving document coherence and quality. This approach combines the efficiency of automated content generation with the control of manual oversight.

The system 100 may leverage any of the external data 128 to enhance comment analysis and revision generation. Using a distributed processing architecture, computationally intensive operations may be performed on dedicated servers while maintaining responsive performance. The state-based revision management approach enables efficient tracking of suggested changes while preserving the original document content.

The system 100 may provide capabilities for refining tracked changes through its text generation and processing architecture. When processing tracked changes within a document, the text generation module 120 may apply a selected action definition to improve the integration and quality of modifications. This may enable complex transformations while preserving document structure, formatting, and overall coherence.

The action processor 112 may support multi-stage refinement of tracked changes through sequential processing steps. Initial transformations may be further enhanced through subsequent action definitions, enabling compound improvements that build upon previous refinements. This sequential approach allows for sophisticated content transformations while maintaining precise control over document updates.

The system 100 may enable automated generation of explanations for tracked changes through its text generation capabilities. For example, the text generation module 120 may apply selected action definitions to analyze modifications and generate clear explanations that provide context for the changes. This automated documentation helps users understand the rationale and impact of tracked changes while maintaining document coherence.

When processing tracked changes, the system 100 may consider document-wide context and relationships between different content elements. The action processor 112 may analyze both the modified content and surrounding document context (e.g., one or more surrounding words, paragraphs, and/or sections) to generate contextually appropriate explanations. This context-aware processing ensures that generated explanations accurately reflect how changes integrate with and affect the broader document.

The system 100 may support flexible explanation generation through both automated and interactive workflows. For example, the system 100 may enable the user 102 to review generated explanations and request refinements through the user interface 104. Through state-based revision management, the system 100 may maintain clear relationships between tracked changes and their corresponding explanations.

Embodiments of the present invention have a variety of advantages, such as the following.

In the traditional writing process, every thought is developed and every word is written manually by the writer. This process, while deeply personal, can be slow and often lead to writer's block. Embodiments of the present invention preserve the essence and benefits of manual writing while bypassing the occasional blockades. Embodiments of the present invention use the action definition library 106 (e.g., language model prompts) for brainstorming, refining, and elaborating on the writer's text without replacing the human touch.

Although certain AI-based writing tools exist, such as those that use LLMs to draft entire documents, the resultant piece may not fully capture the writer's voice or intent. Post-creation, the writer often must manually revise word-by-word, which can be cumbersome. In contrast, instead of a one-size-fits-all approach, embodiments of the present invention enable the writer to seamlessly blend his or her own words with AI-generated content. The writer is empowered to decide where to obtain assistance from the system 100 and to what extent, ensuring the final piece resonates with the writer's unique voice.

Although chatbot-based AI tools, such as ChatGPT, may be used to assist writers in generating written works, such tools are useful primarily for creating an entire draft of such works. If the writer then wants to revise a chatbot-generated work, the writer must either revise the entire work manually, or request that the chatbot generate an entire new draft of the work. Chatbots do not, in other words, facilitate editing of works. In contrast, embodiments of the present invention provide writers with granular control over the revision process, enabling them to modify specific sections without overhauling the entire piece, allowing for efficient iterations that take maximum advantage of language models and other computer automation, while preserving the core of the writer's content. In this way, embodiments of the present invention combine the best of computer-automated writing with manual human writing.

Although some LLM-based writing apps, such as Jasper, provide limited features that enable writers to leverage LLMs to revise a draft document, such apps are limited to providing a fixed set of opaque revision commands, such as “summarize,” “shorten,” “lengthen,” and “rephrase.” Such apps do not enable the user to see how such commands operate, to modify those commands, or to add commands of their own. In contrast, embodiments of the present invention enable users to customize prompts to reflect the writer's own writing preferences and style.

In short, embodiments of the present invention do not dictate the writer's writing process. Instead, they collaborate with the writer, enabling the writer to write, refine, expand, and restructure documents using whatever mixture of human writing and computer-automated writing and revising the writer prefers, including computer-automated writing and revising defined by the writer.

Although the advantages mentioned above focus primarily on the benefits to the writer, embodiments of the present invention also include a variety of technical innovations that have a variety of technical benefits. For example, embodiments of the present invention are able to merge user-selected text (e.g., the selected text 116) with pre-defined action definitions 108a-n (e.g., prompts), which represents a particular way of implementing prompt optimization that represents a technical advancement over existing techniques for generating prompts that do not incorporate user-selected text. Furthermore, by enabling the user 102 to create and modify action definitions (e.g., prompts) in the action definition library 106, to store those action definitions for future use, and to select those stored action definitions for use in connection with the user-selected text 116, embodiments of the present invention enable the generated text 122 to be generated more efficiently than existing solutions that do not enable pre-stored components of a prompt to be selected (e.g., without typing them manually) and then combined with user-selected text (e.g., without requiring such text to be typed manually).

The ability of embodiments of the present invention to enable the user 102 to select multiple non-contiguous selections of text within the selected document 114 provides a variety of advantages. For example, embodiments of the present invention may apply a multi-token prompt to such multi-selections to generate a combined prompt that is based on some or all of the multiple selections. This enables embodiments of the present invention to generate prompts and to perform operations, e.g., using language models (e.g., LLMs), that would either not be possible using existing systems, or that could not be performed as efficiently using existing systems. For example, by enabling multiple non-contiguous text selections to be used to generate the generated text 122 (e.g., by generating a single prompt that incorporates all of the multiple non-contiguous text selections), embodiments of the present invention allow for more intricate interactions with a language model than existing systems by facilitating compound queries or task to be performed using the multiple non-contiguous text selections, such as comparing, contrasting, or merging the multiple non-contiguous text selections and/or concepts represented by those multiple non-contiguous text selections. In contrast, systems that are limited to using contiguous text selections are limited to performing simpler operations on the selected text only, such as rephrasing, summarizing, or expanding the selected text.

As another example, by enabling the user 102 to select multiple non-contiguous text blocks, the system 100 enables richer context to be provided to a language model, thereby enabling the language model to generate more informed and nuanced outputs. In contrast, operations performed on single contiguous text selections tend to lack such broader context, thereby leading to outputs that may not fully capture the intended essence.

As yet another example, by enabling the user 102 to select multiple non-contiguous text blocks, the system 100 may execute complex tasks in a single step (e.g., by providing a single prompt to a language model to generate a single output), rather than performing multiple steps (e.g., by sequentially providing multiple prompts to the language model to generate multiple outputs). As a result, embodiments of the present invention provide an increase in processing efficiency compared to systems that can only be applied to single contiguous text selections.

The ability of embodiments of the present invention to generate, store, modify, and execute compound prompts (e.g., chained prompts and/or alternative take prompts) provides a variety of advantages. For example, the ability to execute compound prompts (e.g., to provide a compound prompt as an input to a language model to generate the generated text 122) enables the system 100 to perform multi-stage content processing. For instance, using a chained prompt, the system 100 may first simplify a complex paragraph (using Component Prompt A in a chained prompt) and then summarize the simplified version (with Component Prompt B in the chained prompt), thereby ensuring the essence is captured in a concise manner. Because the system 100 may execute both component prompts of the chained prompted automatically in sequence, the system 100 enables such sequential processing to be performed more efficiently and effectively than systems that require the user 102 to manually instruct such systems to execute each such component prompt manually.

The ability to apply multiple component prompts within an alternative take compound prompt to generate alternative outputs from the same text selection provides a variety of benefits. For writers, this ability may assist in content brainstorming, assisting in decision-making about plot development, evaluation of multiple hypotheses, and crafting a message for multiple audiences. This feature also provides technical benefits, such as providing the ability to generate a larger amount of text based on the same input as conventional systems that lack the ability to process alternative take prompts automatically.

Yet another technical feature of embodiments of the present invention is that it may be implemented using an event-based design that can perform any of a variety of functions disclosed herein at any time, particularly in response to input received from the user 102 via the user interface 104 at any time. For example, the user 102 may provide first input via the user interface 104 (e.g., input which selects a first instance of the selected action definition 118 and a first instance of the selected text 116), in response to which the action processor 112 may execute a first instance of the method 200 to generate a first instance of the generated text 122. At any subsequent time, the user 102 may provide second input via the user interface 104 (e.g., input which selects a second instance of the selected action definition 118 and a second instance of the selected text 116), in response to which the action processor 112 may execute a second instance of the method 200 to generate a second instance of the generated text 122. Even within such scenarios, the system 100 may receive individual inputs from the user 102, such as inputs selecting the first instance of the selected action definition 118 and the first instance of the selected text 116, at any time, and take action in response to such inputs whenever they are received.

Such event-based processing may be implemented, for example, using object-oriented programming (OOP) techniques in connection with a GUI. As is well-known, the rise of GUIs in the history of software development represented a significant shift in software design paradigms. Earlier software, designed for terminal-style interfaces, operated in a more linear fashion, waiting for a single text-based input from the user. However, the advent of GUIs introduced a far more interactive and dynamic user experience, where multiple types of inputs could be triggered at any time. Event-based OOP emerged as an effective way to design software that could respond flexibly to these multi-faceted, asynchronous user inputs.

Today's chatbot-based writing tools, and writing tools which first receive input from a user and then produce a draft based on the user's input, have the limitations of the terminal-style interfaces of previous generations of software. In contrast, embodiments of the present invention may replace such limitations with the benefits of software that uses an OOP-based GUI, and apply such benefits to the context and generating and editing text. In particular, embodiments of the present invention may respond flexibly to multi-faceted, asynchronous inputs from the user 102.

For example, in an event-based OOP design, and in embodiments of the present invention, actions such as selecting text or choosing a prompt may be treated as events. When these events occur, specific event handlers may be triggered to execute corresponding actions, such as invoking a language model to apply a prompt. This architecture allows for real-time, dynamic interaction between the user 102 and the system 100. Given that the writing process preferred by most human writers is not linear, an event-based design allows the user 102 to make asynchronous revisions to the selected document 114. This enables the user 102 to be free to edit any part of the selected document 114 at any time, in any order, according to their creative flow.

As the above explanation illustrates, embodiments of the present invention differ from existing software applications for providing writing assistance by facilitating the process of revising the selected document 114 based on both human input and computer-generated output, rather than focusing only on the process of generating an initial draft of the selected document 114 automatically. In particular, by enabling the user 102 to apply user-definable action definitions (e.g., prompts) to user-selectable text within the selected document 114, while also enabling the user 102 to manually edit the selected document 114, and to flexibly intersperse such automatic user-configurable revisions with manual edits, embodiments of the present invention provide the user 102 with a combination of the power of computer-automated text generation and revision with the control of manual user text generation and revision, all where and when specified by the user 102, at any level of granularity within the selected document 114.

For example, consider a sequence of events in which:
the user 102 manually writes an initial draft of the selected document 114;
the user 102 then selects a first sentence within the selected document 114 as a first instance of the selected text 116 and applies a first one of the action definitions 108a-n to the first sentence to generate a first instance of the generated text 122, in response to which the document update module 124 replaces the first sentence with the first instance of the generated text 122 in the selected document 114;
the user 102 then manually adds a new paragraph to the selected document 114;
the user 102 then selects a second sentence within the selected document 114 (e.g., within the manually-added new paragraph) as a second instance of the selected text 116 and applies a second one of the action definitions 108a-n to the second sentence to generate a second instance of the generated text 122, in response to which the document update module 124 replaces the second sentence with the second instance of the generated text 122 in the selected document 114; and
the user 102 then manually revises the second instance of the generated text 122 in the selected document 114.

As the above example illustrates, the user 102 may use embodiments of the system 100 to flexibly add and revise text manually in the selected document 114 and to apply selected (and user-configurable) action definitions from the action definition library 106 to arbitrarily-selected text within the selected document 114, in any sequence and combination, including interspersing manual additions/revisions to the selected document 114 with automatic additions/revisions to the selected document 114 in any combination. This enables the user 102 to take maximum advantage of the benefits of the action processor 112's ability to generate and revise text automatically within the selected document 114, without sacrificing any ability to manually add to and revise text within the selected document 114, and without limiting the use of the action processor 112 merely to generating entire new drafts of the selected document 114 or to performing predefined and non-user-configurable actions on selected text within the selected document 114.

Most efforts on improving the ability of language models, especially LLMs, to assist in the writing process, both in academia and in commercial products, focus on achieving improvements in prompt engineering for the purpose of developing individual prompts that are better able to generate an entire draft of a document. The premise of such efforts is that the goal is to achieve a single prompt that can be used to assist a writer in producing an entire draft of a document. Such efforts fail to recognize both that many writers, especially professional writers of long-form content, prefer or require a writing process that includes making multiple revisions of the document being written, not a single draft produced from whole cloth. Furthermore, it is not even known whether it will be possible to produce written documents that are desired and needed by both writers and audiences solely through improvements in prompt engineering. What is known is that, based on the current state of the art in prompt engineering, the best output currently generated using individual prompts often lack depth, context, and the nuance required in advanced or professional writing tasks, especially when long-form content is needed. Furthermore, the content produced using the current best prompts lack the writer's unique voice, which can only be achieved by the writer manually editing the output generating using such prompts.

Furthermore, writers, especially those engaged in long-term projects like novels and screenplays, often do not have a fully formed set of their own goals at the outset. This makes it impossible to encapsulate all of the writer's requirements in a single prompt. The writing process itself is iterative and the writer's goals may change or become clearer as the draft progresses. A writer may only recognize what needs to be revised or what their true goals are after writing or seeing a draft. A single prompt approach does not offer the flexibility to adapt to these post-draft realizations, making a solely prompt-driven writing process too rigid for the needs of the professional or otherwise sophisticated writer. For this and other reasons, professional writers value and require the ability to revise small portions of their work, making a tool that offers nuanced editing features more aligned with their needs. This contrasts sharply with a model where all the goals have to be stated up front.

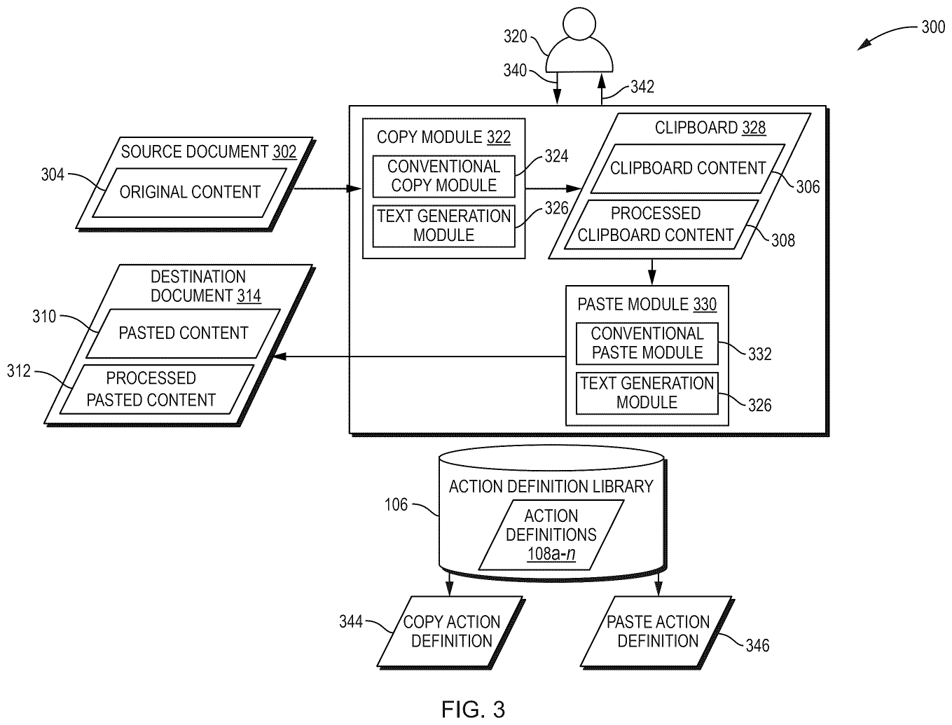

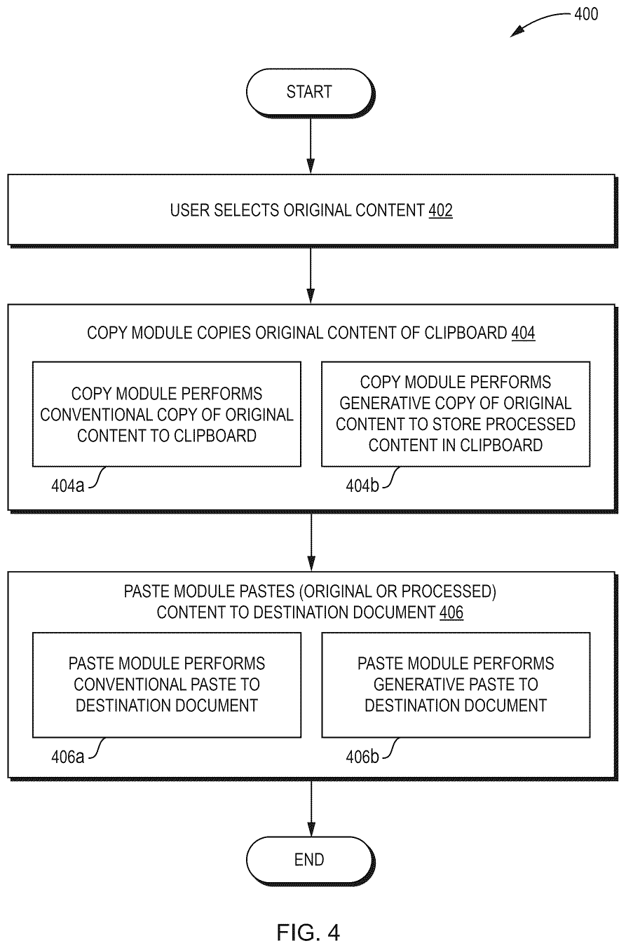

In addition to the document revision capabilities described above, embodiments of the present invention also include a novel “generative cut and paste” feature. This feature extends the power of generative AI to standard clipboard operations, further enhancing the writing and editing process. Referring to FIG. 3, a dataflow diagram is shown of a system 300 for implementing the generative cut and paste feature according to one embodiment of the present invention. Referring to FIG. 4, a flowchart is shown of a method 400 performed by the system 300 of FIG. 3 according to one embodiment of the present invention. The system 300 and method 400 may, for example, be used in connection with the system 100 of FIG. 1 and the method 200 of FIG. 2 to extend the capabilities of that system 100 and method 200 to include generative AI processing during clipboard operations, further enhancing the writing and editing process.

The generative cut and paste feature may operate in either of both of two primary modes:
Generative Copy: When content (e.g., text) is copied from a document or any other source, the system 300 applies generative AI to the copied content, producing processed copied content. This processed content is then stored in the clipboard, either replacing or supplementing the original copied content.
Generative Paste: When content is pasted from the clipboard (whether that content is original content or previously processed content), the system 300 applies generative AI to the pasted content, producing processed pasted content. This processed content is then inserted into the target document, either replacing or supplementing the original clipboard content.

The generative cut and paste feature may leverage the same action definition framework described earlier herein. Any action definition, such as simple text prompts, tokenized prompts, alternative take prompts, chained prompts, and/or scripted prompts, may be applied to process copied or pasted content. This integration allows for a seamless extension of the system 100's capabilities to copy and paste operations, enabling a wide range of content transformations and enhancements during these common document editing tasks.

For the purposes of the disclosure herein, the term “copying” is used to encompass both the actions of copying and cutting content. Copying refers to the process of duplicating selected content and storing it in the clipboard without removing it from its original location. Cutting, on the other hand, involves removing the selected content from its original location and storing it in the clipboard. To streamline the description and avoid repetition, whenever “copying” is mentioned in the context of the generative cut and paste feature, it should be understood to encompass copying and/or cutting operations. This convention allows for a more concise explanation of the feature while covering both content duplication methods.

The system 300 for implementing the generative cut and paste feature comprises several elements that represent the content at various stages of the process:
Source Document 302: The document or source from which content is initially copied.
Original Content 304: The specific content that is copied from the source document 302.
Clipboard Content 306: The content as it is stored in the clipboard before any processing using an action definition occurs.
Processed Clipboard Content 308: The content after it has undergone processing by an action definition and is stored in the clipboard.
Pasted Content 310: The content after it has been pasted from the clipboard but before any action definition processing has been applied.
Processed Pasted Content 312: The content after it has been pasted from the clipboard and subsequently processed using an action definition.
Destination Document 314: The document or location where the pasted content is ultimately inserted.

The terms “source document” 302 and “destination document” 314 encompass any source or destination for content, including documents, text fields, web pages, databases, or any other medium from which content can be copied or into which content can be pasted.

The system 300 and method 400 may apply any kind of action definition disclosed herein to content, whether or not such action definition uses generative AI. For example, scripted prompt action definitions may apply formatting rules and data transformations using techniques other than generative AI.

Processing described as applied to original content 304 during copy operations may equally be applied to clipboard content 306 or processed clipboard content 308 during paste operations, and vice versa.

The system 300 may: (1) apply action definitions during copy to produce processed clipboard content 308, then paste conventionally; (2) copy conventionally to produce clipboard content 306, then apply action definitions during paste; or (3) apply a first action definition during copy and a second action definition during paste for multi-stage processing.

The system 300 includes a user 320 that may be a human user, software program, device, or combination thereof. The source document 302 contains original content 304, which may be selected by the user 320 for copying. Multiple instances of original content 304 may be processed with different action definitions.

Embodiments may implement components directly for full control, or use pre-existing operating system components for conventional operations while implementing novel features on top. This hybrid approach enables adaptation to various environments including standalone applications, plugins, cloud services, and mobile apps.

The system 300 may interact with operating system clipboard functionality through clipboard APIs, event listeners, custom clipboard formats, inter-process communication, or system hooks to enhance conventional cut-and-paste operations with generative capabilities while maintaining compatibility.

Referring now to FIG. 4, in operation 402, the user 320 selects the original content 304 within the source document 302. This operation defines the scope of content for subsequent generative AI operations and transformations.

Operation 402 may be implemented through various methods including:
Mouse selection by clicking and dragging across desired text
Keyboard shortcuts such as Ctrl+A or Shift+Arrow keys
Touch gestures on touch-enabled devices
Voice commands in systems with voice recognition
Programmatic selection through API calls or scripted commands

The system 300 registers the selection and may provide visual feedback through highlighting or other visual cues. The system 300 may also support selecting content from multiple documents or non-document sources such as web pages.

The method 400 includes a copy operation 404 with two sub-operations: operation 404a performs conventional copy of original content 304 to create clipboard content 306, while operation 404b performs generative copy to create processed clipboard content 308.

The system 300 may be configured to use either sub-operation based on user preferences, system settings, or contextual factors. The user 320 may explicitly choose between operations, the system 300 may automatically determine which to use, or a hybrid approach may perform both operations simultaneously.

In some embodiments, the system 300 may support only conventional copy operations (operation 404a) while providing generative capabilities during paste operations. This approach offers compatibility with existing workflows, improved performance, and flexibility for users to apply generative processing at paste time.

The copy operation 404 may be triggered by input 340 from the user 320, such as keyboard shortcuts (Ctrl+C, Cmd+C), menu selection, toolbar buttons, touch gestures, or voice commands.

The user 320 may provide a single input that both selects the original content 304 and triggers the copy operation 404, such as through double-click and drag, touch-based selection, voice commands with content specification, or smart selection features that automatically trigger copying upon selecting specific content types.

The system 300 recognizes these input types and initiates either the conventional copy operation 404a or the generative copy operation 404b based on user preferences or system settings.

As part of performing the generative copy operation 404b, the system 300 may select or otherwise identify a particular action definition to apply to the original content 304 to produce the processed clipboard content in operation 404b. We will refer to this selected action definition as the “copy action definition 344”, because it is applied by the system 300 to the original content 304 as part of the generative copy operation 404b. The system 300 may, for example, select or otherwise identify the copy action definition 344 from the action definitions 108a-n in the action definition library 106 previously described in connection with FIGS. 1 and 2, or from any other suitable source of action definitions.

The system 300 may implement the selection or identification of the copy action definition 344 in various ways, such as user selection through dropdown menus or contextual menus, default action definitions that are pre-configured or determined by content type, context-aware selection based on content analysis, keyboard shortcuts for frequently used actions, or programmatic selection through API calls.

The system 300 includes a copy module 322 with both a conventional copy module 324 and a text generation module 326. The conventional copy module 324 performs conventional copy operations on the original content 304 to produce clipboard content 306. The text generation module 326 performs generative copy operations by applying the copy action definition 344 to the original content 304 to produce processed clipboard content 308.

This dual-module structure supports both conventional and generative copy operations. The text generation module 326 may apply generative processing using language models and various prompt types to transform the copied content. The system 300 may store both conventional clipboard content 306 and processed clipboard content 308 in the clipboard 328, providing users flexibility to choose between original and processed versions at paste time.

The method 400 includes a paste operation 406 for inserting copied content into the destination document 314, supporting both conventional and generative paste capabilities.

The paste operation 406 includes operation 406a (conventional paste) and operation 406b (generative paste).

Operation 406a performs standard paste functionality, inserting clipboard content 306 or processed clipboard content 308 into the destination document 314 as pasted content 310 without modifications.

Operation 406b applies an action definition to clipboard content 306 or processed clipboard content 308 to generate processed pasted content 312, leveraging generative AI capabilities to transform content during paste.

The system 300 may select between operations 406a and 406b based on user preferences, system settings, or contextual factors.

By supporting both conventional and generative paste operations, the system 300 maintains compatibility with existing workflows while offering enhanced functionality through generative AI capabilities.

In some embodiments, the system 300 may implement only generative copy operation 404b while maintaining conventional paste operation 406a, providing generative processing during copy while ensuring predictable paste behavior.

This configuration utilizes generative capabilities during copy operations while maintaining conventional paste functionality, ensuring standard paste behavior while benefiting from generative features during copy.

As part of performing the generative paste operation 406b, the system 300 may select a paste action definition 346 from the action definitions 108a-n in the action definition library 106 to apply to the clipboard content 306 or processed clipboard content 308 to produce the processed pasted content 312.

The system 300 may select the paste action definition 346 through:
User Selection: The user 320 may explicitly select the paste action definition 346 from a dropdown menu, contextual menu, or toolbar interface.
Default Action Definition: The system 300 may apply a pre-configured default paste action definition set by the user 320 or determined by the system 300 based on content type or target application.
Context-Aware Selection: The system 300 may automatically select an appropriate paste action definition based on content type, target document type, or user preferences.
Keyboard Shortcuts: The system 300 may allow users to assign specific paste action definitions to custom keyboard shortcuts.
Multiple Action Definitions: The system 300 may apply multiple paste action definitions in sequence, creating a compound action.
   The system 300 may determine whether to use the clipboard content 306 or the processed clipboard content 308 as input for the generative paste operation 406b, and may offer options to preview the results of applying different paste action definitions before finalizing the paste operation.

The system 300 includes a paste module 330 comprising both a conventional paste module 332 and the text generation module 326, enabling both conventional and generative paste operations.

The conventional paste module 332 performs standard paste operations on clipboard content 306 or processed clipboard content 308 to insert content into the destination document 314 as pasted content 310 without modifications.

The text generation module 326 performs generative paste operations on clipboard content 306 or processed clipboard content 308 to produce processed pasted content 312 by applying the paste action definition 346.

The paste action definition 346 may be selected through user selection, default settings, context-aware selection, or programmatic determination, enabling customizable generative processing during paste operations.

The paste operation 406 may be triggered by input 340 from the user 320, such as keyboard shortcuts (Ctrl+V, Cmd+V), menu selection, toolbar buttons, touch gestures, or voice commands. The user 320 may provide a single input that both specifies the paste location and triggers the paste operation 406, such as click-and-paste, touch-based insertion, voice commands with location specification, or smart insertion where selecting an insertion point automatically triggers the paste operation.

The system 300 recognizes these input types and initiates either the conventional paste operation 406a or the generative paste operation 406b based on user preferences or system settings.

The clipboard 328 may include both clipboard content 306 and processed clipboard content 308. The paste operation 406 may handle both types of clipboard content in various ways:
User Preference: The system 300 may allow the user 320 to set a default preference for which type of clipboard content to use during paste operations.
Context-Aware Selection: The system 300 may analyze the destination document 314 to determine which clipboard content is more appropriate and select accordingly.
User Prompt: The system 300 may present the user 320 with a choice between conventional clipboard content 306 and processed clipboard content 308 during paste operations.
Keyboard Shortcut Differentiation: The system 300 may assign different commands for pasting conventional content versus processed content.
Application-Specific Behavior: The system 300 may maintain different paste behaviors for different applications based on typical use cases.

These methods provide flexibility and control to the user 320, allowing them to leverage both conventional and generative paste capabilities while maintaining compatibility with traditional clipboard functionality.

The system 300 and method 400 may implement a special case involving applying generative copy to the original content 304 to produce the processed clipboard content 308, and then applying generative paste to the processed clipboard content 308 to produce the processed pasted content 312. This workflow leverages generative capabilities at both copy and paste stages.

In this special case, the generative copy operation 404b applies a copy action definition 344 to the original content 304, resulting in the processed clipboard content 308. Subsequently, the generative paste operation 406b applies a paste action definition 346 to the processed clipboard content 308, generating the processed pasted content 312 that is inserted into the destination document 314.

This double application of generative processing offers enhanced content transformation, workflow flexibility, iterative refinement, context-aware processing, and efficiency in complex tasks.

The copy action definition 344 and paste action definition 346 may be the same or different. When the same, this provides consistency and simplicity. When different, this enables multi-stage processing and context-aware adaptation.

Examples of different action definitions include: (1) language translation during copy followed by cultural adaptation during paste; (2) technical summarization during copy followed by simplification during paste. Examples of same action definitions include: (1) style transformation applied twice for reinforcement; (2) text simplification applied twice for progressive clarity.

Embodiments of the cut-and-paste system 300 and method 400 have a variety of advantages, such as one or more of the following.

The generative cut and paste features offer seamless integration with existing workflows by incorporating AI-driven content processing into familiar copy and paste operations. Unlike traditional chatbots that require separate interfaces, users can leverage AI capabilities directly within their normal document editing process through keyboard shortcuts, menu selections, or other input methods.

The system 300 provides granular control over content transformation by allowing users to apply action definitions to specific text selections rather than entire documents. Users can select individual words, sentences, paragraphs, or non-contiguous text portions for targeted transformation, applying different action definitions to different portions of the same document as needed.

The system supports customizable action definitions ranging from simple text prompts to complex scripted operations stored in an action definition library. This enables users to create domain-specific prompts, develop multi-step content transformations, and fine-tune AI behavior to match their specific workflow and preferences.

The two-stage processing capability enables separate generative processing during both copy and paste operations. During copying, users can apply an action definition to generate processed clipboard content. During pasting, users can apply a second action definition to the processed clipboard content, allowing for context-aware transformations that consider both source and destination document contexts. This enables more sophisticated content adaptations than single-step processes typical of chatbots.

Some embodiments of the present invention, which may (but need not) build upon the foundation of the systems 100 and 300 and methods 200 and 400 previously described herein, offers an innovative approach to text transformation and formatting within documents. These embodiments introduce the ability to apply sophisticated transformations to (“paint”) existing text, thereby modifying such text in complex ways not before possible, but with the ease and intuitiveness of traditional format painting tools. For example, and as described in more detail below, such embodiments enable a user to select text (the “destination text”), such as by dragging over that text, and thereby to cause the destination text to be modified automatically, such as by causing any type of action definition disclosed herein to be applied to the destination text to produce modified text (referred to herein as “painted text”), and to further cause the destination text to be replaced automatically with the painted text. The painted text may, for example, be produced by providing a prompt as an input to a language model (e.g., a large language model), which produces the painted text in response as an output. The prompt may, for example, be selected (e.g., generated) based on the destination text.

Optionally, in addition, the particular modification that is applied to the source text to produce the painted text may be selected (e.g., generated) based on other text (the “source text”). For example, before the user selects the destination text, the user may select the source text, which may be in the same or different document as the destination text. A “painting configuration” may be selected (e.g., generated) based on the source text, and the destination text may be modified based on the selected painting configuration. The painting configuration may, for example, be selected by providing a prompt as an input to a large language model, which produces output in response. That output may be used to select the painting configuration.

In some embodiments, the steps just described are only performed if and when the system is in a “painting mode.” The system may, for example, be put into the painting mode in response to user input selecting the painting mode, such as clicking on or otherwise selecting a button associated with the painting mode. Similarly, the system may be taken out of painting mode in response to user input deselecting the painting mode, such as clicking on or otherwise selecting the (toggle) button associated with the painting mode.

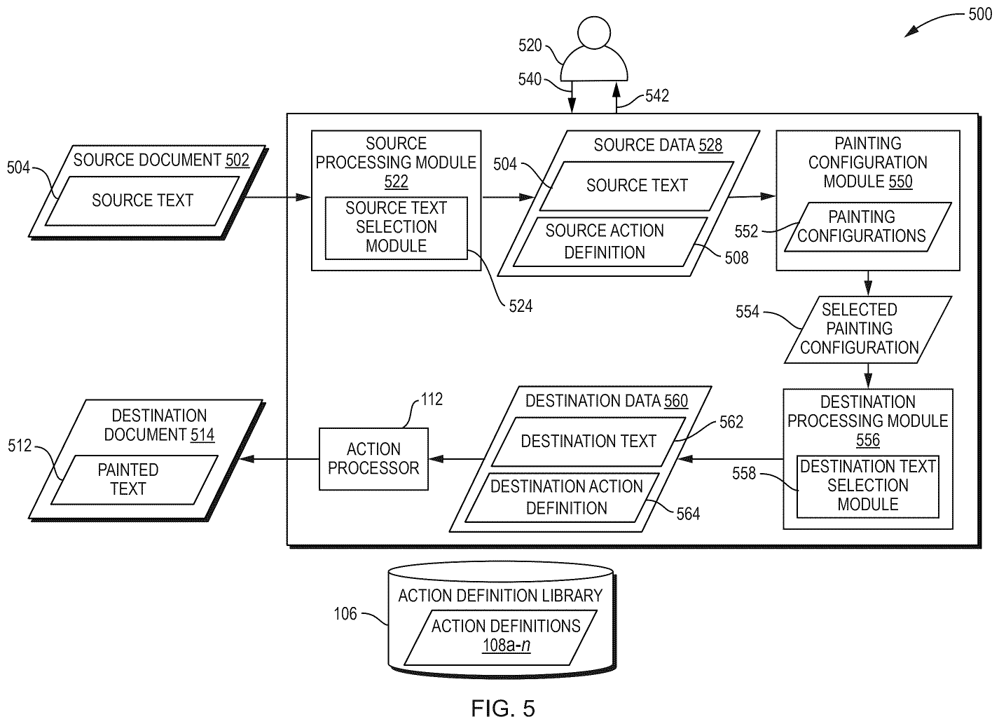

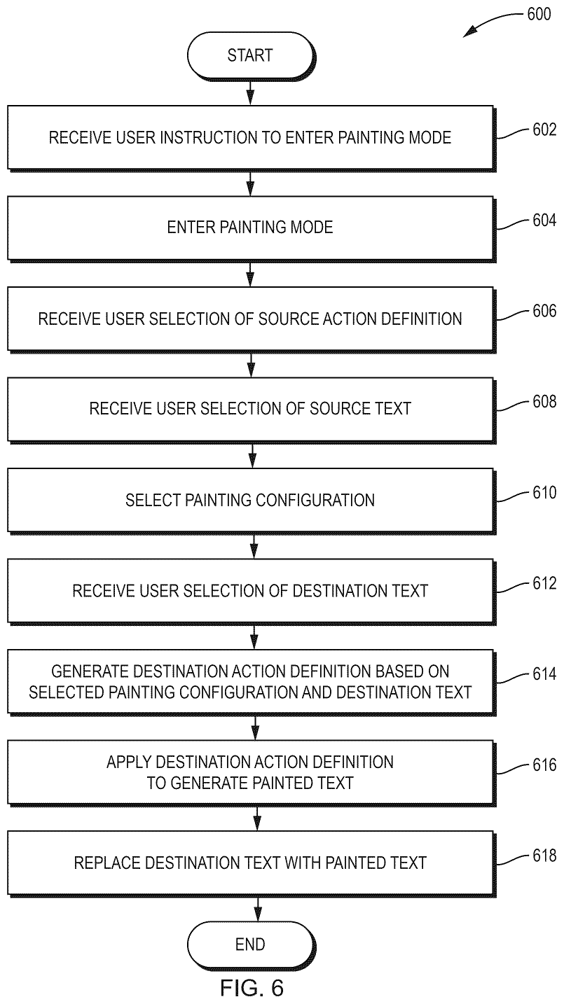

Referring to FIG. 5, a dataflow diagram is shown of a system 500 for implementing various painting features according to one embodiment of the present invention. Referring to FIG. 6, a flowchart is shown of a method 600 performed by the system 500 of FIG. 5 according to one embodiment of the present invention. The system 500 illustrated in FIG. 5 shares many similarities with the system 300 shown in FIG. 3, with some elements being identical or closely related but assigned different reference numerals. For instance, the user 520 in FIG. 5 corresponds to the user 320 in FIG. 3 and may represent the same entity (e.g., person). As such, the descriptions and functionalities associated with user 320 in the system 300 are equally applicable to user 520 in the system 500, unless explicitly stated otherwise in connection with FIG. 5.

The user 520 may provide input 540 representing an instruction to enter a painting mode. The system 500 may receive the input 540 from the user 520 representing the instruction to enter the painting mode (FIG. 6, operation 602). In response to receiving the input 540 representing the instruction to enter the painting mode, the system 500 may enter the painting mode (FIG. 6, operation 604). The painting mode enables the application of text transformations using paint action definitions. In some embodiments, the system 500 only performs certain operations (e.g., applying action transformations to destination text to produce painted text) while in painting mode. However, the painting mode is not required in all embodiments, as some allow for the application of paint action definitions without explicitly entering a designated painting mode.

The instruction to enter painting mode may take various forms in graphical user interfaces (GUIs), including:
Button or toggle switch in toolbar or menu bar
Menu selection from dropdown or context menu
Keyboard shortcut (e.g., Ctrl+P or Cmd+P).
Gesture-based activation on touch-enabled devices
Voice command in systems with voice recognition
Right-click context menu option

These input methods provide flexibility and accessibility for users to enter and exit the painting mode.

The user 520 may provide input 540 selecting a source action definition 508 from the action definitions 108a-n in the action definition library 106 (FIG. 6, operation 606). The source action definition 508 may be any type of action definition disclosed herein, including simple text prompts, tokenized prompts, compound prompts, or scripted prompts.

Alternatively, the system 500 may automatically select the source action definition 508 based on context-aware analysis, user history, default settings, or machine learning predictions. The user 520 may select the source action definition 508 once and reuse it in subsequent iterations of the method 600.

The user 520 may provide input 540 selecting source text 504. The system 500 may receive that input 540 (FIG. 6, operation 608). The source text 504 may, for example, be contained within a source document 502. The user 520 may select the source text 504 in any of the ways disclosed above in connection with the user 320's selection of the original content 304 in the system 300 of FIG. 3.

The system 500 may include a source processing module 522, which may perform a variety of functions, such as processing the user 520's selection of the source action definition 508 and/or the source text 504. The source processing module 522 may include a source text selection module 524, which receives the user 520's input 540 selecting the source text 504, and which extracts or otherwise prepares the source text 504 for further processing. The source data 528 may include the source text 504.

The source text selection module 524 may implement various methods for receiving and processing the user's input, similar to those described for selecting the original content 304 in the system 300 of FIG. 3. These methods could include mouse selection, keyboard shortcuts, touch gestures, voice commands, or programmatic selection, depending on the specific implementation and user interface of the system 500.

The system 500 may include a painting configuration module 550. The painting configuration module 550 may include a plurality of painting configurations 552, each of which specifies a corresponding transformation to be performed on text. Some or all of the painting configurations 552 may fall within the definition of an action configuration, as that term has previously been defined. In some embodiments, the painting configurations 552 are implemented as the action definitions 108a-n. In other words, the action definitions 108a-n may play the role of the painting configurations 552. More generally, however, the painting configurations 552 may take any form that is suitable for performing the functions disclosed herein in connection with the painting configurations 552, whether or not any particular such form qualifies as an action definition. Different painting configurations may be the same as or different from each other in any of a variety of ways.

The painting configuration module 550 selects one of the painting configurations 552, referred to herein as the selected painting configuration 554 (FIG. 6, operation 610). The painting configuration module 550 may select the selected painting configuration 554 based on the source text 504, the source action definition 508, or both in combination.

Unlike conventional format painters limited to text formatting properties, embodiments can “paint” destination text with properties derived from the source text 504, including:
Writing style, tone, or voice
Content structure (e.g., paragraphs to bullet points)
Vocabulary level and technical jargon
Language, dialect, and emotional tone
Summarization, expansion, and argumentation style

Different source text 504 or source action definitions 508 may cause selection of different painting configurations 554 that specify different transformations, enabling the system 500 to tailor transformations based on the specific nature of the source content.

The painting configuration module 550 may apply the source action definition 508 to the source text 504 to produce source action definition output, then select the selected painting configuration 554 based on this output. For example, if the source action definition 508 includes the prompt “Identify the tone of the source text” and produces output “informal”, the module may select a painting configuration designed to transform text into informal tone.

The user 520 may provide input 540 selecting destination text 562 (FIG. 6, operation 612). The destination text 562 may be contained within a destination document 514, which may be the same document as the source document 502 or a different document. The user 520 may select the destination text 562 using any of the selection methods disclosed above for the original content 304 in system 300.

The system 500 may include a destination processing module 556 and a destination text selection module 558, which receive the user 520's input 540 and extract the destination text 562 for processing. The destination data 560 may include the destination text 562.

The destination text selection module 558 may implement various selection methods including mouse selection, keyboard shortcuts, touch gestures, voice commands, or programmatic selection.

The destination processing module 556 generates the destination action definition 564 based on the selected painting configuration 554 and the destination text 562 (FIG. 6, operation 614), either by selecting from existing action definitions 108a-n or by generating a new definition.

The destination processing module 556 may generate a processed destination prompt by concatenating the prompt from the selected painting configuration 554 with the destination text 562. For example, if the selected painting configuration 554 includes “Rewrite the following text in an informal tone”, the module concatenates this with the destination text 562 to create a tailored prompt incorporating both transformation instructions and specific content.

Operation 614 is performed when the system 500 is in painting mode.

The system 500 applies the destination action definition 564 to generate painted text 512 (FIG. 6, operation 616) using an action processor 112 in any of the ways disclosed herein.

The destination action definition 564 may include or be generated based on the destination text 562. Operation 616 may apply the destination action definition 564 to some or all of the destination text 562 to produce the painted text output.

Where the destination action definition 564 is a final prompt generated based on the selected painting configuration 554 and destination text 562, operation 616 may provide the final prompt to a language model (e.g., LLM) which processes the prompt and generates the painted text output.

For example, if the final prompt is “Rewrite the following text in an informal tone: [destination text]”, the language model generates a version of the destination text rewritten in an informal tone.

The same or different language model may be used to generate the selected painting configuration 554 and the painted text output.

The painted text 512 may be the painted text output or generated based on the painted text output, allowing for post-processing, quality control, user intervention, or integration with other systems before replacing the destination text 562.

In some embodiments, operation 616 is performed if and only if the system 500 is in painting mode.

The system 500 replaces the destination text 562 in the destination document 514 with the painted text 512 (FIG. 6, operation 618). The system 500 may perform such replacement using any of the following methods:
Direct Replacement: Straightforward substitution of destination text 562 with painted text 512.
In-place Modification: Modifying destination text 562 while preserving formatting or structural elements.
Differential Update: Computing differences between texts and applying only necessary changes.
Staged Replacement: Side-by-side comparison before finalizing changes upon user confirmation.

The system 500 manifests the painted text 512 by replacing visual output representing the destination text 562 with visual output representing the painted text 512. This manifestation may include real-time preview, incremental updates, side-by-side comparison, highlighting changes, animated transitions, context-aware rendering, interactive editing capabilities, and undo/redo visualization.

In some embodiments, operation 618 performed if and only if the system 500 is in painting mode.

Various operations of the method 600 of FIG. 6 may be performed in different orders than those disclosed herein. Examples include:
Selecting source text 504 before activating painting mode;
Selecting painting configuration from painting configurations 552 before selecting source text 504;
Selecting destination text 562 before source text 504;
Iteratively applying the same configuration to multiple document parts;
Modifying the selected painting configuration 554 after text selection but before application.

Embodiments of the system 500 and method 600 enable users to transform text with minimal input. Key use cases include:
Quick Style Transformation: Select source text with desired style, activate painting mode, and click on destination text sections to apply the transformation.
Tone Adjustment: Apply consistent tone changes (e.g., formal to informal) across multiple document sections.
Language Simplification: Use a simplified paragraph as source text to simplify complex paragraphs throughout a document.
Multi-document Transformation: Apply transformations across different documents by selecting source text from one document and applying to destination text in other documents.

Benefits include time efficiency, consistency, reduced cognitive load, flexibility, and improved workflow.

The system 500 and method 600 provide extensive control through:
Multi-stage Transformation: Apply series of transformations combining style, tone, and formatting changes in customized sequences.
Context-aware Transformations: System analyzes destination document context and suggests tailored painting configurations.
Custom Action Definition Creation: Users can define custom prompts or scripts and combine existing action definitions for specialized transformations.
Interactive Refinement: Iteratively refine transformations by adjusting parameters and reapplying until desired outcome is achieved.
Language Model Configuration: Advanced users can select from multiple language models and adjust parameters for fine-tuned AI output.

These capabilities provide powerful tools for customized and context-aware transformations while balancing ease of use with precise control.

Several user interface enhancements extend the core generative text transformation capabilities disclosed herein. These enhancements include:
Generative Drag: Extends generative cut and paste functionality to drag operations, allowing users to apply action definitions dynamically as they drag text, with transformed output inserted at the destination.
Dynamic Action Selection: Intelligently selects and applies different action definitions in real-time based on the context of where text is being dragged.
Enhanced Touch Gestures: Touch-based interactions including pinch, spread, directional swipes, and multi-finger gestures mapped to specific text transformations.
Real-time Preview: Users can see and evaluate effects of different generative actions on text in real-time, including comparing multiple transformations simultaneously.

Embodiments implement a “generative drag” feature that extends generative cut and paste functionality to drag operations. Unlike traditional drag operations that move or copy text, this feature applies an action definition to dragged text, resulting in transformed content being inserted at the destination rather than the original selected text.

The basic workflow includes: (1) user selects text; (2) initiates generative drag operation; (3) system selects action definition; (4) system applies action definition to generate new content; and (5) when user releases drag, system inserts generated text at destination location.

The generative drag feature extends generative cut and paste functionality by: (1) combining operations into a single, fluid interaction; (2) enabling real-time processing with immediate visual feedback; (3) providing context-aware transformations based on drag operation's spatial context; and (4) making complex text transformations more intuitive through familiar drag-and-drop paradigm.

The generative drag feature incorporates dynamic action selection based on current drag location context. As users drag text across different document parts, the system analyzes potential destination areas and dynamically selects different action definitions. The system may apply these selections in real-time and display results in preview mode, updating continuously as the drag operation moves across different document sections.

Examples of dynamic action selection include: varying complexity levels (simplifying technical content for introductory sections, expanding detail for advanced sections); language translation across multilingual document sections; tone and style adaptation between formal and informal sections; and data visualization (generating appropriate charts based on destination context).

The system uses various context types for dynamic action selection, including: document structure (headings, section types); content complexity; writing style and tone; target audience; language and localization; data presentation requirements; citation styles; technical jargon levels; emotional tone; and time-based context.

Embodiments of the present invention incorporate gesture-based interactions for touch-enabled devices that integrate with the generative text transformation capabilities disclosed herein, allowing users to manipulate content with greater ease and precision.

Touch-based gestures may be employed to control features including:
Selecting source and destination text using double-tap, drag, or multi-finger gestures
Selecting and applying action definitions through circular motions or multi-finger swipes
Initiating generative drag operations using modified drag gestures
Controlling real-time previews and navigating transformation history
Switching between painting configurations and entering/exiting painting mode

Touch-based gestures may be replaced or complemented by camera-captured movements including hand signs, motion tracking, finger position detection, and dynamic gesture recognition. These vision-based inputs control the same functions as touch gestures through real-time camera processing, computer vision algorithms, and machine learning models.

Specific gesture categories include:
Pinch and Spread Gestures: Pinch triggers summarization actions, while spread initiates expansion or elaboration of selected text.
Swipe Gestures: Directional swipes adjust formality, complexity, and perspective. Swipe up increases formality, swipe down simplifies text, and left/right swipes provide perspective shifts.
Circular Motions: Clockwise rotation triggers rephrasing actions, while counterclockwise reverts text or cycles through different versions.
Multi-finger Gestures: Two-finger rotate adjusts tone precisely, three-finger swipes enable significant transformations like genre changes, and multi-finger pinch/spread provides contextual zooming.

Any gesture or gesture category may be mapped to and used to perform any action disclosed herein.

In action definitions, a “parameter” refers to a variable or placeholder that can be customized to modify text transformation behavior. Parameters enable flexibility and fine-tuning of generative processes. Examples include:
Complexity Level: Controls complexity from simple language to technical jargon.
Formality Scale: Adjusts language formality from casual to formal tones.
Summarization Ratio: Determines text compression degree (25%, 50%, 75% of original length).
Language Model Temperature: Adjusts randomness or creativity of language model output.
Citation Style: Specifies desired citation format (APA, MLA, Chicago).

Parameter values may be adjusted using gesture-based interactions or other input methods:
Swiping left/right: Decrease/increase parameter values.
Pinch/spread gestures: Reduce/increase parameter values.
Circular motions: Clockwise increases, counterclockwise decreases values.
Slider controls: Graphical controls for precise numerical adjustments.
Text input fields: Direct entry of numerical or textual values.
Voice commands: Spoken instructions for parameter adjustment.

User input-based parameter adjustment provides intuitive control, fine-grained adjustments, rapid experimentation, and seamless workflow integration, enabling users to tailor transformations precisely to their needs while maintaining an efficient interface.

The user interface enhancements complement generative cut and paste functionality by integrating text manipulation capabilities using LLMs into familiar document editing workflows.

Key enhancements include:
Generative Drag Feature: Extends generative cut and paste to drag operations, applying action definitions dynamically as users drag text, with transformed output inserted at the destination.
Dynamic Action Selection: Intelligently selects and applies different action definitions in real-time based on context of where text is being dragged.
Enhanced Touch Gestures: Touch-based interactions including pinch, spread, directional swipes, and multi-finger gestures for accessing generative text transformation capabilities.
Real-time Preview: Enables evaluation of generative actions on text in real-time and comparison of multiple transformations simultaneously.

These enhancements create synergies with existing action definitions and painting configurations through expanded accessibility via gesture-based interactions, context-aware application of transformations, enhanced customization control, workflow integration with painting mode, and real-time adaptation capabilities.

The user interface enhancements disclosed herein may improve workflow efficiency through:
Generative Drag Feature: Combines text selection, transformation, and placement into a single fluid interaction, reducing required steps.
Dynamic Action Selection: Automatically selects appropriate action definitions based on document context during drag operations.
Gesture-Based Interactions: Enables intuitive touch gestures for text transformation tasks without navigating menus.
Real-time Preview: Provides immediate visual feedback of transformations during application.

The system may address accessibility through customizable gesture sensitivity, multi-modal interactions, visual feedback, and voice integration capabilities.

Building upon the innovative text transformation capabilities described above, certain embodiments of the present invention include what is referred to herein as a “generative merge” feature, which introduces a powerful new paradigm for bulk document creation and personalization. This feature leverages the action definition framework and AI-driven content generation features disclosed herein to enable the automatic and semi-automatic creation of a wide variety of documents.

In the prior art, conventional “mail merge” features simply replace static placeholders with predefined data. In contrast, embodiments of the generative merge feature employ action definitions of any of the kinds disclosed herein to create highly personalized content, such as with the use of generative AI. This approach allows for the generation of unique, tailored text that goes far beyond simple data insertion, opening up possibilities for creating truly individualized documents at scale.

The generative merge feature may seamlessly integrates with the system architectures disclosed elsewhere herein, such as by utilizing text generation modules to apply complex transformations across multiple sections of a document or even across multiple documents. This integration ensures that the sophisticated content generation capabilities are applied efficiently and consistently throughout the merge process.

By incorporating the kinds of action definitions supported by embodiments disclose elsewhere herein-including simple text prompts, tokenized prompts, compound prompts, and scripted prompts—the generative merge feature offers unparalleled flexibility in defining how content should be and is generated and transformed during the merge operation. This allows for highly nuanced and context-sensitive content creation that can adapt to the specific needs of each user or use case.

Any use of the term “generative” in connection with embodiments of what is referred to herein as the “generative merge” or “merge” feature disclosed herein should be understood not to be limited to the use of generative AI or to the use of “generative” technologies, but may more generally encompass any technology or technologies that are capable of performing the functions disclosed herein, whether or not such technologies are “generative.” Instead the term “generative” is used merely as a convenient shorthand, except in cases in which specific generative AI technologies are explicitly mentioned.

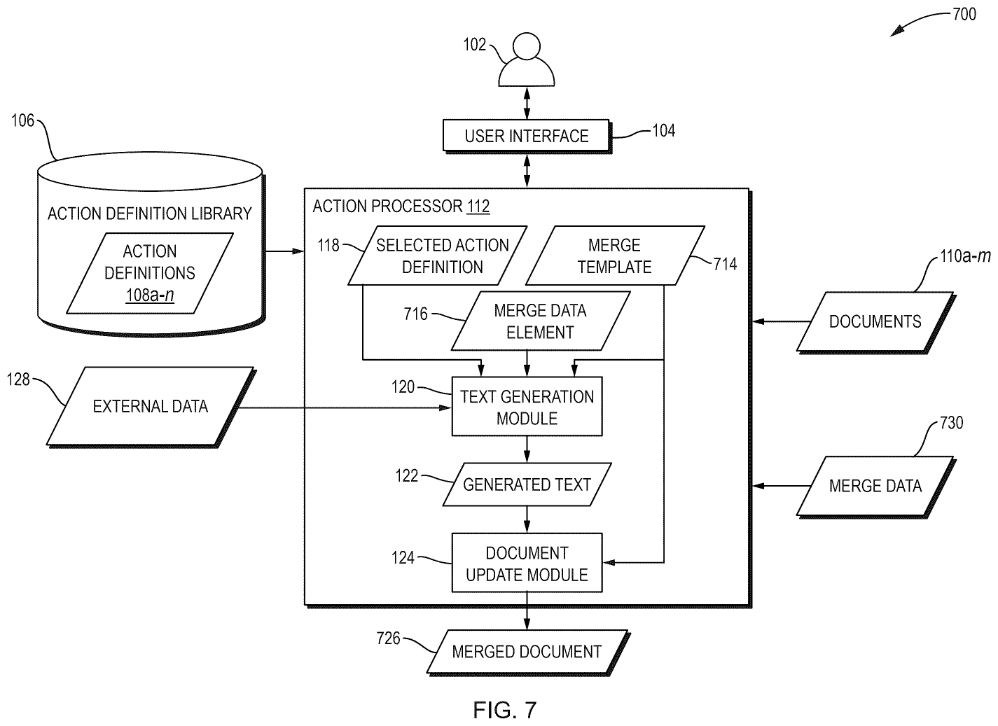

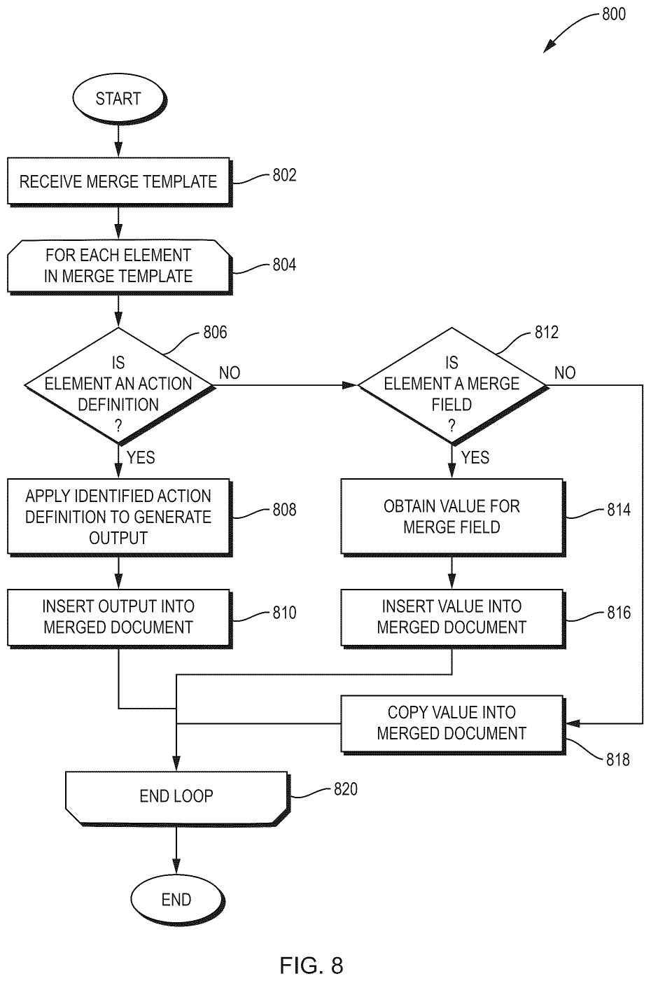

FIGS. 7 and 8 illustrate a system 700 and a method 800, respectively, for implementing the generative merge feature in certain embodiments of the present invention. This feature builds upon the text transformation capabilities described earlier in the specification, adapting them for a mail merge-like functionality that leverages action definitions for dynamic content generation. FIG. 7 presents a system diagram of the generative merge system 700, which shares several components with the system 100 depicted in FIG. 1. Elements that have the same reference numbers as in FIG. 1 may be implemented in the same or similar ways to those elements in FIG. 1. These shared components include, for example, the action definition library 106, the action definitions 108a-n, the external data 128, the user 102, the user interface 104, the action processor 112, the selected action definition 118, the text generation module 120, the generated text 122, the document update module 124, and the documents 110a-m. The system 700 introduces additional elements specific to the generative merge feature, such as the merge template 714, merge data element 716, merge data 730, and merged document 726. The generative merge feature may or may not make use of all of the elements shown in FIG. 7.

The system 700 may receive the merge template 714, which serves as the foundation for the generative merge process (FIG. 8, operation 802). This operation can be performed in various ways, and the merge template 714 can take a variety of different forms. The merge template 714 may be received through multiple input mechanisms that accommodate different user workflows and system integration requirements. The flexibility in receiving the merge template 714 enables the system 700 to adapt to diverse operational environments and user preferences.

Examples of ways in which the merge template 714 may be received include:
User Input: The user 102 may provide the merge template 714 through the user interface 104 by uploading files, pasting content, or selecting existing templates. The user interface 104 may support any of a variety of file formats including DOCX, PDF, HTML, or plain text files, and may provide template creation wizards for defining action definitions 108a-n and merge fields.
System Selection: The action processor 112 may automatically select the merge template 714 based on predefined criteria, user preferences, or machine learning algorithms that analyze user behavior patterns and document context to recommend appropriate templates from a repository organized by categories or usage patterns.
API Integration: The system 700 may receive the merge template 714 through API calls from external applications using RESTful APIs that support standardized formats such as JSON or XML, with authentication methods including API keys, OAuth tokens, or certificate-based authentication.
Database Retrieval: The system 700 may retrieve the merge template 714 from a database of stored templates with associated metadata, version control capabilities, and search functionality based on keywords, tags, or content similarity.
Cloud Storage Integration: The system 700 may connect to cloud storage services such as Google Drive, Dropbox, Microsoft OneDrive, or Amazon S3 to retrieve the merge template 714, with automatic synchronization across devices and caching mechanisms for improved performance.
Email Attachment Processing: The merge template 714 may be received as email attachments through automated email processing systems that monitor designated accounts and extract template files using protocols including IMAP, POP3, or Exchange Web Services.
Version Control System Integration: The system 700 may integrate with version control systems such as Git, SVN, or Perforce to retrieve the merge template 714 from code repositories, enabling collaborative template development with branch-based versioning and audit trails.
Content Management System Integration: The merge template 714 may be retrieved from content management systems such as SharePoint, Drupal, or WordPress, leveraging existing content approval workflows and providing bidirectional integration for publishing generated documents back to the CMS.
Drag-and-Drop Interface: The user interface 104 may support drag-and-drop functionality allowing the user 102 to drag template files from file explorers or web browsers into the system 700, with automatic file type detection and visual feedback during upload.
Scheduled Retrieval: The system 700 may implement scheduled retrieval mechanisms that automatically fetch the merge template 714 from specified sources at predetermined intervals using any of a variety of timing patterns including daily, weekly, monthly, or custom cron-based schedules with error handling and retry mechanisms.

While the merge template 714 may be referred to as a “document,” the merge template 714 may be any of a variety of data structures capable of containing action definitions and other content. Some examples of forms of the merge template 714 include:
Text Document: A traditional document format (e.g., .docx, .txt, .pdf, .rtf) containing text and embedded action definitions.
Structured Data Format: XML, JSON, YAML, or other structured data formats that define the template structure and action definitions.
Database Record: The template stored as a record or set of records in a database, with fields representing different parts of the template and action definitions.
Custom Data Structure: A proprietary data structure designed for the generative merge system, optimized for efficient processing of action definitions.
Hybrid Format: A combination of text and structured data, allowing for rich formatting alongside machine-readable action definitions.
Spreadsheet Format: A spreadsheet file (.xlsx, .csv, .ods) with cells containing action definitions and merge fields.
Web-based Format: HTML, Markdown, or other web-compatible formats with embedded action definitions.
Configuration File: INI, TOML, or other configuration file formats containing template structure and action definitions.
Binary Format: A compiled or encoded binary format optimized for processing speed and storage efficiency.
Template Engine Format: Formats compatible with template engines such as Jinja2, Mustache, or Handlebars templates.
Cloud-based Format: Templates stored in cloud services with API-accessible structure and action definitions.

Regardless of its form, the merge template 714 may serve as a container for action definitions and other content that may be processed by the generative merge feature to produce the merged document 726. The merge template 714 may be defined recursively using a content model that supports three fundamental types of content elements. In this recursive definition, content within the merge template 714 may be classified as static content, dynamic content, or hybrid content, where each type serves a specific role in the document generation process:
Static content may, for example, comprise traditional text elements that remain unchanged during the merge process. This may include, for example, fixed headings, standard paragraphs, boilerplate text, or any other textual elements that are not modified or generated by the action processor 112.
Dynamic content may, for example, include one or more action definitions that specify instructions for content generation using language models and/or other processing systems. When encountered during the merge process or when otherwise applied, dynamic content elements trigger the execution of their associated action definitions, resulting in the generation of new content that replaces or supplements the original dynamic element. The generated content may itself be static, dynamic, or hybrid in nature.
Hybrid content represents a collection (e.g., list) of content elements, where each element in the collection may be static content, dynamic content, or hybrid content. This recursive structure enables the creation of complex document hierarchies where different types of content may be nested and combined in sophisticated ways.

The recursive nature of this content model enables the merge template 714 to support arbitrarily complex document structures. For example, a hybrid content element may contain a list that includes static text, followed by a dynamic content element that generates additional content, followed by another hybrid content element that itself contains a nested combination of static and dynamic elements. This flexibility allows for the creation of merge templates that can generate documents with varying levels of complexity and customization.

This recursive content definition provides the foundation for the generative merge feature's ability to process templates containing mixed content types while maintaining the relationships and hierarchies between different content elements throughout the merge process.

Regardless of its form, the merge template 714 serves as a container for action definitions and other content that will be processed by the generative merge feature to produce the merged document 726.

The merge template 714 may be created through various user interface mechanisms that enable intuitive template construction while providing powerful customization capabilities. The system 700 may, for example, support graphical user interface elements including menu-driven selection of action definitions from the action definition library 106, displaying short names such as “Summarize|Rephrase|Expand” for easy selection. The system 700 may provide buttons or toolbar options for inserting action definitions into the template, context menus that appear when right-clicking to add elements, and visual indicators highlighting different element types such as action definitions, merge fields, and static content. These interface mechanisms enable users to construct merge templates 714 efficiently while maintaining clear visibility of different element types throughout the template creation process.

Users may select action definitions through any of a variety of interaction methods that accommodate different user preferences and workflow requirements. For example, users may click on manifested short names in menus or buttons, use voice commands specifying desired actions, employ keyboard shortcuts for frequently used definitions, or utilize programmatic selection through APIs. These selection mechanisms provide flexibility in how users interact with the action definition library 106, enabling both manual and automated approaches to template construction. The system 700 may support use of any of a variety selection methods, allowing users to combine different interaction approaches based on their specific needs and the complexity of the merge template 714 being created.

The system 700 may enable users to perform any of a variety of customization operations including adding new action definitions to the library, modifying existing action definitions using text editor interfaces, creating custom prompts for language models, and/or defining metadata such as descriptions and short names. These customization capabilities allow users to extend the functionality of the system 700 beyond the default action definitions 108a-n provided in the action definition library 106. Users may create specialized action definitions tailored to their specific document generation requirements, industry-specific terminology, and/or organizational standards. The customization process may include validation mechanisms to ensure that newly created or modified action definitions function correctly within the merge template processing workflow.

Interactive preview capabilities may be provided to enhance the template creation experience, allowing users to preview generated content before finalizing action definitions, supporting iterative refinement of action definitions, and/or providing real-time feedback on transformation results. These preview features enable users to test and refine their merge templates 714 during the creation process, reducing the likelihood of errors in the final merged documents 726. The preview functionality may display sample outputs based on test merge data 730, allowing users to evaluate how their action definitions will perform with actual data. Users may iterate through any of a variety of preview cycles, adjusting action definitions and template structure until the desired output quality is achieved.

Advanced configuration options may include fine-tuning of language model parameters, creation of compound and chained action definitions, definition of custom tokens and variables, and/or specification of transformation rules and constraints. These advanced features enable sophisticated users to create complex merge templates 714 that perform multi-stage content transformations and handle intricate document generation scenarios. The system 700 may provide any of a variety of specialized interfaces for advanced configuration, including visual editors for compound action definitions, parameter adjustment controls for language model settings, and/or rule-based constraint definition tools. Advanced configuration capabilities may also include integration with external data 128 sources and/or custom processing logic that extends beyond standard language model operations.

The system 700 may maintain flexibility through support for both simple and advanced editing interfaces, any of a variety of input methods including mouse, keyboard, voice, and/or programmatic approaches, various levels of user involvement in template creation, and/or integration with existing document editing workflows. This flexibility ensures that the system 700 can accommodate users with different technical expertise levels and diverse workflow requirements. Simple editing interfaces may provide streamlined access to common functionality, while advanced interfaces may expose the full range of customization options. The system 700 may automatically adapt its interface complexity based on user preferences and/or detected usage patterns, providing an optimal balance between functionality and usability for each individual user.

This interface design enables users to efficiently create sophisticated merge templates while maintaining precise control over document structure and content generation capabilities. Merge templates and merged documents in embodiments of the present invention may have any one or more of the following useful features, in any combination.

Embodiments of the present invention may provide action definition integration capabilities within merge templates. For example, merge templates may include action definitions that specify prompts for large language models to generate content dynamically. Such action definitions may enable text transformations beyond simple field value substitution. The system 700 may process action definitions by providing their specified prompts to language models to generate output. This integration allows merge templates to leverage advanced AI capabilities while maintaining the structured approach of traditional mail merge operations.

The system 700 may support hybrid element functionality within merge templates. A single merge template 714 may contain a mix of one or more action definitions, one or more conventional merge fields, and/or any amount of static content, interspersed in any way throughout the template structure. The system 700 may process each element type differently based on the element's characteristics and purpose. For example, action definitions may trigger LLM-based content generation, merge fields may receive conventional field values from merge data 730, and static content may be copied directly to the merged document 726. This hybrid approach enables templates to combine the flexibility of AI-generated content with the reliability of traditional merge operations.

Embodiments of the present invention may incorporate multiple action definition types within a single merge template 714. A single merge template 714 may contain multiple different action definitions that vary in any of a variety of ways. Such action definitions within a single merge template 714 may differ in their prompt specifications, their types such as simple text, tokenized, compound, or scripted variations, and their transformation rules and parameters. This diversity of action definition types enables merge templates to perform complex, multi-stage content generation operations while maintaining document structure and coherence across different processing requirements.

The system 700 may provide enhanced content generation capabilities through merge templates that support context-aware content generation through action definitions. Generated content may adapt based on any one or more of merge data values, document context, and recipient-specific information. This contextual awareness enables the text generation module 120 to produce content that is specifically tailored to each document instance while maintaining consistency with the overall template structure. The adaptation process may consider multiple data sources simultaneously to generate content that is both relevant and coherent within the document's intended purpose.

Embodiments of the present invention may maintain structured control over document generation processes. Templates may maintain author-defined structure while enabling dynamic content generation through the coordinated operation of the action processor 112 and document update module 124. Authors may specify which elements remain static and which should be dynamically generated, providing precise control over the balance between automation and consistency. The system 700 may preserve document integrity while allowing sophisticated content transformations, ensuring that generated documents maintain professional quality and structural coherence regardless of the complexity of the underlying generation processes.

The system 700 may support multi-instance generation capabilities where templates may result in generating multiple document instances with consistent structure. Each instance may incorporate different merge field values, uniquely generated content from action definitions, and context-specific adaptations based on the particular merge data 730 associated with that instance. This multi-instance approach enables organizations to generate large numbers of personalized documents while maintaining the efficiency benefits of template-based processing. The document update module 124 may ensure that each generated instance maintains structural consistency while allowing for sophisticated content variations that reflect the specific requirements of each document recipient or use case.

When creating the merge template 714, embodiments of the present invention may enable users to freely place action definitions at any arbitrary location within the template. For example, users may select or create any type of action definition and position it wherever desired within the template structure.

The merge template 714 may contain any combination and sequence of action definitions that specify various types of transformations and prompts, traditional merge fields for data insertion, and static content like plain text. In some embodiments, the merge template 714 may include action definitions that define complex language model operations alongside conventional merge fields that enable simple data substitution. The merge template 714 may incorporate static content elements that remain unchanged during the merge process, providing structural consistency across generated document instances. This flexible architecture enables the merge template 714 to support both traditional mail merge functionality and advanced generative content capabilities within a single template structure.

This flexibility allows users to insert action definitions at any point in the template where dynamic content generation is desired. Users may intersperse action definitions with conventional merge fields and static content throughout the template structure. Additionally, users may define multiple different action definitions throughout the template, with each action definition potentially specifying different prompts or transformation rules. This approach enables sophisticated document customization while maintaining template organization and readability.

The system may place no restrictions on the number of action definitions that can be included within a single merge template, the locations where action definitions can be placed within a single merge template, the combinations of elements (action definitions, merge fields, static content) that can be used within a single merge template, or the sequence in which different element types appear within a single merge template. This flexible approach enables merge templates to incorporate action definitions at any position within the template structure, allowing for dynamic content generation at arbitrary points during the merge process. The system may support templates that contain only action definitions, only merge fields, only static content, or any combination of these element types in any order. For example, a merge template may begin with static content, include multiple action definitions interspersed with merge fields, and conclude with additional static content, or may follow any other arrangement that serves the document author's requirements. This unrestricted placement capability allows document authors to design merge templates that precisely match their intended document structure while incorporating generative capabilities wherever dynamic content generation would enhance the final output.

This arbitrary placement and combination capability enables users to create highly customized templates that precisely specify where and how dynamic content generation should occur while maintaining complete control over document structure.

Action definitions may be embedded into the merge template 714 in a variety of ways, providing flexibility in implementation while maintaining compatibility with different document formats and systems. Metadata-based embedding approaches may include XML or custom tags, where action definitions may be embedded using invisible tags surrounding dynamic content, such as ‘visible text’. These tags may contain the action definition parameters while keeping the underlying content visible to users during template creation and editing. The system may alternatively store action definitions in document properties fields that are linked to specific text ranges within the merge template 714. This approach may leverage existing document property systems while maintaining clean separation between content and processing instructions. Action definitions may also be embedded using hidden characters, such as zero-width Unicode characters or special formatting marks as delimiters. These invisible markers may define the boundaries of dynamic content sections while preserving the visual appearance of the template. Style-based embedding represents another metadata approach, where the system may utilize custom paragraph or character styles that contain action definition data within their properties. This approach may integrate seamlessly with existing document formatting systems while providing a user-friendly method for defining dynamic content areas.

Field-based embedding methods may leverage existing document infrastructure to incorporate action definitions. Form fields may be used to embed action definitions by leveraging existing document field infrastructure, similar to traditional mail merge fields such as Word's MERGEFIELD functionality. This approach may provide compatibility with existing document editing workflows while extending capabilities to include generative processing. The system may use rich content controls with custom XML properties to embed action definitions, where these controls may provide structured containers for both the action definition parameters and the content they will process. Bookmarks represent another field-based approach, where action definitions may be associated with hidden bookmarks that contain prompt data and processing instructions. This method may enable precise positioning of dynamic content while maintaining document structure. The system may also utilize invisible comment threads containing action definitions, where these comments may be linked to specific text ranges and may contain all necessary processing parameters while remaining hidden from normal document viewing.

External reference systems provide alternative approaches for embedding action definitions while maintaining separation between template structure and processing logic. A UUID system may be implemented where each dynamic section within the merge template 714 has a unique identifier that links to an external action definition database. This approach may enable centralized management of action definitions while keeping the template document lightweight and focused on structure. Sidecar files represent another external reference method, where action definitions may be stored in companion files that maintain position mappings to corresponding locations within the merge template 714. This method may provide clear separation between template structure and processing logic while enabling version control and sharing of action definitions across multiple templates. Cloud storage approaches may store action definitions in cloud-based repositories, with the merge template 714 containing only reference identifiers. This approach may enable collaborative editing, centralized updates, and scalable management of action definition libraries across distributed teams.

Hybrid approaches may combine multiple embedding methods to optimize for different requirements and use cases. Multi-layer embedding may combine multiple embedding methods within a single merge template 714, such as using metadata for simple action definitions while employing external references for complex, reusable processing logic. Conditional embedding may utilize different methods based on the characteristics of specific action definitions, where simple transformations may use style-based embedding while sensitive or complex operations may use external reference systems. Format-adaptive embedding represents another hybrid approach where the embedding method may automatically adapt based on the document format and capabilities of the target system. For instance, XML-based documents may use custom tags while binary formats may rely on metadata or external references. These various embedding approaches may be selected based on factors such as document format compatibility, processing requirements, security considerations, and collaborative workflow needs.

The flexibility in embedding methods enables embodiments of the present invention to adapt to various document formats, user workflows, and technical requirements while maintaining consistent processing capabilities across different implementation approaches. Users and system administrators may select the most appropriate embedding method based on their specific needs, technical constraints, and integration requirements.

When the system 700 manifests the merge template 714 to users, the system 700 may manifest action definitions within the merge template 714 in any of a variety of ways, providing flexibility in how users view and interact with embedded action definitions during template creation and editing.

Action Definition Label Manifestation: The system 700 may manifest an action definition label (also referred to herein as a “short name”) corresponding to a manifested action definition. These labels may provide concise, user-friendly identifiers that summarize the purpose or function of each action definition without revealing the underlying technical details. For example, an action definition containing a complex prompt for content summarization may be manifested simply as “Summarize” or “Create Summary.”

Selective Data Manifestation: More generally, the system 700 may manifest any data within the action definition, or any subset thereof, or any information derived therefrom. This approach may enable users to view different levels of detail based on their needs and preferences. The system 700 may manifest metadata such as descriptions, parameter specifications, or transformation rules while keeping other technical details hidden.

Prompt Visibility Options: In some cases, the system 700 may manifest some or all of the prompt contained within an action definition. This approach may provide users with complete transparency regarding how content will be generated, enabling them to understand and verify the specific instructions that will be provided to language models. In other cases, the system may not manifest the prompt contained within an action definition, instead relying on labels or descriptions to convey the action definition's purpose.

The system 700 may implement hybrid approaches that combine the benefits of different manifestation methods. For example, the system may manifest labels by default while providing expandable sections or hover tooltips that reveal additional details when needed. The system may also support user-configurable manifestation preferences, enabling different users to view action definitions at their preferred level of detail.

Merge templates incorporating the generative capabilities of embodiments of the present invention may be particularly well-suited for various content types that benefit from structured personalization. For example, email marketing applications may include marketing campaign templates that dynamically generate personalized content based on recipient data, product recommendation sections that adapt messaging to customer segments, and call-to-action content tailored to recipient engagement history. Business communications may utilize proposal templates that generate customized value propositions, contract templates with dynamically generated terms and conditions, and client reports with context-aware analysis and recommendations. Customer service applications may employ response templates that generate personalized solutions, support documentation that adapts technical content to user expertise levels, and follow-up communications with context-aware engagement content. Educational materials may include course materials that adapt explanations to student levels, assessment templates that generate personalized feedback, and learning resources with dynamically adjusted complexity. HR communications may utilize offer letter templates with role-specific details and benefits, performance review templates with customized feedback generation, and training materials adapted to employee roles and experience.

Each of these applications benefits from the system's ability to maintain consistent document structure while enabling sophisticated content generation. The system may process multiple data sets to create personalized document instances, allowing for scalable document production across various use cases. Embodiments of the system may apply different action definitions for various content sections, enabling targeted transformations within different portions of the same document. The system may combine static content with dynamically generated elements, providing flexibility in document composition while preserving author-defined structural elements and ensuring coherent integration of both fixed and generated content components.

As just one example, and without limitation, the following is an example of a particular embodiment of a merge template that includes both traditional merge fields and action definitions that include prompts that are designed to be provided as inputs to a generative AI-based module, such as a large language model:
Subject: {customer_name}, Your Personalized Travel Recommendations
Dear {customer_name},
[ACTION_DEFINITION_1]
“Generate a personalized travel destination recommendation based on the following customer data:
   Previous destinations: {travel_history}
   Budget range: {budget_preference}
   Travel style: {travel_style}
   Write in an engaging, conversational tone highlighting 2-3 specific destinations.”
   [/ACTION_DEFINITION_1]
Based on your interests, here are some exclusive offers for your next adventure:
[ACTION_DEFINITION_2]
“Using the recommended destinations above, generate compelling promotional offers that:
   Highlight unique experiences.
   Include specific pricing details using {budget_preference}
   Create urgency through limited-time messaging
   Format as 3 distinct bullet points with emotional appeal”
   [/ACTION_DEFINITION_2]
Book your trip by {offer_expiration_date} to receive:
   Complimentary airport transfers
   Priority check-in at all hotels
   Exclusive local experiences
[ACTION_DEFINITION_3]
“Generate a personalized call-to-action paragraph that:
   References the customer's loyalty tier: {loyalty_status}
   Mentions their available reward points: {point_balance}
   Provides a clear next step for booking
   Use an encouraging but not pushy tone”
   [/ACTION_DEFINITION_3]
Best regards,
Your Travel Team

Operation 804 of the method 800 initiates a loop that iterates over each “element” in the merge template 714. This loop serves as the core mechanism for processing the contents of the merge template 714 and generating the merged document 726. The primary purpose of this loop may be to systematically analyze and process each element within the merge template 714. During each iteration, the system 700 determines the nature of the current element and takes appropriate action based on its type. For example, the loop may identify action definitions that need to be applied, recognize conventional merge fields that require processing, and handle any other content that should be copied directly into the merge document.

This approach allows for a flexible and comprehensive processing of the merge template, accommodating various types of content and transformations.

The “elements” that are looped over in operation 804 may take various forms, depending on the structure and format of the merge template 714. Elements may include, for example, any one or more of the following:
Characters: Individual characters within the merge template, allowing for character-by-character processing.
Tokens: Larger units of text or data that represent meaningful segments within the template, such as words, phrases, or specific markers.
XML/HTML Tags: If the merge template is structured using markup languages, elements could be defined by tags.
JSON Objects: For templates structured as JSON data, elements could be individual key-value pairs or nested objects.
Database Fields: If the merge template is represented as a database structure, elements could correspond to individual fields or records.
Custom Delimiters: The system may use custom delimiters to define elements, such as special character sequences that denote the beginning and end of action definitions or merge fields.
Semantic Units: Elements could be defined based on the semantic meaning within the document, such as sentences, paragraphs, or sections.

The flexibility in defining what constitutes an “element” allows the system 700 to adapt to various template formats and structures, enhancing its versatility in handling different types of document generation scenarios. By systematically processing these elements, the loop ensures that all components of the merge template 714 are appropriately handled, whether they require the application of sophisticated action definitions, the insertion of merge data, or simple copying into the final merged document 726.

Operation 806 of the method 800 involves determining whether the current element being processed is (or points to or otherwise specifies) an action definition. This step allows the system 700 to identify which elements require special processing through the application of action definitions. This step enables the system 700 to differentiate between content that needs dynamic generation and content that can be directly copied or processed using conventional merge techniques.

The system 700 may implement operation 806 in various ways, depending on the structure of the merge template 714 and the representation of action definitions. Some example implementation methods include:
Delimiter-based identification: The system 700 may look for specific delimiters or markers that indicate the beginning and end of an action definition. For example, action definitions may be enclosed in special characters or tags.
Token analysis: If the merge template 714 is processed as tokens, the system 700 may analyze each token to determine if it matches the structure or pattern of an action definition.
Semantic parsing: The system 700 may use more advanced parsing techniques to understand the semantic meaning of each element and identify those that represent action definitions.
Reference lookup: If action definitions are stored separately and referenced within the template, the system 700 may check if the current element is a reference or pointer to an action definition in the action definition library 106.
Metadata analysis: The merge template 714 may include metadata that specifies which elements are action definitions. The system 700 may analyze this metadata during the processing loop.
Type checking: If the merge template 714 uses a structured format (e.g., XML, JSON), the system 700 may check the type or attributes of each element to determine if it represents an action definition.
Pattern matching: The system 700 may use regular expressions or other pattern matching techniques to identify elements that match the expected structure of action definitions.
Hash-based identification: The system 700 may compute hash values or checksums of elements and compare them against a precomputed hash table of known action definitions, enabling rapid identification through mathematical comparison rather than textual analysis.
Machine learning classification: The system 700 may employ trained machine learning models, such as neural networks or decision trees, to classify elements as action definitions based on learned patterns from training data, enabling adaptive identification that improves over time.
Signature-based detection: The system 700 may identify action definitions through unique binary or textual signatures embedded within elements, similar to how antivirus software identifies malicious code through signature matching.
Context-aware identification: The system 700 may analyze the surrounding context of elements, including preceding and following elements, to determine whether an element represents an action definition based on its position and relationship to other template components.
Version-based identification: The system 700 may identify action definitions through version identifiers or compatibility markers that indicate the specific format or generation of action definition being used within the merge template 714.
Namespace-based identification: The system 700 may use namespace prefixes or URI-based identification schemes to distinguish action definitions from other elements, particularly in XML-based or web-standard formats.
Statistical analysis: The system 700 may employ statistical methods to analyze element characteristics such as length, character distribution, or structural complexity to probabilistically determine whether elements represent action definitions.
Hybrid identification: The system 700 may combine multiple identification methods simultaneously, using primary and secondary validation techniques to increase accuracy and reduce false positives in action definition detection.

The specific implementation method chosen may depend on factors such as the format of the merge template 714, the representation of action definitions, and the overall design of the system 700. The flexibility in implementation allows the generative merge feature to adapt to various document structures and use cases while maintaining the ability to identify and process action definitions effectively.

The selected action definition 118 in the system 700 may be the action definition represented or specified by the current element, if the current element is determined to be or otherwise specify an action definition in operation 806. This alignment between the current element and the selected action definition 118 allows for seamless integration of the generative merge feature with the existing action definition processing capabilities of the system 700.

If the current element is determined to be an action definition in operation 806, the method 800 may proceed to apply this action definition (referred to as the “current action definition”) to generate output in operation 808. This generated output may, for example, be produced using any of the previously disclosed methods for utilizing the text generation module 120 to apply the selected action definition 118 and generate the generated text 122. In fact, the output generated in operation 808 may be the generated text 122.

The process of generating output in operation 808 may leverage the existing infrastructure and capabilities of the system 700, which are consistent with those described elsewhere herein. Specifically, the text generation module 120 may process the current action definition in the same manner in which it would process the selected action definition 118 in the system 100 of FIG. 1. This approach allows for the application of various types of action definitions within the context of the generative merge feature, including simple text prompts, tokenized prompts, compound prompts, and scripted prompts. The flexibility in action definition types enables sophisticated and context-aware content generation during the merge process.

It is important to note, however, that in at least some embodiments of the system 700, the selected text 116 of the system 100 of FIG. 1 is not utilized. This distinction highlights a key difference between the generative merge feature and the text transformation capabilities described elsewhere herein. In the context of the generative merge feature, the action definitions may be applied to generate new content based on their inherent instructions and parameters, rather than transforming existing selected text.

The text generation module 120 in operation 808 offers flexibility in how it generates output based on the current action definition. For example, the text generation module 120 may apply solely the current action definition to generate the output. This approach focuses on the specific instructions contained within the action definition itself. Alternatively, the text generation module 120 may apply both the current action definition and any of the other data disclosed in the specification, such as the external data 128 and/or one or more of the documents 110a-m.

Operation 810 of the method 800 involves inserting the generated output into the merged document 726. This operation may be implemented in at least one of two ways:
Building a New Document: In this approach, the system 700 creates a new document based on the merge template 714 to produce the merged document 726. As the method 800 processes each element of the merge template 714, it inserts the generated output at the current location in the new document. This method allows for a clean separation between the original template 714 and the final merged document 726, without modifying the merge template 714.
In-Place Replacement: Alternatively, the system 700 may replace content in the merge template 714 “in place.” In this implementation, the generated output replaces the action definition directly within the merge template 714. At the conclusion of method 800, the modified merge template 714 becomes the merged document 726. This approach can be more efficient in terms of memory usage and may be preferable for large documents.

Both implementations use a “current location,” which represents the point in the document where the method 800 is currently processing and inserting output. As the method 800 iterates through each element of the merge template 714, the current location advances, ensuring that generated content is inserted in the correct sequence and position within the merged document 726.

The application of the current action definition to generate output and insert it into the merged document 726 may be implemented with varying degrees of user involvement, ranging from fully automated (i.e., no user involvement) to highly interactive processes.

In a fully automated approach, the system 700 may apply the current action definition, generate the output, and insert it into the merged document 726 without any user intervention. This method maximizes efficiency and is suitable for scenarios where rapid document generation is prioritized.

Alternatively, the system 700 may incorporate various forms of user input during operations 806, 808, and/or 810, such as any one or more of the following:
Review and Approval: The system may present the generated output to the user 102 for review before insertion into the merged document 726. This allows the user to verify the output's accuracy and appropriateness. The user interface 104 may, for example, display the generated output alongside the original action definition, enabling the user to compare and make informed decisions.
Alternative Take Selection: For “alternative take” action definitions, which generate multiple outputs, the system 700 may present such outputs to the user 102 through the user interface 104 (e.g., simultaneously or sequentially). The user 102 may then select their preferred output for inclusion in the merged document 726, in response to which the system 700 may insert only the user-selected output into the merged document 726. This approach leverages the power of automatically-generated content while maintaining user control over the final document.
Interactive Refinement: The system 700 may allow the user 102 to modify the generated output directly through the user interface 104 before it is inserted into the merged document 726. This enables fine-tuning of the automatically-generated content to better suit specific requirements.
Contextual Feedback: The system 700 may provide the user 102 with information about how the generated output fits within the broader context of the merged document 726. This may include previews of surrounding content or analysis of document coherence, allowing the user 102 to make more informed decisions about content insertion.

By offering these various levels of user interaction, the generative merge feature may combine the efficiency of automated content generation with the precision and control of manual editing. This flexibility allows the system 700 to adapt to different user preferences and document generation scenarios, ensuring that the final merged document 726 meets the desired quality and content standards.

The method 800 may process any conventional merge fields in the merge template 714 as follows. In operation 812, the method 800 may determine whether the current element is a merge field, such as any kind of merge field conventionally used in mail merge templates. Conventional merge fields may, for example, take the form of text enclosed in double angle brackets (e.g., < >), text surrounded by curly braces (e.g., {LastName}), or text prefixed with special characters (e.g., &Address&). The system 700 may, for example, employ any of the techniques disclosed in connection with operation 806, such as delimiter-based identification that searches for specific bracket patterns, token analysis that identifies field markers within template text, or pattern matching using regular expressions to detect merge field syntax, to determine if the current element represents a merge field.

If the current element is identified as a merge field, the system 700 may obtain a value for that field, such as by using any known technique for obtaining a value of a merge field in a mail merge template, such as any one or more of the following: retrieving data from the merge data 730, querying a database or external data source, applying predefined rules or calculations, or prompting the user for input.

In operation 816, the method 800 may insert the obtained value into the merged document 726. Similar to operation 810, this step involves inserting the obtained value into the merged document 726 at the current location. The system 700 may use the same approach as described for inserting generated output from action definitions, namely either building a new document or performing in-place replacement of the merge field in the merge template 714. The concept of the “current location” remains applicable, ensuring that merge field values are inserted in the correct sequence and position within the merged document 726.

By processing both action definitions and conventional merge fields, the method 800 provides a comprehensive approach to document generation, combining the power of AI-driven content creation with traditional mail merge functionality.

Some embodiments of the present invention may omit operations 812, 814, and 816, or may only perform those operations in certain circumstances, such as if conventional merge processing has been enabled, e.g., by default or based on user input.

Operation 818 of the method 800 handles the case where the current element is neither an action definition nor a merge field. In this scenario, the method 800 copies the current element into the merged document 726 or leaves the current element unchanged within the merge template 714 in operation 818. Operation 818 may occur, for example, when the current element is static content, such as plain text, formatting elements, images, or other content that does not require automated processing. In some cases, operation 818 may also handle elements that represent structural components of the document, such as headers, footers, or layout elements. The current element may also include metadata elements, style definitions, or other document components that are intended to be preserved in the merged document 726 without modification.

This approach ensures that all content from the merge template 714 is preserved in the final merged document 726, even if it does not require special processing. By maintaining the original content, the system 700 can generate documents that seamlessly blend dynamically generated content (from action definitions), merged data (from conventional merge fields), and static content (from unprocessed elements).

Some embodiments of the generative merge feature expand upon the capabilities of the system 700 and method 800 by incorporating an enhanced version of the merge data 730. This enhanced merge data 730 may serve a dual purpose, supporting both conventional merge fields and providing specialized data for action definitions (referred to herein as “action definition data”) within the merge template 714.

The high-level purpose of such embodiments is to create a more versatile and powerful document generation system that seamlessly integrates traditional mail merge functionality with AI-driven content creation. By leveraging both conventional merge data and action definition data, the system 700 can produce highly customized documents that combine static content, dynamically merged information, and sophisticated AI-generated text.

Functionally, this embodiment enables the system 700 to process the merge template 714 and create a single merged document 726 that incorporates:
Conventional merge field data
AI-generated content based on action definitions
Static content from the original template

This approach enhances the flexibility and customization options available to users, allowing for the creation of complex, context-aware documents that can adapt to specific data inputs and requirements.

Note that, in some embodiments, the merge data 730 may only include action definition data for use with action definitions, and not include any conventional merge data. This configuration allows the system 700 to focus solely on leveraging AI-driven content generation through action definitions, without the need to process traditional merge fields. In such cases, operations 812, 814, and 816 may be omitted from the method 800 (FIG. 8), as these operations relate to processing conventional merge fields and copying static values into the merged document.

To enable the use of the merge data 730 in enhancing the generation of the merged document 726, the system 700 and method 800 may include some or all of the following modifications:
Data Structure Enhancement: The merge data 730 may be structured to include action definition data, or both action definition data and conventional merge data. This may, for example, be implemented as a hierarchical data structure or a key-value store, where each action definition in the merge template 714 has a corresponding entry in the merge data 730. For example, the merge data 730 may include conventional fields such as {“customer_name”: “John Smith”, “account_balance”: “$1,250”} alongside action definition data such as {“personalization_context”: {“purchase_history”: [“outdoor gear”, “electronics”], “communication_style”: “casual”, “interests”: [“hiking”, “technology”]}}. The action definition data may be organized using nested structures where each action definition identifier corresponds to a data object containing relevant parameters and context information.
Action Definition Identification: Operation 806 may be extended to not only identify if the current element is an action definition, but also to extract any identifiers or references within the action definition that link it to specific data in the merge data 730. For example, an action definition may include embedded references such as “[ACTION_DEF:personalize_greeting|data_key:customer_profile]” where “personalize_greeting” identifies the action and “customer_profile” specifies which data object in the merge data 730 to retrieve. The system 700 may parse these embedded references using delimiter-based identification or structured markers to establish the connection between action definitions and their corresponding data sources.
Data Retrieval: A new operation may be introduced (e.g., between operations 806 and 808) to retrieve the relevant data from the merge data 730 for the current action definition. This may involve, for example, parsing the action definition for data references, querying the merge data 730 using these references, and preparing the retrieved data for use in the text generation process. For example, when the system 700 encounters a data reference “customer_profile,” the data retrieval operation may extract the corresponding object from the merge data 730, validate the data structure, and format the retrieved information for integration with the action definition's prompt. The retrieved data may be converted into a structured format such as “Customer preferences: outdoor activities, technology; Communication style: casual; Recent purchases: camping equipment” that can be seamlessly incorporated into the text generation process.
Enhanced Text Generation: Operation 808 may be modified to incorporate the retrieved data when applying the current action definition. The text generation module 120 may be updated to accept and process this additional input alongside the action definition itself. For example, the text generation module 120 may combine the action definition's base prompt “Generate a personalized product recommendation” with the retrieved customer data to create a comprehensive prompt such as “Generate a personalized product recommendation for a customer who enjoys outdoor activities and technology, prefers casual communication, and recently purchased camping equipment.” The integration may occur through prompt concatenation, token substitution within the action definition, or by providing the retrieved data as contextual parameters that guide the language model's content generation process.
Context Awareness: The system may maintain awareness of the document's overall context as it processes each action definition. This may involve tracking previously processed elements and their generated content to ensure coherence in the final merged document 726.
Flexible Data Application: The method 800 may be flexible in how it applies the merge data 730. For some action definitions, the data might be used as direct input, while for others, it might serve as context or parameters for more complex text generation tasks.
Error Handling and Validation: Additional error handling and validation steps may be used to manage cases where expected data is missing from the merge data 730 or where data types don't match the expectations of the action definition.
User Interface Updates: The user interface 104 may be updated to allow users to review and potentially modify the merge data 730 before or during the document generation process, especially for complex or critical documents.
Performance Optimization: Depending on the size and complexity of the merge data 730, optimizations may be used to ensure efficient processing, particularly for large documents or batch operations involving multiple merged documents.

These modifications would allow the system 700 and method 800 to leverage the merge data 730 effectively, creating more dynamic and data-driven merged documents 726 that combine the benefits of traditional mail merge with the power of AI-driven content generation.

Yet another embodiment of the generative merge feature expands upon the previously described system 700 and method 800 by enabling the merge data 730 to include multiple sets of action definition data and merge data. Each set within the merge data 730 is utilized by the system 700 and method 800 to generate a distinct instance of the merged document 726.

The high-level purpose of this embodiment is to provide a powerful and flexible document generation system that combines the capabilities of traditional mail merge operations with AI-driven content creation. By leveraging multiple data sets within the merge data 730, the system can produce a series of customized documents, each tailored to a specific set of inputs.

Functionally, this embodiment allows the system 700 to process the merge template 714 multiple times, once for each set of data in the merge data 730, resulting in multiple instances of the merged document 726. Each instance incorporates:
Conventional merge field data specific to that instance
AI-generated content based on action definitions, potentially customized for each instance
Static content from the original template

This approach significantly enhances the scalability and efficiency of document generation, enabling the creation of multiple, highly personalized documents from a single merge template and a comprehensive set of merge data.

Note that, in some embodiments, the merge data 730 may only include action definition data for use with action definitions, and not include any conventional merge data. This configuration allows the system 700 to focus solely on leveraging AI-driven content generation through action definitions, without the need to process traditional merge fields.

To enable the use of the merge data 730 to generate multiple distinct instances of the merged document 726, the system 700 and method 800 may include some or all of the following modifications:
Data Structure Enhancement: The merge data 730 may be restructured to accommodate multiple sets of data, each containing both conventional merge data and action definition data. This may, for example, be implemented as an array or list of data sets, where each set corresponds to a single instance of the merged document 726. The system 700 may support various data formats including JSON structures with nested objects for merge fields and action definition parameters, XML hierarchies with schema validation, CSV formats with header mappings for field identification, database result sets with relational constraints, or custom binary formats optimized for large-scale processing performance.
Iteration Mechanism: The method 800 may be modified to iterate over each set of data in the merge data 730. This may involve wrapping the existing method 800 of FIG. 8 in an outer loop that processes each data set sequentially. The system 700 may implement configurable iteration strategies, such as sequential processing for memory-constrained environments, parallel processing pools for high-performance scenarios, or adaptive processing that automatically adjusts parallelization based on system resources and data set characteristics. The iteration mechanism may include checkpoint capabilities that allow processing to resume from specific data set positions in case of interruption, and conditional processing filters that skip data sets based on validation criteria.
Context Management: The system 700 may maintain separate contexts for each instance of the merged document 726 being generated. This ensures that data and generated content from one instance do not interfere with other instances. Context isolation may be implemented through separate memory spaces, temporary file systems, or containerized processing environments. The system 700 may maintain context state through serializable context objects that encapsulate document state, processing history, and intermediate results, with garbage collection mechanisms that automatically clean up resources after each document instance is completed to prevent memory leaks during large batch operations.
Document Instance Creation: For each iteration, the system 700 may create a new instance of the merged document 726, starting from the original merge template 714. This ensures that each document instance starts with a clean slate.
Data Set Selection: At the beginning of each iteration, the system 700 may select the corresponding data set from the merge data 730 to be used for the current document instance.
Enhanced Action Definition Processing: When processing action definitions (operation 808), the system 700 may use the action definition data from the current data set in the merge data 730. This allows for customized AI-generated content for each document instance.
Merge Field Handling: For conventional merge fields (operations 812-816), the system 700 may use the merge data specific to the current data set, allowing for customized static content in each document instance.
Output Management: The system 700 may be modified to handle multiple output documents. This may, for example, involve creating a collection or array of merged documents 726, each representing a distinct instance. The system 700 may implement various output collection mechanisms, such as streaming output to disk for large document sets, in-memory collections for smaller batches, database storage for persistent document management, or cloud storage synchronization. Output management may include automatic naming conventions based on merge data values, configurable output formats including individual files or compressed archives, and version control integration for document tracking.
Performance Optimization: Given the potential for generating a large number of document instances, optimizations may be used to ensure efficient processing. This may, for example, include parallel processing of document instances or batch operations. The system 700 may implement memory-mapped file processing for large data sets, connection pooling for database-backed merge data, and caching mechanisms for frequently used action definitions. Performance optimization may include progress monitoring with estimated completion times, resource usage tracking to prevent system overload, and adaptive load balancing across available processing resources.
User Interface Updates: The user interface 104 may be updated to allow users to review and manage multiple generated document instances. This may, for example, include features for previewing, selecting, or further editing individual instances.
Error Handling and Validation: Additional error handling may be used to manage cases where data is missing or inconsistent across different sets in the merge data 730. The system 700 may be able to gracefully handle such scenarios, potentially by skipping problematic data sets or providing detailed error reports. The system 700 may implement pre-processing validation that checks data set completeness before beginning document generation, retry mechanisms for transient failures, fallback processing modes that generate partial documents when complete processing fails, and configurable error tolerance levels that allow users to specify whether processing should halt on first error or continue with remaining data sets.

These modifications allow the system 700 and method 800 to leverage multiple sets of data within the merge data 730, enabling the generation of multiple, distinct instances of the merged document 726. This approach combines the scalability of traditional mail merge operations with the power of AI-driven content generation, resulting in a highly flexible and efficient document generation system.

The automatic selection of one or more action definitions within the merge template 714 represents only one approach for selecting such action definition(s) for processing. The system 700 and method 800 may alternatively or additionally enable user-driven selection of action definitions embedded within documents.

For example, the user 102 may provide input which selects one or more action definitions within the merge template 714, in response to which the action processor 112 may apply the selected action definition(s) in any of the ways disclosed herein. The user 102 may select such action definitions through any of a variety of input methods via the user interface 104, including visual selection of manifestations of action definitions within manifestations of the merge template 714.

As a specific example, the user 102 may select a visual manifestation of an action definition in a manifestation of the merge template 714, such as by clicking, tapping, double-clicking, or double-tapping on that visual manifestation. In response to such user input, the action processor 112 may apply the selected action definition 118 in any of the ways disclosed herein, such as applying the selected action definition 118 to generate output and inserting that output into the document (e.g., in place of the selected action definition 118).

The user 102 may select text in the merge template 714 that includes more than one action definition, in which case the action processor 112 may apply each and every one of such selected action definitions in any of the ways disclosed herein. As a particular example, if the user 102 selects a portion of the merge template 714 that includes both a first action definition, static text, and a second action definition, the action processor 112 may apply the first action definition to generate first text and replace the first action definition with the first text, and apply the second action definition to generate second text and replace the second action definition with the second text. For instance, if the user 102 selects a portion of the merge template 714 containing “Dear {customer_name}, {action_def_1: personalize_greeting} We are pleased to inform you that {action_def_2: generate_product_recommendation} Thank you for your business,” the action processor 112 may apply action_def_1 to generate personalized greeting text such as “we hope you are enjoying the beautiful spring weather” and replace action_def_1 with this generated text, while simultaneously applying action_def_2 to generate product recommendation text such as “our new premium service package would be perfect for your needs” and replace action_def_2 with this generated text, resulting in a fully processed selection.

The user 102 may select action definitions within the merge template 714 using any of the input methods disclosed herein, such as mouse selection, keyboard shortcuts, touch gestures, voice commands, or programmatic selection. The system 700 may manifest action definitions within the merge template 714 in various ways to facilitate user selection, such as through highlighting, special formatting, interactive elements, or visual indicators that distinguish action definitions from static content and conventional merge fields.

Any of the functions performed by the system 700 and method 800 in response to automatic selection of action definitions may alternatively be performed in response to user input selecting one or more action definitions within the merge template 714. This includes applying the selected action definition to generate output, inserting generated output into the merged document 726, processing multiple action definitions sequentially, and coordinating the execution of action definitions with the processing of conventional merge fields and static content.

The system 700 may support mixed processing approaches where some action definitions within a merge template 714 are processed automatically while others are processed in response to user selection. This flexibility enables users to maintain control over specific content generation operations while benefiting from automated processing for other portions of the document. The user 102 may specify which action definitions should be processed automatically and which should await user selection, such as through configuration settings or by designating certain action definitions as requiring user approval before execution.

In some embodiments, the output generated by applying an action definition may itself be or include another action definition. More generally, embodiments of the present invention may apply first dynamic content to generate second dynamic content, and so on. The system 700 may implement technical safeguards including generation depth counters that track recursion levels and prevent infinite loops through configurable depth limits. Cycle detection algorithms may identify circular dependencies between action definitions, while performance optimization mechanisms such as lazy evaluation and content caching may enhance processing efficiency during recursive operations.

When the text generation module 120 applies an action definition (e.g., within hybrid content, such as the merge template 714) to generate output (e.g., in FIG. 8, operation 808), that output may take the form of hybrid content that contains both static text and one or more embedded action definitions. The newly generated action definition(s) may be activated by a user or automatically processed by the system 700, leading to further content generation, which may include dynamic content (e.g., hybrid content). This recursive capability enables the creation of self-expanding document structures where each level of expansion can spawn additional levels. The system 700 may maintain separate processing contexts for each recursion level to prevent interference between generations and may implement error recovery mechanisms that handle failures in child action definitions through fallback strategies such as reverting to static content or using alternative action definitions.

For example, when processing an action definition that generates a business report summary, the output may include static text describing key metrics along with one or more embedded action definitions such as “Generate detailed financial analysis” or “Expand market research findings.” When these embedded action definitions are subsequently activated, they may generate their own hybrid content containing both informational text and one or more additional action definitions for even more specific analyses.

The system 700 may handle this recursive generation through any of a variety of approaches. In some cases, the newly generated action definitions may be processed immediately in a cascading fashion, where each level of generation automatically triggers the next. Alternatively, the system 700 may present the newly generated action definitions to the user 102 for selective activation, allowing for controlled exploration of the content hierarchy. The system 700 may provide visual indicators in the user interface 104 to distinguish between static content and embedded action definitions, may offer preview capabilities that show potential recursive expansions without committing to generation, and may include undo/redo functionality that operates across multiple recursion levels.

This recursive capability may be particularly useful in scenarios where the depth and breadth of required content cannot be predetermined. For instance, a legal document template may generate contract clauses that themselves contain action definitions for generating jurisdiction-specific modifications, compliance requirements, or risk assessments. Each of these generated elements may further contain action definitions for creating supporting documentation or alternative formulations.

The merge template 714 may be designed to accommodate this recursive structure by supporting nested action definitions and maintaining context across multiple levels of generation. The system 700 may track the relationships between parent and child action definitions, enabling features such as context inheritance, constraint propagation, and dependency management across the recursive hierarchy. The system 700 may implement content validation mechanisms including schema validation to ensure generated action definitions conform to expected formats, semantic analysis to verify that embedded prompts are coherent and executable, and quality scoring mechanisms that evaluate the appropriateness of recursive content generation.

Embodiments of the present invention (e.g., the system 700 and method 800) may implement a structured content generation architecture that ensures language models reliably produce hybrid content containing embedded executable prompts rather than generating only static text. This architecture addresses the fundamental challenge that language models, when given conventional prompts, typically generate plain text output without embedded dynamic elements. The structured generation architecture guides language models to produce content that conforms to the recursive content model by providing explicit formatting instructions, output specifications, and parsing mechanisms that convert generated text into functional content objects containing both static text and executable prompt elements.

Embodiments of the present invention may provide structured output specifications to language models alongside content generation requests to ensure the generated content includes both static text and dynamic elements in appropriate locations. These specifications may include schemas or templates that define the expected structure of the output, indicating where dynamic elements should be embedded within the generated content.

Embodiments of the present invention may provide format directives that specify the arrangement of static and dynamic components within the generated output. For example, embodiments of the present invention may instruct the language model to “Generate response in format: {static_intro, dynamic_expansion_prompt, static_conclusion}” where each component type is explicitly defined. The language model receives these structural requirements as part of the generation request, enabling it to produce content that conforms to the hybrid content model.

The output specifications may include metadata about each content component, such as activation methods for dynamic elements, context requirements, and relationship information that defines how components interact with each other. Embodiments of the present invention may also specify constraints for dynamic elements, including depth limits, content types that may be generated, and inheritance rules that govern how properties propagate to child elements.

Embodiments of the present invention include a parser that converts the language model's structured output into executable content objects. The parser processes the generated content to identify and extract dynamic elements, transforming them from textual representations into functional prompt components that can be activated within the document system.

The parser may identify dynamic elements within generated content and convert them to functional prompts capable of triggering additional content generation. This conversion process may involve extracting prompt text, activation parameters, and contextual information from the structured output, then creating executable prompt objects that maintain the necessary metadata for proper functioning within the recursive content system.

The parsing mechanism may maintain separation between descriptive text about prompts and actual executable prompt elements. This distinction ensures that references to prompts or descriptions of dynamic functionality within the generated content do not inadvertently become executable elements, while genuine dynamic components are properly recognized and converted to functional form. The parser may use formatting markers, structural indicators, or metadata tags to distinguish between descriptive content and executable prompt specifications.

Embodiments of the present invention may utilize prompt templates that specify both content requirements and structural requirements for generated output. These templates may define not only what information should be generated but also how that information should be organized within the hybrid content structure, including the placement and configuration of dynamic elements.

The system may combine user requests with structural directives before sending prompts to the language model. This integration process may involve merging user-specified content goals with template-defined structural requirements, creating generation instructions that address both the substantive content needs and the technical formatting requirements necessary for proper hybrid content creation.

The templates may ensure consistent generation of hybrid content across different use cases by providing standardized frameworks for content structure. Templates may define common patterns for embedding dynamic elements, specify default activation methods, and establish inheritance rules that maintain coherence across multiple generations. This templating approach enables the system to reliably produce hybrid content regardless of the specific domain or application context.

Each generated dynamic element may include metadata specifying how it should behave when activated. This metadata may define activation methods, processing parameters, output constraints, and relationship information that governs the element's behavior within the recursive content system. The metadata ensures that dynamic elements maintain consistent functionality and appropriate boundaries when generating subsequent content.

Embodiments of the present invention maintain context and constraints that propagate through multiple generation levels. Context information may include document state, user preferences, previous generation history, and environmental parameters that influence content generation. Constraints may encompass formatting requirements, content boundaries, depth limitations, and quality standards that ensure generated content remains coherent and appropriate throughout the recursive generation process.

Generated prompts inherit properties from parent prompts to maintain document coherence across multiple generation levels. This inheritance mechanism may transfer stylistic guidelines, domain-specific constraints, formatting requirements, and contextual information from parent elements to their generated children. The inheritance system may propagate specific types of metadata including security permissions that determine which types of content can be generated at each recursion level, formatting constraints that ensure visual consistency across generated content, business rules that govern content appropriateness in different organizational contexts, and access control parameters that restrict certain types of generation based on user roles or document sensitivity levels. The inheritance system ensures that content generated at deeper levels of recursion maintains consistency with the overall document structure and adheres to the governing principles established by ancestor elements.

In some embodiments, the merge template 714 may include multiple action definitions that operate sequentially, with one action definition processing the output generated by a previous action definition and/or merge field. This enables sophisticated multi-stage content generation where each stage can build upon and refine content created in earlier stages.

For example, a first action definition in the merge template 714 may generate initial content, while a subsequent action definition in the merge template 714 processes that generated content to produce more refined output. This chained processing enables complex transformations where the context and content from earlier generations inform and enhance later content generation steps.

This capability enables merge templates to implement multi-stage processing workflows where initial action definitions generate foundational content based on merge field data, and subsequent actions process and refine that generated content. In some cases, multiple transformations may be chained together within a single template, allowing for complex content generation processes that build upon previous outputs. Later stages may reference both original merge data and previously generated content, creating sophisticated content relationships that enhance the overall document generation process. This multi-stage approach enables embodiments of the system to create more nuanced and contextually appropriate content by allowing each processing stage to contribute specialized transformations while maintaining coherence across the entire document generation workflow.

Through this sequential processing capability, the system enables merge templates to implement sophisticated content generation workflows while maintaining precise control over document structure and formatting. The ability to chain multiple action definitions together allows for complex, context-aware content generation that goes beyond simple field substitution or single-stage processing.

Embodiments of the invention support multiple mechanisms for action definitions to reference and process previously-generated content within merge templates, including content that was inserted to the document as the result of applying one or more previous action definitions and/or one or more previous merge fields.

For example, an action definition may explicitly reference specific previously-generated content through any one or more of several mechanisms. An action definition may include a direct reference to the output of a specific prior action definition by its identifier, enabling precise targeting of previously generated content within the document processing workflow. The action definition may alternatively reference content generated within a particular template section or field, allowing for section-specific content retrieval and processing. In some cases, the action definition may reference content generated during a specific processing stage, providing temporal control over content dependencies. The action definition may also reference content generated from specific merge field data, enabling data-driven content relationships and processing sequences.

Additionally or alternatively, an action definition may implicitly reference previously-generated content through broader contextual references. For example, an action definition may reference the entire document state, which includes any previously generated content that has been incorporated into the document during prior processing steps. In some cases, an action definition may reference the surrounding context of the current insertion point, enabling the action definition to consider nearby text, formatting, or structural elements when generating new content. An action definition may also reference related document sections that may contain generated content, allowing for coordination between different parts of the document that have undergone content generation processes. Furthermore, an action definition may reference document-level metadata that reflects prior generation steps, such as information about previous transformations, generation parameters, or processing history that can inform subsequent content generation operations.

Additionally or alternatively, an action definition may include one or more compound (i.e., direct and indirect) references to previously generated content. Such compound references may, for example, include references that combine multiple generated content elements, enabling the action definition to process and integrate content from various sources within the document. The compound references may include references that process both generated content and original merge field data, allowing the action definition to create sophisticated relationships between dynamically generated content and static data elements. In some cases, the compound references may include references that analyze relationships between different generated elements, enabling the action definition to understand and leverage connections between various pieces of generated content. The compound references may include references that consider both local and document-wide generated content, allowing the action definition to access and process content from specific document sections as well as content distributed throughout the entire document structure.

An action definition may, for example, reference document content (including metadata) using Document Object Model (DOM) or DOM-like structures that provide programmatic access to document elements. This structured representation enables precise navigation and manipulation of document content through well-defined interfaces. For example, such structures allow action definitions to access hierarchical relationships between document elements, navigate parent-child relationships between content sections, reference specific nodes within the document tree, query document structure using standardized selectors, and traverse document content systematically. These capabilities enable action definitions to interact with document structure in sophisticated ways that support complex content generation and manipulation operations. The DOM or DOM-like structures may provide standardized methods for accessing document elements, attributes, and content, allowing action definitions to programmatically interact with document structure regardless of the underlying document format or implementation.

When referencing previously generated content, action definitions may utilize DOM or DOM-like interfaces to perform various document navigation and content selection operations. For example, action definitions may select specific content nodes by type, attributes, or location within the document structure. Action definitions may also access surrounding context through parent and sibling relationships, enabling comprehensive understanding of content positioning and hierarchical relationships. In some cases, action definitions may navigate document structure using standard DOM traversal methods, providing systematic access to document elements. Action definitions may query document state using DOM-based selectors, allowing for precise identification and retrieval of specific content elements. Additionally, action definitions may reference content across different structural levels, enabling cross-sectional content analysis and manipulation within complex document hierarchies.

The DOM-based approach provides a standardized mechanism for action definitions to reference and process document content while maintaining structural relationships. This enables sophisticated content generation that preserves document hierarchy and formatting while allowing precise access to previously generated elements.

In some embodiments, the system 700 enables action definitions to reference and process content that will be generated by action definitions and/or merge fields that appear later in the merge template 714. Implementing such forward references may involve executing action definitions in an order that differs from their sequential appearance in the merge template 714. For example, consider a first action definition that appears at a first location in the merge template 714 that is earlier in the merge template 714 than a second location of a second action definition. The first action definition refers, directly or indirectly, to output generated by applying the second action definition. The system 700 may implement any of a variety of mechanisms for executing the second action definition before executing the first action definition.

For example, an executive summary section at the beginning of a document may need to reference key points that will be generated in later sections. Through forward references, the action definition generating the summary can process content that will be created by subsequent action definitions, ensuring the summary accurately reflects the complete document content.

Similarly, a table of contents or index section may need to reference and process content that appears throughout the rest of the document. Forward references enable these organizational elements to be placed at their natural location in the template while still accessing content that will be generated later in the processing sequence.

As the above implies, the loop performed in operations 804-820 of the method 800 may not identify and/or apply action definitions in the order in which they appear in the merge template 714. Instead, the method 800 may be implemented in any suitable way to identify and apply action definitions in the merge template 714 in a sequence that is consistent with any dependencies between action definitions in any of the ways disclosed herein.

The system 700 may determine and apply appropriate execution ordering in any of a variety of ways. For example, in one embodiment the system 700 may analyze references between action definitions to identify dependencies that exist between different action definitions within the merge template 714. The system 700 may build a dependency graph of action definitions that represents the relationships and interdependencies among the various action definitions 108a-n. Based on the dependency graph, the system 700 may determine an execution sequence that satisfies all dependencies, ensuring that action definitions are processed in the correct order to maintain data integrity and proper content generation. The system 700 may coordinate processing across distributed system components, enabling efficient execution of complex merge operations that span multiple computing resources or processing modules.

One or more of the action definitions 108a-n may include data or otherwise be stored in a manner that explicitly specifies or otherwise indicates or provides hints about the order in which to execute some or all of the action definitions 108a-n. For example, some or all of the action definitions 108a-n may include explicit sequence identifiers, which may include explicit ordering information through numeric sequence identifiers that specify absolute execution order; decimal sequence values that enable fine-grained ordering control; named execution phases that group related processing steps; or priority values that determine relative execution order. In some cases, numeric sequence identifiers may use simple integer values such as 1, 2, 3 to establish a clear sequential order for action definition execution. Decimal sequence values may provide more granular control through values such as 1.1, 1.2, 2.1, enabling the insertion of additional action definitions between existing sequence points without requiring renumbering of the entire sequence. Named execution phases may organize action definitions into logical groups such as preprocessing, main processing, and postprocessing phases, allowing for structured execution workflows. Priority values may establish relative importance or urgency levels that determine the order in which action definitions are processed when multiple definitions are available for execution.

As another example, the system 700 may store, identify, and/or apply action definition ordering through structural mechanisms. Such structural mechanisms may include linked list structures connecting related action definitions, which enable sequential processing relationships between action definitions. The system 700 may also utilize tree structures representing hierarchical processing relationships, allowing for complex parent-child relationships between action definitions where higher-level action definitions may control or influence the execution of subordinate action definitions. In some cases, the system 700 may implement dependency graphs specifying execution prerequisites, which ensure that action definitions are executed in the correct order based on their interdependencies and requirements. The system 700 may employ processing queues managing execution sequences, which provide ordered processing of action definitions while maintaining system performance and resource allocation efficiency.

As another example, the system 700 may store, identify, and/or apply relative ordering of action definitions through various mechanisms. The system 700 may, for example, establish before/after relationships with other action definitions, enabling sequential processing where certain action definitions execute only after prerequisite action definitions have completed. The system 700 may implement dependencies on specific processing stages, allowing action definitions to be triggered based on the completion of particular phases within the document processing workflow. The system 700 may define relationships to document structure elements, where action definitions are associated with specific document components such as headers, paragraphs, or sections, ensuring that processing occurs in alignment with the document's organizational structure. The system 700 may support conditional execution based on processing state, where action definitions are activated or deactivated depending on the current status of the document processing operation, the results of previous action definitions, or other contextual factors within the merge template processing environment.

The ability of embodiments of the present invention to execute action definitions out-of-sequence represents a fundamental departure from conventional mail merge systems. Traditional mail merge functionality follows a strictly sequential processing model, applying merge fields in the exact order they appear in the template. This sequential limitation exists because conventional systems are designed for simple field substitution without interdependencies between merge fields, making more sophisticated processing capabilities unnecessary.

In contrast, embodiments of the present invention enable interdependencies between action definitions, allowing generated content to reference and build upon other generated content regardless of template position. This capability enables several significant advances over conventional merge processing. For example, the system 700 supports sophisticated content relationships through action definitions that process output from other actions appearing later in the template, generated content that adapts based on both prior and subsequent content, complex dependencies between multiple content elements, and bidirectional relationships between different document sections. These interdependencies may enable action definitions to create dynamic content that references outputs from subsequent processing steps, allowing for forward-looking content generation that anticipates and incorporates information that will be generated later in the template processing sequence. The system 700 may support content adaptation mechanisms where generated text modifies based on contextual information from both preceding and following document elements, creating coherent document flows that maintain consistency across all generated sections. In some cases, the complex dependencies between multiple content elements may enable cascading content generation where changes to one element automatically trigger updates to related elements throughout the document, maintaining document coherence while allowing for sophisticated content relationships that would be impossible with traditional sequential processing approaches.

These capabilities enable significantly more sophisticated document generation in various ways. For example, embodiments of the present invention may generate executive summaries that accurately reflect content from throughout the document by processing and synthesizing information from multiple document sections. The system may create table of contents entries that reference dynamically generated section content, ensuring that navigation elements remain synchronized with the actual document structure as content is generated and modified. Embodiments may maintain cross-references that preserve accuracy across generated elements, automatically updating reference relationships as content changes throughout the document processing workflow. The system may ensure document-wide consistency in generated content by applying coherent styling, terminology, and formatting standards across all generated sections and elements within the document.

The generative merge feature may be extended beyond creating individual document instances to generating entire hierarchies of related documents. In this extended implementation, merge templates serve as genetic templates that spawn not just individual documents, but document trees where each node represents a distinct document with inherited characteristics from its parent template.

When a merge template spawns a document, that spawned document may inherit the merge template's structural framework and embedded action definitions, enabling it to function as a template for generating its own child documents. This inheritance mechanism creates a recursive document generation system where each document in the tree maintains the capability to spawn additional documents while preserving the contextual relationships and constraints established by its ancestors.

The document tree structure enables sophisticated content organization patterns where documents can branch into specialized variations, drill down into detailed sub-topics, or expand into related domains while maintaining coherent relationships throughout the hierarchy. Each document node in the tree may contain its own merge data, action definitions, and spawning rules, allowing for complex document ecosystems that can evolve and expand based on user interactions or automated triggers.

This document tree generation capability transforms the merge template from a tool for creating parallel document instances into a foundation for building interconnected document networks that can grow and adapt over time while preserving the structural and contextual integrity established by the original template design.

The recursive content generation principles described herein may be extended from content-level operations to document-level operations. Just as dynamic content can generate more dynamic content within a document, merge templates can generate new merge templates that themselves can generate additional documents, creating hierarchical tree structures of related documents.

This document-level recursion may follow the same fundamental pattern as the content recursion disclosed herein, where the output of applying a merge template may include not only document content but also new merge templates with their own action definitions and spawning capabilities. When a merge template generates a child document, that child document may itself be and/or contain embedded one or more merge templates that can spawn their own descendants, enabling unlimited depth in document tree generation.

The recursive document architecture may, for example, use the same constraint inheritance and context preservation mechanisms described herein for content generation. Parent merge templates may propagate structural rules, formatting constraints, and/or contextual information to child templates, ensuring consistency across the document hierarchy while allowing for specialized adaptations at each level.

Each node in the document tree may represent a fully functional merge template capable of independent operation while maintaining its genealogical relationships. This enables document trees where different branches can evolve specialized characteristics while preserving their connection to the common ancestor template. The recursive generation process may continue indefinitely, with each generation potentially spawning new branches based on the action definitions and merge data available at that level.

This recursive document generation capability enables the creation of self-organizing document ecosystems where the initial merge template serves as the foundational genetic code that governs how the entire document family can evolve and expand over time.

The dynamic document tree features disclosed herein are not limited to use with the generative merge features disclosed herein. For example, the dynamic document tree features disclosed herein may be used in connection with other uses disclosed herein of the action processor 112 to generate text. Referring to FIG. 1, if the action processor 112 in the system 100 uses the selected action definition 118 to generate the generated text 122 and then uses the document update module 124 to generate the updated document 126, the system 100 may apply any of the dynamic document tree techniques disclosed herein to make that updated document 126 part of a document tree. As this example illustrates, such a document tree may be generated and updated using any of the techniques disclosed herein, even if generative merge techniques are not used. The action processor 112 may, for example, apply document tree generation techniques to any document processing operation that involves the selected text 116, the selected action definition 118, or the generated text 122. In some cases, the document update module 124 may create hierarchical relationships between the updated document 126 and other documents in the documents 110a-m, enabling the formation of document trees through any of the text generation and document update processes described herein.

Embodiments of the present invention may implement document tree generation using either or both of the following approaches that balance computational efficiency with user experience requirements.

Eager Document Tree Generation: In eager generation, the system pre-generates one or more documents (nodes) in a document tree, e.g., by recursively applying merge templates with different data sets or contexts. Each node in the tree represents an actual generated document with fully realized content. For example, the system may process the root merge template and immediately generate some or all potential child documents based on the available merge data and action definitions. This process may continue recursively through one or more (e.g., each and every) level of the hierarchy. Eager generation provides immediate access to all documents in the tree without generation delays, enabling rapid navigation and comprehensive search capabilities across the entire document ecosystem. The approach may be particularly suitable for scenarios where the document tree size is bounded and computational resources are sufficient to generate all potential documents upfront. Each document node contains complete content and maintains full genealogical relationships with its ancestors and descendants.

Lazy Document Tree Generation: In lazy generation, the system creates abstract document trees showing potential documents without generating actual content until accessed. Documents are only realized when accessed, using the same just-in-time generation principles described for content elements. The system initially creates a tree structure containing merge template specifications and metadata for each potential document node, but defers content generation until a user or process specifically requests a particular document. This approach enables the exploration of potentially infinite document trees without requiring unlimited computational resources. Users may navigate through the abstract tree structure, preview potential documents through metadata and summaries, and selectively realize only the documents they need. The lazy generation strategy maintains the same context inheritance and constraint propagation mechanisms while optimizing resource utilization by generating content only when required.

The system may combine both approaches within a single document tree, such as by using eager generation for frequently accessed or critical documents while applying lazy generation to less commonly needed branches. This hybrid strategy enables optimization based on usage patterns and resource constraints while maintaining the full capabilities of the recursive document generation system.

The multiple merge data sets concept may be extended to include hierarchical data structures where each data set can specify child data sets, creating natural tree relationships that correspond to document tree structures. In this enhanced implementation, the merge data 730 may be organized as a hierarchical structure where individual data sets contain not only their own merge field values and action definition data, but also references or specifications for child data sets that should be used to generate descendant documents.

Each data set within the hierarchical merge data structure may include metadata that defines its relationships to other data sets, such as parent-child relationships, sibling relationships, and inheritance rules. This hierarchical organization enables the merge template processing system to follow the data relationships automatically when generating corresponding document trees, ensuring that the document hierarchy mirrors the logical structure of the underlying data.

The merge template processing may traverse the hierarchical merge data structure systematically, applying the root merge template to the top-level data set to generate the root document, then recursively processing each child data set to generate the corresponding child documents. During this traversal, the system may propagate contextual information and constraints from parent data sets to child data sets, maintaining consistency across the document tree while allowing for specialized adaptations at each level.

This hierarchical approach enables sophisticated document generation scenarios where the structure of the document tree is determined by the logical relationships inherent in the data itself. For example, an organizational chart data structure could automatically generate a corresponding hierarchy of employee profile documents, or a product catalog structure could spawn detailed specification documents for each product category and individual product.

The system may support various hierarchical data formats, including nested JSON structures, XML hierarchies, database relationships with foreign keys, and custom data models that define parent-child relationships. This flexibility allows the document tree generation capability to integrate with existing data systems while maintaining the powerful recursive generation and constraint inheritance mechanisms established for the merge template processing system.

Embodiments of the system may implement speculative search capabilities that enable users to search not only through realized document content but also through potential content that has not yet been generated. This speculative search functionality may extend conventional search operations to explore the possibility space of both document trees and individual documents, providing search results for content that could exist based on embedded action definitions and merge templates. The speculative search may operate across the documents 110a-m (FIG. 1) and may utilize the action definitions 108a-n stored in the action definition library 106 to identify potential content matches.

When performing speculative search, embodiments of the system may analyze both generated content that exists as actual content and abstract content elements that represent potential content. For realized content, the search may operate using conventional text matching and semantic analysis techniques applied to the documents 110a-m. For potential content, the action processor 112 may compute match probabilities based on the action definitions 108a-n, merge templates, and contextual data that would be used to generate that content. The text generation module 120 may be consulted to evaluate the likelihood that applying specific action definitions would produce content matching the search query.

In the case of single documents, embodiments of the system may analyze potential content that could be generated by applying action definitions 108a-n to selected text 116 or elements within that document, enabling speculative search within individual documents. The action processor 112 may evaluate how different action definitions would transform existing text elements to produce content that matches search criteria. In the case of document hierarchies, the system may analyze potential content across multiple related documents within the documents 110a-m, enabling speculative search across document hierarchies by considering how merge templates and action definitions would generate content in different document contexts.

The speculative search may return results in multiple categories through the user interface 104. Realized results may represent actual matches found in existing content within the documents 110a-m. Potential results may indicate high-probability matches in ungenerated content, where the action processor 112 determines that generated text 122 would likely contain the search query based on analysis of the underlying prompts and context from the action definitions 108a-n. Speculative results may represent lower-probability but possible matches where the search terms might appear in generated content under certain conditions. These categories may apply whether the speculative search is performed within a single document or across multiple documents in a tree structure, with the user interface 104 presenting the results in a manner that distinguishes between the different probability levels.

Embodiments of the system may implement probabilistic matching algorithms that evaluate whether content generated from specific action definitions 108a-n would likely contain the search query. This analysis may consider semantic similarity between the search terms and the action definition prompts stored in the action definition library 106, contextual relevance based on merge data, and historical patterns of content generation for similar prompts. The text generation module 120 may, for example, evaluate how applying a selected action definition 118 to a particular word, phrase, or selected text 116 within the document would likely produce generated text 122 matching the search query. The external data 128 may also be analyzed to determine how additional context would influence the probability of generating matching content.

When users select potential or speculative search results through the user interface 104, embodiments of the system may perform just-in-time generation of the corresponding content to realize the text and confirm the match. This approach may enable users to discover relevant information without requiring pre-generation of all possible content variations. In single-document contexts, this may involve the action processor 112 applying action definitions 108a-n to specific text elements to generate the potential content that was identified during the speculative search process. The text generation module 120 may generate the actual content on demand, and the document update module 124 may integrate the generated text 122 into the document structure to create an updated document 126 that contains the realized search result.

The speculative search capability may support various search strategies implemented through the action processor 112, including semantic concept searches that identify content likely to contain related ideas even when specific terms do not appear in the prompts of action definitions 108a-n, temporal searches that find content that would match queries at future time points, and counterfactual searches that explore content that would exist under different assumptions or conditions. These search strategies may be applied within individual documents by considering how action definitions would transform existing text elements, as well as across document trees by analyzing potential document variations. The external data 128 may provide additional context for these advanced search strategies, enabling more sophisticated analysis of potential content generation scenarios.

This comprehensive search functionality may transform both individual documents and document trees from static content into explorable knowledge spaces where users can discover both existing and potential information through intelligent search operations that understand the generative capabilities and recursive structure of the content ecosystem. Within a single document, users may search through potential content that could be generated by applying various action definitions 108a-n to different text elements, while across document trees, users may explore potential documents and their relationships within the hierarchical structure. The user interface 104 may present these search capabilities in an intuitive manner that allows users to navigate between realized and potential content seamlessly.

The speculative search capabilities described herein may be extended to operate across entire document trees, enabling users to search through both realized and potential documents within the tree structure. This extension may transform the search functionality from operating on individual documents 110a-m to exploring the complete possibility space of document hierarchies. The action processor 112 may coordinate search operations across multiple levels of document trees, analyzing how different combinations of action definitions 108a-n and merge data would generate content at various nodes in the hierarchy.

When performing speculative search across document trees, embodiments of the system may analyze both generated documents that exist as actual content and abstract document nodes that represent potential documents in the tree structure. For realized documents within the documents 110a-m, the search may operate using conventional text matching and semantic analysis. For potential documents, the action processor 112 may compute match probabilities based on the merge templates, action definitions 108a-n, and hierarchical merge data that would be used to generate those documents. The text generation module 120 may evaluate the likelihood of generating matching content at different levels of the document hierarchy, considering how parent-child relationships between documents would influence content generation.

The search results may be organized hierarchically through the user interface 104 to reflect the document tree structure, showing users not only where matches occur but also the genealogical relationships between matching documents. Users may navigate search results by exploring different branches of the document tree, understanding how potential matches relate to their parent and child documents within the hierarchy. The user interface 104 may provide visual representations of the document tree structure that highlight both realized and potential matches, enabling users to understand the context and relationships of search results within the broader document ecosystem.

Embodiments of the system may implement lazy search expansion across document trees, where search operations progressively explore deeper levels of the tree structure based on match probabilities and user interest. High-probability matches in abstract document nodes may trigger just-in-time generation of those documents through the text generation module 120 to provide more detailed search results, while lower-probability branches may remain unexplored to optimize computational resources. The action processor 112 may manage this progressive exploration by prioritizing the evaluation of action definitions 108a-n that are most likely to produce matching content, thereby efficiently allocating processing resources while maintaining comprehensive search coverage.

Speculative search across document trees may enable sophisticated query scenarios such as finding all documents in a tree that would contain specific information, identifying potential document paths that lead to desired content, and discovering relationships between concepts across different branches of the document hierarchy. The search functionality may also support temporal queries that explore how document trees might evolve over time based on changing merge data or updated action definitions 108a-n. The external data 128 may provide temporal context that influences how the action processor 112 evaluates potential content generation scenarios across different time periods, enabling users to search for content that would be relevant at specific points in time or under changing conditions.

This comprehensive search capability may transform document trees from static hierarchies into explorable knowledge spaces where users can discover both existing and potential information through intelligent search operations that understand the recursive structure and generative capabilities of the document ecosystem. The integration of the action processor 112, text generation module 120, and user interface 104 may enable seamless navigation between realized and potential content, providing users with unprecedented access to the full possibility space of document-based knowledge systems.

Embodiments of the system may implement speculative search using a process that analyzes both realized and potential content. The speculative search process may begin when the user interface 104 receives a search query from the user 102. The action processor 112 may then analyze the documents 110a-m to identify existing content that matches the search query using conventional text matching techniques. The action processor 112 may evaluate the action definitions 108a-n stored in the action definition library 106 to identify potential content that could be generated and would likely match the search query.

The action processor 112 may compute match probabilities for potential content by analyzing semantic relationships between the search query and the prompts contained within the action definitions 108a-n. For each action definition, the action processor 112 may evaluate how applying that action definition to specific text elements would likely produce content containing the search terms. The text generation module 120 may be consulted to provide probability estimates based on language model capabilities and historical generation patterns. The external data 128 may provide additional context that influences these probability calculations, enabling more accurate predictions of potential content matches.

The user interface 104 may present search results in categorized format, distinguishing between realized matches found in existing content, potential matches with high probability of containing the search query, and speculative matches with lower but possible probability. When users select potential or speculative results through the user interface 104, the action processor 112 may trigger just-in-time content generation by applying the relevant action definition to the identified text element. The text generation module 120 may generate the actual content, which the document update module 124 may then integrate into the document structure to create an updated document 126 containing the realized search result.

For document tree scenarios, the speculative search process may extend across multiple document levels by analyzing hierarchical relationships and potential document generation paths. The action processor 112 may evaluate how different combinations of merge data and action definitions 108a-n would generate content at various nodes in the document tree, computing match probabilities for potential documents that do not yet exist. The system 100 may implement lazy expansion techniques where high-probability matches trigger progressive exploration of deeper tree levels, while lower-probability branches remain unexplored until user interest or additional context warrants their evaluation.

The document tree generation capabilities described herein build directly on the established recursive generation engine, constraint inheritance system, and context preservation mechanisms already described in this specification. This approach requires minimal additional technical infrastructure while dramatically expanding the system's capabilities from individual document processing to comprehensive document ecosystem management.

The recursive generation engine that enables dynamic content to spawn additional dynamic content within documents operates identically at the document level, where merge templates spawn child documents that themselves contain merge templates capable of further spawning. The same algorithmic foundations, processing loops, and generation logic apply seamlessly to both content-level and document-level operations.

The constraint inheritance system maintains its fundamental architecture when extended to document trees. Parent merge templates propagate constraints, formatting rules, and contextual parameters to child documents using the same inheritance mechanisms established for content generation. The system preserves the ability to enforce semantic boundaries, maintain consistent styling, and apply constitutional constraints across multiple generations, whether those generations occur within a single document or across an entire document hierarchy.

Context preservation mechanisms function identically across document boundaries, maintaining the accumulated context, user preferences, and environmental parameters that inform generation decisions. The context management system requires no modification to support document trees, as it already maintains hierarchical context relationships that naturally extend from content elements to document nodes.

This approach leverages the existing foundation while naturally extending it to document-level operations, maintaining consistency with the established technical framework. The text generation module 120, document update module 124, and action definition processing systems operate without modification, applying their existing capabilities to document tree nodes rather than individual content elements. The user interface 104 and action processor 112 maintain their established interaction patterns while supporting the expanded scope of operations.

The seamless integration ensures that all existing features, optimizations, and safeguards automatically apply to document tree operations, providing a robust and proven foundation for the expanded capabilities while minimizing implementation complexity and maintaining system reliability.

The system may implement a “quantum” pre-generation approach that generates multiple variations of content simultaneously and stores them in a superposition state until user selection collapses the superposition to a specific version. This approach enables the system to prepare content optimized for different contexts or user preferences without knowing in advance which version will be needed.

When processing a document node, the quantum pre-generation system may generate multiple variations of the same content concurrently, such as detailed, summary, technical, and simplified versions. These variations are stored together in what may be termed a “superposition,” where all potential versions exist simultaneously within the system until a selection mechanism determines which version to manifest.

The collapse of the superposition to a specific version may occur through various selection mechanisms. The user may manually select from the available variations through the user interface, choosing the version that best meets their immediate needs. Alternatively, the system may automatically select the most appropriate variation based on stored user profile data, which may include preferred writing styles, technical expertise levels, reading preferences, or historical interaction patterns.

The quantum pre-generation approach may be implemented through a class structure that manages the superposition state and collapse mechanism. Each generated variation may include metadata describing its characteristics, target audience, complexity level, and other distinguishing features. The collapse process evaluates these characteristics against the selection criteria to identify the optimal match.

This approach provides several advantages over sequential generation methods. Users experience immediate access to appropriately tailored content without waiting for generation to occur after their preferences are known. The system can optimize content for multiple potential use cases simultaneously, ensuring that regardless of user needs or context changes, suitable content is readily available.

The quantum pre-generation method may be particularly effective in scenarios where user preferences are variable or unknown at generation time, where content needs to serve multiple audiences, or where rapid response times are critical to user experience. The superposition state enables the system to maintain multiple potential content states until the moment of user interaction determines which state becomes reality.

Embodiments of the present invention may implement quantum pre-generation capabilities that enable text generation modules to generate multiple variations of content simultaneously when applying action definitions to selected text. For example, referring to FIG. 1, embodiments of the system 100 may implement such quantum pre-generation capabilities in the text generation module 120 when applying action definitions 108a-n to selected text 116. The quantum pre-generation approach may operate by generating a plurality of content variations concurrently through the application of a single selected action definition, storing these variations in a superposition state until a selection mechanism determines which variation to manifest as generated text. Although such quantum pre-generation capabilities may be described in connection with FIG. 1, this is merely an example; such quantum pre-generation capabilities may be implemented in connection with any of the techniques disclosed herein.

When the action processor 112 applies the selected action definition 118 to the selected text 116, the text generation module 120 may generate multiple distinct variations of output content rather than producing a single instance of generated text 122. These variations may differ in characteristics such as writing style, complexity level, tone, length, or technical detail while all being responsive to the same selected action definition 118 and selected text 116. The system 100 may store all generated variations simultaneously in what may be termed a superposition state, where each variation exists as a potential candidate for the generated text 122 until a selection process determines which variation becomes the actual generated text 122.

The quantum pre-generation process may leverage the stochastic nature of language models to produce diverse content variations from identical inputs. When the text generation module 120 provides a prompt derived from the selected action definition 118 and selected text 116 to a language model, the system 100 may execute multiple inference operations with the same prompt to generate different outputs due to the probabilistic sampling mechanisms inherent in language model processing. Each inference operation may produce a distinct variation that represents a different potential realization of the generated text 122, enabling the system 100 to explore multiple possibilities within the content generation space defined by the selected action definition 118.

With continued reference to FIG. 1, the superposition state may be maintained through data structures that store multiple content variations along with associated metadata describing the characteristics of each variation. The metadata may include information such as complexity scores, readability metrics, tone classifications, length measurements, or semantic similarity scores relative to the selected text 116. This metadata enables the system 100 to evaluate and compare variations during the selection process, providing quantitative measures for determining which variation best matches specified criteria or user preferences.

The collapse of the superposition to a specific variation may occur through various selection mechanisms implemented by the action processor 112. In some cases, the user 102 may manually select from the available variations through the user interface 104, with the system 100 presenting multiple options and enabling the user 102 to choose the variation that best meets their immediate needs. The user interface 104 may display the variations simultaneously or sequentially, potentially with preview capabilities that allow the user 102 to evaluate each option before making a selection. Alternatively, the system 100 may automatically select the most appropriate variation based on stored user profile data, historical interaction patterns, or contextual analysis of the document containing the selected text 116.

Referring to FIG. 2, the quantum pre-generation process may be integrated into the method 200 at operation 210, where the application of the selected action to the selected text generates multiple variations rather than a single output. The method 200 may include an additional operation between operation 210 and operation 212 where the system selects one variation from the multiple generated variations before updating the selected document. This selection operation may involve presenting the variations to the user through the user interface 104 for manual selection, or automatically selecting a variation based on predetermined criteria or learned user preferences.

The quantum pre-generation approach may provide several technical advantages over sequential generation methods. The system 100 may reduce response latency by pre-generating multiple content options before user preferences are fully determined, enabling immediate presentation of appropriately tailored content once selection criteria become available. The approach may also improve content quality by enabling comparative evaluation of multiple generated options, allowing the system 100 to select variations that best meet specific quality metrics or user requirements. Additionally, the quantum pre-generation method may enhance user experience by providing choice and control over generated content while maintaining the efficiency benefits of automated text generation.

The superposition state management may include mechanisms for handling memory allocation and computational resource optimization. The system 100 may implement configurable limits on the number of variations generated simultaneously, balancing content diversity against system performance requirements. The system 100 may also include garbage collection mechanisms that automatically release unused variations after selection occurs, preventing memory accumulation during extended operation periods. In some cases, the system 100 may implement lazy evaluation techniques where certain variations are generated on-demand during the selection process rather than being fully realized during the initial generation phase.

The quantum pre-generation feature may be particularly effective when applied to action definitions 108a-n that benefit from multiple interpretation possibilities or when the selected text 116 contains ambiguous elements that could be processed in different ways. For example, when applying an action definition 118 that involves summarization, the text generation module 120 may generate variations with different levels of detail, different organizational structures, or different emphasis on various aspects of the selected text 116. Similarly, when applying an action definition 118 that involves style transformation, the system 100 may generate variations that interpret the target style in different ways or that apply the transformation with varying degrees of intensity.

The system may implement a recursive document reproduction capability that enables documents to spawn additional documents through embedded prompt elements. This recursive architecture creates self-reproducing document systems where each generated document contains the capability to generate further documents, enabling unlimited expansion of document hierarchies.

The recursive reproduction process may begin with generating a parent document that contains at least one embedded prompt element. These embedded prompt elements comprise action definitions that specify instructions for content generation using language models. The embedded prompt elements may be stored within the document structure using any of the embedding methods described herein, including metadata-based storage, field-based implementation, or external reference systems.

When an embedded prompt element is activated, the system executes a spawning operation that creates a child document separate from the parent document. The child document contains content generated by applying the embedded prompt element's specifications to a language model. This spawning process creates a distinct document entity while maintaining genealogical relationships with the parent document through the relationship tracking mechanisms described herein.

The content generated during the spawning operation automatically includes at least one new embedded prompt element within the child document. This ensures that the child document possesses the same reproductive capability as its parent, enabling it to serve as a parent document in subsequent iterations of the spawning process. The new embedded prompt elements may inherit contextual information and constraints from the parent document while potentially introducing specialized characteristics based on the generated content.

This recursive structure enables unlimited document reproduction, where each generation of documents can spawn additional generations through the same spawning mechanism. The recursive process maintains the constraint inheritance and context preservation mechanisms established for content generation, ensuring consistency across multiple generations while allowing for evolutionary adaptations at each level.

The recursive document reproduction capability transforms individual documents into self-expanding document ecosystems. Each document in the hierarchy maintains both its individual content and its generative potential, creating networks of related documents that can grow and evolve based on user interactions or automated triggers. The system preserves genealogical relationships throughout the recursive reproduction process, enabling navigation and management of complex document family trees.

Embodiments of the present invention significantly expand upon traditional mail merge capabilities by integrating sophisticated generative AI functionality. Unlike conventional mail merge systems that simply substitute basic field values within a template, embodiments of the present invention enable dynamic, automated (e.g., AI-driven) content generation and transformation through the use of action definitions, which may use generative AI (e.g., LLMs).

By incorporating action definitions into merge templates, the embodiments of the present invention enable documents to be customized in ways that go far beyond simple data insertion. When processing action definitions within a template, embodiments of the present invention leverage may use language models (e.g., LLMs) to generate contextually appropriate content, allowing for sophisticated transformations that can adapt to both the document author's message and the readers' preferences.

The ability of embodiments of the present invention to process multiple sets of merge data while applying AI-driven transformations enables a new level of mass personalization. Each generated document instance can incorporate not only customized field values but also AI-generated content that is tailored to specific contexts, audiences, or requirements. This combination of traditional merge functionality with generative AI capabilities enables organizations to create highly personalized documents at scale while maintaining consistency and quality.

This structured approach to mass personalization represents a significant advancement over traditional mail merge systems. Rather than being limited to simple text substitution, document authors can now define sophisticated transformation rules through action definitions, enabling context-aware content generation that adapts to specific recipient characteristics and document contexts. Embodiments of the present invention may support style and tone adaptations that modify the presentation and voice of content based on audience preferences or document requirements. Dynamic text transformations may enhance the system's capabilities by allowing real-time modification of content structure, format, and presentation during the merge process. The system may provide audience-specific content modifications that tailor messaging, terminology, and detail levels to match recipient demographics, preferences, or organizational contexts. Complex content restructuring may be supported, enabling the reorganization of information hierarchies, the reordering of content sections, and the adaptive formatting of document elements based on merge data characteristics and action definition specifications.

These capabilities enable a degree of document customization and personalization that was previously impossible with conventional mail merge systems, while maintaining the efficiency and scalability benefits of automated document generation.

Embodiments of the present invention may enable document authors to maintain precise control over document structure while allowing dynamic content generation through template-based structure control, action definition control, balanced automation, structured personalization, and multi-instance generation capabilities. The merge template 714 allows authors to explicitly define the structure and purpose of document elements, including where action definitions 108a-n, merge fields, and static content should appear within the document structure. This template-based approach gives authors full control over the document's organization and flow while enabling sophisticated content generation capabilities.

Authors may precisely specify how content should be generated through customizable action definitions 108a-n stored within the action definition library 106. These action definitions 108a-n determine how the text generation module 120 will generate content using language models, ensuring the generated text 122 aligns with the author's intent while still enabling personalization based on merge data 730. The system 700 may strike a balance between automation and control by allowing authors to define which elements remain static and which can be dynamically generated, enabling specification of transformation rules through action definitions 108a-n, maintaining consistent document structure across multiple generated instances, and supporting various levels of user involvement in the content generation process through the user interface 104.

Unlike traditional mail merge that only allows simple field substitution, or pure AI generation that may lack structure, embodiments of the present invention may enable structured personalization through context-aware content generation within author-defined boundaries, sophisticated text transformations that maintain document integrity, audience-specific modifications while preserving core message and structure, and dynamic content adaptation based on merge data 730. The document update module 124 may process the generated text 122 to ensure that transformations maintain the structural integrity defined by the merge template 714 while incorporating personalized content based on the specific merge data element 716 being processed.

Embodiments of the present invention may generate multiple document instances through the merged document 726, with each instance personalized through application of action definitions 108a-n with recipient-specific context, integration of merge data 730 for customization, maintenance of author-defined structure and purpose as specified in the merge template 714, and preservation of key messaging while allowing contextual adaptation. The action processor 112 coordinates the processing of multiple merge data elements to generate distinct document instances, each maintaining the structural control defined by the author while incorporating dynamic content generation capabilities that adapt to specific recipient contexts and requirements.

This approach uniquely combines the structural control of traditional mail merge with the personalization capabilities of AI, enabling authors to maintain control over their documents while leveraging sophisticated AI-driven content generation to meet reader needs.

Embodiments of the present invention enable large-scale structured personalization through the ability to process multiple sets of merge data to generate distinct document instances, while maintaining author-defined structure and control. The system 700 may process multiple sets of merge data within the merge data 730, with each set being used to generate a distinct instance of the merged document 726. This enables the creation of numerous personalized documents from a single merge template 714, analogous to traditional mail merge operations but with significantly enhanced capabilities through the integration of action definitions 108a-n and the text generation module 120.

For each document instance, the system 700 may maintain the author-defined template structure while applying action definitions 108a-n consistently across all generated documents. The action processor 112 may process merge fields with instance-specific data from the merge data 730, ensuring that each merged document 726 contains personalized information relevant to the specific recipient or context. The text generation module 120 may generate AI-driven content tailored to each specific context, utilizing the external data 128 to enhance the personalization capabilities. This structured control at scale enables organizations to maintain consistent document quality while providing individualized content for each recipient.

The system 700 may include optimizations for handling large-scale document generation through parallel processing of document instances, batch operations for efficient processing, performance optimizations for generating multiple documents, and systematic error handling across document instances. The action processor 112 may coordinate the processing of multiple merge data elements simultaneously, enabling efficient generation of large numbers of personalized documents. The document update module 124 may manage the integration of generated content across multiple document instances while maintaining consistent formatting and structure. These processing optimizations enable the system 700 to handle enterprise-scale document generation requirements while preserving the quality and personalization capabilities of individual document processing.

This approach enables organizations to generate large numbers of highly personalized documents while maintaining consistent structure, apply sophisticated AI-driven transformations across multiple document instances, ensure quality and consistency across all generated documents, and efficiently create customized content for different audiences or contexts. The merge template 714 provides the structural foundation that ensures consistency across all generated instances, while the action definitions 108a-n enable sophisticated content transformations that adapt to specific recipient characteristics or document requirements. The system 700 may achieve these capabilities through data structure enhancement to handle multiple data sets, iteration mechanisms for processing each data set, separate context management for each document instance, efficient output management for multiple documents, and enhanced error handling and validation across all instances.

This scalable approach combines the efficiency of traditional mail merge with the sophistication of AI-driven content generation, enabling organizations to create large numbers of personalized documents while maintaining author control and document integrity.

Embodiments of the present invention may seamlessly integrate advanced AI capabilities, particularly large language models (LLMs), into document creation workflows. This integration enables sophisticated text transformations and content generation within familiar document editing processes, significantly enhancing the document creation experience.

By incorporating action definitions that leverage LLMs and/or other forms of automated processing, embodiments of the present invention allow users to apply complex text transformations and generate context-aware content directly within the merge template. When processing an element identified as an action definition, the system may, for example, provide a prompt specified by the action definition to a large language model, generating output that is then inserted into the merged document.

This approach combines the power of AI-driven content generation with the familiarity of traditional document merge processes. Users can create merge templates that include not only conventional merge fields but also sophisticated AI-powered transformations, all within a single, cohesive workflow.

The integration of AI capabilities enhances the document creation process in several ways. For example, the integration may enable more dynamic and context-aware content generation, going beyond simple data insertion. The AI integration may allow for complex text transformations that would be difficult or time-consuming to perform manually. Embodiments of the present invention may maintain the efficiency and scalability of traditional merge operations while adding the flexibility and power of AI-generated content. These enhancements demonstrate how AI capabilities may be seamlessly incorporated into existing document workflows to provide expanded functionality without disrupting established processes.

By seamlessly incorporating these AI capabilities into familiar document editing processes, embodiments of the present invention significantly expand the possibilities for content creation and editing, allowing users to leverage advanced AI technologies without disrupting their existing workflows or requiring extensive training on new systems.

Embodiments of the present invention provide users with extensive flexibility in customizing and controlling the document generation process. The system may, for example, support varying degrees of user involvement, from fully automated processing to detailed interactive refinement, enabling users to tailor the document generation workflow to their specific requirements.

At the automated end of the spectrum, embodiments of the present invention may process merge templates and generate documents with minimal user intervention, applying action definitions and processing merge fields automatically to produce customized output. This automation enables efficient generation of multiple document instances while maintaining consistent quality and structure. For users requiring or desiring more control, embodiments of the present invention may support interactive refinement through selection and modification of action definitions, review and adjustment of generated content, fine-tuning of language model parameters, customization of processing workflows, and interactive preview and selection of content variations. The system 700 may provide flexible configuration options that allow users to determine the appropriate level of automation versus manual control for their specific document generation requirements. In some cases, users may choose to apply automated processing for routine document generation tasks while reserving interactive refinement capabilities for more complex or sensitive content creation scenarios. The document update module 124 may coordinate these various interaction modes to ensure that both automated and interactive workflows maintain document integrity and formatting consistency throughout the generation process.

This flexibility extends to both the template creation and document generation phases. During template creation, users can define custom action definitions, specify transformation rules, and establish document structure. During generation, users can choose their level of involvement in reviewing and refining the output, from accepting automated results to engaging in detailed content customization.

Embodiments of the system may support various user interaction levels through multiple implementation approaches. For example, the system may include customizable action definitions that can be modified to suit specific needs, enabling users to tailor the behavior of action definitions 108a-n within the action definition library 106 to match particular document processing requirements. The system may provide user-configurable processing parameters that allow adjustment of text generation module 120 operations, such as language model settings, output length constraints, or processing priorities. In some cases, interactive preview capabilities may be implemented to enable users to review generated text 122 before the document update module 124 applies changes to documents 110a-m. Embodiments may include multiple document instance management features that coordinate processing across numerous document versions or variations simultaneously. The system may incorporate flexible error handling and validation options that adapt to different user preferences and processing scenarios, ensuring robust operation across various use cases while maintaining document integrity throughout the content generation and revision process.

By supporting this range of user involvement, embodiments of the present invention enable organizations to balance automation efficiency with the need for precise control over document content and quality. This flexibility allows the system to adapt to different use cases, from high-volume automated document generation to carefully crafted, individually refined documents.

The various systems and methods disclosed herein may be implemented and/or executed across a plurality of computers and/or software modules in a variety of ways. Embodiments of the present invention may support distributed implementations where the user interface 104 may be implemented on the user's local computer while other components such as the action processor 112 may be implemented on one or more remote servers. Components may communicate across a network using APIs and other interfaces, and the system may support cloud-based implementations where generative processing happens server-side while conventional operations occur client-side.

Embodiments of the present invention may utilize modular architectures where functions can be performed by multiple modules in any combination, including separate software applications. Some functions may be performed by conventional components such as word processing applications while others are performed by specialized components such as plugins. The system may support hybrid approaches leveraging existing functionality while implementing novel features on top of established platforms.

Various implementation options may be employed across different deployment scenarios. Embodiments may include standalone applications with custom-implemented components for maximum control, plugins or extensions for existing software that use host application functions while implementing custom processing logic, cloud services with client-side clipboard operations and server-side generative processing, or mobile apps using device native APIs with custom user interface and processing logic. These implementation approaches may be selected based on specific deployment requirements and technical constraints.

Communication between system components may be facilitated through various methods depending on the implementation architecture. Standard operating system APIs may be used for basic operations, while event listeners may detect and respond to user actions. Custom clipboard formats may handle metadata transmission, and Inter-Process Communication (IPC) may coordinate between conventional and generative components. System-level hooks may provide deep integration capabilities where supported by the underlying platform.

Embodiments of the present invention may implement distributed architectures where various modules and operations are distributed across multiple computers to optimize performance and resource utilization. In a two-computer distribution configuration, the user interface 104 and basic operations may be implemented on a local computer, including document editing and selection capabilities, conventional copy and paste operations, and document display with basic editing functionality. The processing server in such configurations may handle the action processor 112 including language model operations, the text generation module for processing action definitions, and storage of the action definition library.

Three-computer distribution architectures may provide enhanced separation of concerns by implementing a local client that handles the user interface 104, document editing and display, and selection handling operations. An application server in such configurations may manage action processor 112 coordination, action definition management, and the document update module. The AI processing server may be dedicated to language model operations, text generation processing, and complex transformations that require significant computational resources. This separation enables specialized optimization of each component while maintaining system coherence across the distributed architecture.

Multi-server distribution configurations may implement even greater specialization through dedicated server roles. The local client may continue to handle the user interface 104 and document editing functions, while a template server manages storage and management of merge templates along with the action definition library. Processing servers may handle distributed language model processing and parallel processing of multiple document instances, enabling scalable operations across large document sets. A storage server may manage document storage and external data management, providing centralized data access while supporting distributed processing operations. These multi-server architectures enable embodiments of the present invention to scale efficiently while maintaining performance across complex document processing workflows.

The present disclosure provides a method performed by at least one computer processor executing computer program instructions stored on at least one non-transitory computer-readable medium. The method includes receiving a merge template comprising a plurality of elements. For each element in the plurality of elements, the method determines whether the element is an action definition. If the element is determined to be an action definition, the method applies the action definition to generate output, comprising providing a prompt specified by the action definition to a language model, and inserts the generated output into a merged document. If the element is not determined to be an action definition, then the method determines whether the element is a merge field. If the element is determined to be a merge field, the method obtains a value for the merge field and inserts the obtained value into the merged document. If the element is not determined to be a merge field, the method copies the element into the merged document.

In other embodiments, applying the action definition to generate output comprises providing merge data to the language model along with the prompt specified by the action definition. The method may further comprise repeating the method multiple times using different merge data to generate a plurality of merged documents.

In further embodiments, the generated output from applying the action definition comprises hybrid content that includes both static text and at least one additional action definition, and the method further comprises applying the at least one additional action definition to generate additional output. The method may further comprise providing structured output specifications to the language model alongside content generation requests to ensure the generated content includes both static text and dynamic elements in appropriate locations.

In additional embodiments, the merge template comprises a plurality of action definitions, and the method comprises applying a first action definition in the plurality of action definitions to generate first output and applying a second action definition in the plurality of action definitions to the first output to generate second output. The first action definition may appear at a first location in the merge template that is earlier than a second location of the second action definition, and the method may comprise executing the second action definition before executing the first action definition. The method may further comprise analyzing references between the plurality of action definitions to identify dependencies, building a dependency graph of action definitions, and determining an execution sequence that satisfies all dependencies.

In other embodiments, the action definition includes a tokenized prompt comprising at least one token that is replaced with a corresponding value during application of the action definition. The action definition may include an alternative take prompt comprising a plurality of component prompts, and applying the action definition comprises applying each component prompt in the plurality of component prompts to generate a corresponding plurality of output instances, selecting one of the plurality of output instances, and inserting the selected one of the plurality of output instances into the merged document.

The present disclosure also provides a system comprising at least one non-transitory computer-readable medium storing computer program instructions, wherein the computer program instructions are executable by at least one computer processor to perform the method described above. The system includes the same features and embodiments as the method, including applying the action definition to generate output by providing merge data to the language model along with the prompt specified by the action definition, repeating the method multiple times using different merge data to generate a plurality of merged documents, generating hybrid content that includes both static text and at least one additional action definition, providing structured output specifications to the language model, processing a plurality of action definitions with dependency analysis and execution sequencing, supporting tokenized prompts with token replacement, and handling alternative take prompts with multiple component prompts and output selection.

### Boilerplate

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may provide input to a language model, such as a large language model (LLM), to generate output. Such a function is inherently rooted in computer technology and cannot be performed mentally or manually. As another example, embodiments of the present invention may be used to automatically generate output using a language model, such as an LLM, and then to automatically update a computer-implemented document based on the output of the language model. As yet another example, embodiments of the present invention may be used to execute arbitrary scripts including conditional statements and loops. All of these functions are inherently rooted in computer technology, are inherently technical in nature, and cannot be performed mentally or manually. Furthermore, embodiments of the present invention constitute improvements to computer technology for using language models, such as LLMs, to generate improved output, and to generate such improved output more efficiently than state-of-the-art technology for the reasons provided herein.

The generative cut and paste features of embodiments of the present invention are necessarily rooted in computer technology, as they leverage computational capabilities to transform and manipulate digital content in ways that would be impossible or impractical to achieve through manual means. Key aspects that demonstrate the generative cut and paste features' inherent reliance on computer technology include:
Integration with Language Models: The generative cut and paste features may utilize large language models (LLMs) to process and generate text. These models, which can contain billions of parameters, require significant computational resources and are fundamentally tied to computer systems.
Real-time Content Processing: The generative cut and paste features perform complex text transformations during copy and paste operations in real-time, a feat that is only achievable through the use of advanced computer processing capabilities.
Dynamic Action Definitions: The generative cut and paste features support various types of action definitions, including tokenized prompts, compound prompts, and scripted prompts. These dynamic, programmable instructions are inherently computational in nature and rely on computer systems for execution and management.
Contextual Awareness: The generative cut and paste features' ability to consider the context of both source and destination documents during content transformation requires sophisticated data analysis and processing that can only be performed by computer systems.
Two-stage Processing: The generative cut and paste features' capability to perform separate generative processing during both copy and paste operations involves complex data handling and transformation that is uniquely suited to computer systems.
User Interface Integration: The seamless integration of AI-driven content manipulation within existing document editing interfaces requires intricate software engineering and is inherently tied to computer-based user interfaces.
Clipboard Management: The generative cut and paste features' ability to store and manage multiple versions of copied content (original and processed) in the clipboard is a function that relies on computer memory and data management systems.
Event-based Processing: The generative cut and paste features' ability to respond to various user inputs and trigger appropriate actions in real-time is rooted in event-driven programming paradigms specific to computer systems.

These features collectively demonstrate that the generative cut and paste features are not merely an automation of manual processes, but rather a novel system that is necessarily rooted in computer technology.

Furthermore, the generative cut and paste features of embodiments of the present invention represent a significant improvement to computer technology in several key aspects:
Enhanced Efficiency in Content Manipulation: The generative cut and paste features streamline the process of content transformation by integrating AI-driven processing directly into the familiar copy-paste workflow. This integration allows for complex content manipulations to be performed with minimal user input, significantly reducing the time and effort required compared to traditional methods.
Advanced Contextual Processing: The generative cut and paste features' ability to consider the context of both source and destination documents during content transformation represents a leap forward in intelligent content handling. This contextual awareness enables more relevant and coherent transformations, improving the quality of generated content in ways that were not previously possible with conventional copy-paste operations.
Flexible Two-Stage Processing: The generative cut and paste features' capability to perform separate generative processing during both copy and paste operations introduces a new level of flexibility in content manipulation. This two-stage approach allows for more sophisticated and nuanced transformations that can adapt to changing contexts between the source and destination documents.
Customizable AI Interactions: By supporting user-defined action definitions, ranging from simple prompts to complex scripted operations, the generative cut and paste features provide a level of customization in AI-assisted content manipulation that goes beyond what is typically available in existing technologies. This allows users to tailor the system's behavior to their specific needs and workflows.
Improved User Interface for AI Integration: The generative cut and paste features seamlessly integrate advanced AI capabilities into existing document editing interfaces, representing an improvement in how users interact with AI-assisted tools. This integration reduces the learning curve and cognitive load associated with adopting new AI technologies.
Enhanced Content Version Management: The generative cut and paste features' ability to maintain both original and processed versions of copied content in the clipboard represents an improvement in content version control within the copy-paste paradigm. This feature provides users with greater flexibility and safety in content manipulation.
Real-time Complex Text Transformations: The generative cut and paste features enable real-time processing of complex text transformations during copy and paste operations, leveraging advanced computational capabilities to perform tasks that would be impractical or impossible to achieve manually.
Scalable AI Integration: By building upon familiar copy-paste operations, the generative cut and paste features provide a scalable approach to integrating AI capabilities into document editing. This allows for gradual adoption of AI-assisted features, from simple transformations to complex, multi-step operations.

These improvements collectively enhance the capabilities of computer-based document editing systems, enabling more efficient, context-aware, and flexible content manipulation. The generative cut and paste features represent a significant step forward in integrating advanced AI technologies into everyday computing tasks, improving productivity and expanding the possibilities of digital content creation and editing.

The generative cut and paste features of embodiments of the present invention bring about a transformation of subject matter into a different state or thing in several significant ways:
Text Transformation: The generative cut and paste features transform selected text from its original form into a new, processed form through the application of AI-driven generative processing. This transformation may, for example, involve changes in content, style, tone, or structure of the text, effectively converting it from one state to another.
Clipboard Content Transformation: The generative cut and paste features transform the conventional clipboard content into processed clipboard content during the copy operation. This represents a change in the state of the clipboard data, from its original form to an AI-processed form.
Document Content Transformation: When the processed content is pasted into a document, it transforms the destination document's content, potentially altering its meaning, structure, or overall composition. This represents a transformation of the document from one state to another.
Multi-stage Transformation: The generative cut and paste features' two-stage processing capability allows for sequential transformations of content. The first transformation occurs during the copy operation, and a second transformation can occur during the paste operation. This multi-stage process can result in content that is significantly different from its original state.
Context-based Transformation: The generative cut and paste features' ability to consider the context of both source and destination documents during content transformation can result in adaptive changes to the text. This contextual transformation can produce content that is fundamentally different from the original, tailored to fit seamlessly into its new environment.
Non-contiguous Text Transformation: The generative cut and paste features allow for the selection and transformation of multiple non-contiguous blocks of text. This capability can result in the creation of new, coherent content from disparate parts of a document, effectively transforming disconnected text into a unified whole.
Format and Style Transformation: Through the use of custom action definitions, the generative cut and paste features can transform not only the content of the text but also its format and style. This can include changes in tone, formality, or even the conversion of text into different formats (e.g., from prose to bullet points).

These transformations demonstrate that the generative cut and paste features of embodiments of the present invention go beyond mere information transfer or simple text editing. Instead, they enable the creation of new content states and forms, representing a true transformation of subject matter from one state or thing into another.

Embodiments of the system 500 and method 600 transform subject matter into a different state or thing. For example, embodiments of the system 500 and method 600:
Text Transformation: The system transforms selected text from its original form into a new, processed form through AI-driven generative processing. This transformation may involve changes in content, style, tone, or structure of the text, effectively converting it from one state to another.
Document Content Transformation: When the processed content is pasted into a document, it transforms the destination document's content, potentially altering its meaning, structure, or overall composition. This represents a transformation of the document from one state to another.
Multi-stage Transformation: The system's two-stage processing capability allows for sequential transformations of content. The first transformation occurs during the copy operation, and a second transformation can occur during the paste operation. This multi-stage process can result in content that is significantly different from its original state.
Context-based Transformation: The system's ability to consider the context of both source and destination documents during content transformation can result in adaptive changes to the text. This contextual transformation can produce content that is fundamentally different from the original, tailored to fit seamlessly into its new environment.

These transformations demonstrate that embodiments of the system 500 and method 600 go beyond mere information transfer or simple text editing, enabling the creation of new content states and forms.

Embodiments of the system 500 and method 600 also solve problems necessarily rooted in computer technology and improves computer technology in several ways, such as:
Enhanced Efficiency in Content Manipulation: The system streamlines the process of content transformation by integrating AI-driven processing directly into the familiar copy-paste workflow. This integration allows for complex content manipulations to be performed with minimal user input, significantly reducing the time and effort required compared to traditional methods.
Advanced Contextual Processing: The system's ability to consider the context of both source and destination documents during content transformation represents a leap forward in intelligent content handling. This contextual awareness enables more relevant and coherent transformations, improving the quality of generated content in ways that were not previously possible with conventional copy-paste operations.
Flexible Two-Stage Processing: The capability to perform separate generative processing during both copy and paste operations introduces a new level of flexibility in content manipulation. This two-stage approach allows for more sophisticated and nuanced transformations that can adapt to changing contexts between the source and destination documents.
Customizable AI Interactions: By supporting user-defined action definitions, ranging from simple prompts to complex scripted operations, the system provides a level of customization in AI-assisted content manipulation that goes beyond what is typically available in existing technologies.
Improved User Interface for AI Integration: The system seamlessly integrates advanced AI capabilities into existing document editing interfaces, representing an improvement in how users interact with AI-assisted tools. This integration reduces the learning curve and cognitive load associated with adopting new AI technologies.
Real-time Complex Text Transformations: The system enables real-time processing of complex text transformations during copy and paste operations, leveraging advanced computational capabilities to perform tasks that would be impractical or impossible to achieve manually.

These improvements collectively enhance the capabilities of computer-based document editing systems, enabling more efficient, context-aware, and flexible content manipulation.

The generative drag operation disclosed herein may include one or more of the following features:
Improvement to Computer Technology: The generative drag operation may enhance existing drag-and-drop functionality in computer systems by incorporating real-time, context-aware text transformations. This represents a significant improvement over traditional drag-and-drop operations, which typically only move or copy content without modification.
Necessarily Rooted in Computer Technology: The operation may leverage advanced computational capabilities, such as real-time processing of complex text transformations and integration with large language models, which are inherently tied to computer technology. These features cannot be performed manually or mentally, making the generative drag feature necessarily rooted in computer technology.
Transformation of Subject Matter: The generative drag operation transforms the selected text from its original form into a new, processed form, such as by using AI-driven generative processing. This transformation may involve changes in content, style, tone, or structure of the text, effectively converting it from one state to another.
Real-time Processing and Feedback: The system's ability to perform complex text transformations in real-time during the drag operation and provide immediate visual feedback through previews demonstrates a level of processing speed and interactivity that is only achievable through advanced computer technology.
Context-aware Adaptations: The generative drag operation's ability to consider the context of both the current drag location and the final destination for selecting and applying appropriate transformations represents a sophisticated level of analysis and decision-making that goes beyond well-understood, routine, and conventional computer functions.
Integration of AI Capabilities: By seamlessly incorporating generative AI capabilities into familiar user interface paradigms, the generative drag operation represents a novel approach to human-computer interaction in document editing workflows.
Dynamic Multi-stage Processing: The generative drag operation's ability to perform separate generative processing during both the drag operation and at the final destination introduces a new level of flexibility in content manipulation that is uniquely suited to computer systems.

These features collectively demonstrate that the generative drag operation is not merely an abstract idea implemented on a computer, but a technological innovation that leverages advanced computational capabilities to provide a novel and useful tool for document editing. The operation's ability to dynamically transform content based on context, provide real-time feedback, and seamlessly integrate AI-driven processes into familiar user interactions represents a significant advancement in the field of computer-assisted document editing.

Embodiments of the generative merge feature provide specific technical improvements to computer-based mail merge systems. For example, embodiments of the generative merge feature may implement a novel technical architecture that enables sophisticated content generation during the merge process itself, rather than simply inserting static data into predefined fields. This may be achieved through action definitions embedded within merge templates that can trigger complex language model processing at precisely defined points during document generation.

The technical implementation of embodiments of the generative merge feature support distributed processing, in which merge template execution can occur across multiple computers—with template parsing and basic field substitution potentially occurring on a local machine while computationally intensive language model operations are performed on dedicated processing servers. This architecture enables efficient handling of complex merge operations across large document sets.

The system may improve traditional merge field substitution through, for example, one or more of the following technical mechanisms:
Converting static merge field data into dynamically generated content through AI processing
Enabling context-aware content generation based on multiple merge field values
Supporting compound transformations through multiple action definitions within a single template
Facilitating sophisticated template-driven content generation while maintaining precise structural control

These capabilities extend far beyond conventional mail merge systems by enabling dynamic content generation at arbitrary points within merge templates while preserving the efficiency and automation benefits of traditional merge processing. The result is a technically sophisticated system that maintains precise control over document structure while enabling powerful generative capabilities during the merge process itself.

Embodiments of the generative merge feature are fundamentally tied to and necessarily rooted in computer technology through their core technical architecture and processing capabilities. The system's ability to dynamically generate content during merge operations may use sophisticated computational resources and processing capabilities that can only be implemented through computer systems.

For example, the technical implementation of embodiments of the generative merge feature may use distributed computer processing architectures, in which merge template execution occurs across multiple computing devices. For example, while template parsing may occur on local machines, the system's language model operations may use dedicated processing servers with significant computational capacity. This distributed architecture may be valuable for handling the complex processing demands of generating dynamic content during merge operations.

Embodiments of the merge template processing system may implement technical mechanisms that can only exist in computer environments, such as any one or more of the following:
Template-driven execution of language model operations
Real-time content generation based on merge field data
Context-aware processing across multiple document instances
Coordinated processing across distributed computing resources

These capabilities extend far beyond manual document creation or traditional mail merge operations, involving sophisticated computational resources to execute complex language model operations while maintaining document structure and formatting. The system's ability to generate contextually appropriate content during the merge process itself is fundamentally dependent on computer implementation and processing capabilities.1

Furthermore, embodiments of the generative merge feature transform subject matter into different states through any of a variety of technical mechanisms during the merge process. The system transforms basic merge field data into generated content through a process that alters both the form and substance of the input data.

For example, at a first transformation stage, the system may convert static merge field values into dynamic inputs for content generation. These inputs may be processed using action definitions embedded in merge templates, transforming simple data points into contextual parameters that guide content generation. For example, customer demographic data might be transformed into tailored messaging parameters.

The second transformation may occur through language model processing, where these contextual parameters are transformed into newly generated content. This process converts abstract parameters into concrete text that is contextually appropriate for the specific document instance. The system may generate entirely new content that goes beyond the original merge field data, while maintaining document structure and coherence.

A third transformation may take place when multiple action definitions interact within a single template, enabling compound transformations where generated content from one section influences content generation in subsequent sections. This may create sophisticated content relationships that transform simple input data into complex, interconnected document elements.

Through these transformation stages, the system may convert basic merge data into dynamically generated content that is fundamentally different in both form and substance from the input data. The resulting document instances contain newly generated content that could not have been derived through simple field substitution, representing a true transformation of the source material into a different state.

Furthermore, embodiments of the generative merge feature solve specific technical problems in computer-based mail merge systems through concrete technical solutions. Traditional mail merge systems face significant technical limitations in their ability to generate dynamic, contextually appropriate content during the merge process, being restricted to simple field substitution that cannot adapt to different document contexts.

In contrast, embodiments of the generative merge feature solve this technical problem using a processing architecture that enables dynamic content generation during merge operations. By implementing action definitions within merge templates, the system can trigger language model processing at precisely defined points to generate contextually appropriate content based on merge field data. This technical solution enables the generation of sophisticated content while maintaining document structure and automation benefits.

The system may address scalability challenges through distributed processing capabilities where computationally intensive operations can be performed on dedicated servers while template parsing occurs locally. This architectural solution enables efficient processing of complex merge operations across large document sets while maintaining system performance.

The technical implementation solves coherence problems in generated content through multi-stage processing that enables any one or more of the following:
Dynamic content adaptation based on multiple merge field values
Context-aware generation that maintains document consistency
Compound transformations through multiple coordinated action definitions
Precise control over document structure during content generation

These solutions represent concrete technical improvements that transform the capabilities of computer-based merge systems. By enabling sophisticated content generation during the merge process itself, the system solves fundamental technical limitations of traditional merge operations while maintaining processing efficiency and document control.

The ability of embodiments of the present invention to automatically generate text and automatically revise documents represents a technological advancement that is necessarily rooted in computer technology and provides specific improvements to computer-based document editing systems. The system's ability to automatically generate text using large language models, present that text for user review, and implement approved revisions through a graphical user interface requires significant computational resources and processing capabilities that can only be implemented through computer systems.

The implementation provides concrete technical improvements through its processing architecture that enables dynamic content generation during document operations. By implementing action definitions that trigger language model processing at precisely defined points, the system can generate contextually appropriate content while maintaining document structure and automation benefits. This technical solution enables the generation of sophisticated content while preserving document organization and formatting.

Embodiments of the system address technical challenges through distributed processing capabilities where computationally intensive operations can be performed on dedicated servers while template parsing occurs locally. This architectural approach enables efficient processing of complex operations across large document sets while maintaining system performance. The technical implementation solves coherence problems in generated content through multi-stage processing that enables dynamic content adaptation, context-aware generation that maintains document consistency, and precise control over document structure during content generation.

Furthermore, embodiments of the invention transform subject matter into different states through technical mechanisms during processing. For example, such embodiments may transform basic input data into generated content through multiple transformation stages-converting static content into dynamic inputs for content generation, processing these inputs through language models to generate new content, and enabling compound transformations where generated content influences subsequent generation steps. Through these transformation stages, the system converts basic input data into dynamically generated content that is fundamentally different in both form and substance.

The user of graphical user interface implementations for reviewing and approving transformations represent concrete technical improvements that go beyond merely implementing abstract ideas on generic computer components. For example, embodiments of the present invention may provide real-time preview capabilities, enable comparison of multiple potential transformations, and maintain precise control over document updates through sophisticated user interaction mechanisms. This integration of AI capabilities into existing document editing workflows represents a significant technological advancement in computer-based content generation and revision.

These solutions represent concrete technical improvements that transform the capabilities of computer-based document systems. By enabling sophisticated content generation and revision through an automated yet user-controlled process, the system solves fundamental technical limitations of traditional document editing operations while maintaining processing efficiency and document control.

Branching features of embodiments of the present invention represent technological advancements that are necessarily rooted in computer technology and provide specific improvements to computer-based document editing systems. For example, the system's ability to generate and maintain complex multi-layer branches and trees of generated text, while enabling interactive navigation and selection of nodes, requires sophisticated computational resources and processing capabilities that can only be implemented through computer systems.

The implementation provides concrete technical improvements through its ability to process and maintain complex hierarchical relationships between generated outputs. The system can generate entire trees of content through successive transformations, with each node potentially building upon and refining content from previous nodes. This enables compound transformations where the context and content from earlier generations inform and enhance later content generation steps, requiring sophisticated computational processing to maintain these relationships and dependencies.

The system's technical architecture supports both explicit and implicit references between nodes in sequential transformations. Explicit references may include direct references to specific prior outputs, while implicit references encompass broader contextual references. This capability enables sophisticated multi-stage content generation where each stage can build upon and refine content created in earlier stages, representing a significant advancement in computer-based content generation.

The invention transforms information through multiple technical stages during branch processing. When applying an accepted node that exists multiple layers deep within a branch, the system processes the chain of transformations sequentially, with each node building upon previous transformations. This sequential processing enables compound transformations that would be impossible to implement manually, demonstrating the invention's fundamental reliance on computer technology.

The system's graphical user interface implementations for navigating and selecting nodes from complex output trees represent concrete technical improvements. These interfaces enable users to traverse complex branch structures, preview potential revisions, and select nodes at any depth while maintaining document coherence. The implementation supports both automated and interactive workflows through context-aware preview generation, real-time content manifestation, and flexible node selection mechanisms.

The branching features provide specific technical benefits through state-based revision management, where the system maintains both original and modified content while providing clear representation of current document state through selective rendering. This enables efficient tracking and management of multiple potential revisions without requiring direct modification of original content, representing a significant improvement in how computer systems handle document revisions.

These solutions represent concrete technical improvements that transform the capabilities of computer-based document systems. By enabling sophisticated branch generation, navigation, and selection while maintaining precise control over document structure and content relationships, the system solves fundamental technical limitations of traditional document editing operations while maintaining processing efficiency and document coherence.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by at least one computer processor executing computer program instructions stored on at least one non-transitory computer-readable medium, the method comprising:
(A) receiving a merge template comprising a plurality of elements;
(B) for each element in the plurality of elements:
(B)(1) determining whether the element is an action definition;
(B)(2) if the element is determined to be an action definition:
(B)(2)(a) applying the action definition to generate output, comprising providing a prompt specified by the action definition to a language model;
(B)(2)(b) inserting the generated output into a merged document;
(B)(3) if the element is not determined to be an action definition, then determining whether the element is a merge field;
(B)(4) if the element is determined to be a merge field:
(B)(4)(a) obtaining a value for the merge field;
(B)(4)(b) inserting the obtained value into the merged document;
(B)(5) if the element is not determined to be a merge field:
(B)(5)(a) copying the element into the merged document.

2. The method of claim 1, wherein applying the action definition to generate output comprises providing merge data to the language model along with the prompt specified by the action definition.

3. The method of claim 1, further comprising repeating the method multiple times using different merge data to generate a plurality of merged documents.

4. The method of claim 1, wherein the generated output from applying the action definition comprises hybrid content that includes both static text and at least one additional action definition, and further comprising applying the at least one additional action definition to generate additional output.

5. The method of claim 4, further comprising providing structured output specifications to the language model alongside content generation requests to ensure the generated content includes both static text and dynamic elements in appropriate locations.

6. The method of claim 1, wherein the merge template comprises a plurality of action definitions, and wherein the the method comprises:
applying a first action definition in the plurality of action definitions to generate first output; and
applying a second action definition in the plurality of action definitions to the first output to generate second output.

7. The method of claim 6, wherein the first action definition appears at a first location in the merge template that is earlier than a second location of the second action definition, and wherein the method comprises executing the second action definition before executing the first action definition.

8. The method of claim 7, further comprising analyzing references between the plurality of action definitions to identify dependencies, building a dependency graph of action definitions, and determining an execution sequence that satisfies all dependencies.

9. The method of claim 1, wherein the action definition includes a tokenized prompt comprising at least one token that is replaced with a corresponding value during application of the action definition.

10. The method of claim 1, wherein the action definition includes an alternative take prompt comprising a plurality of component prompts, and wherein applying the action definition comprises:
applying each component prompt in the plurality of component prompts to generate a corresponding plurality of output instances; and
selecting one of the plurality of output instances; and
wherein (B)(2)(b) comprises inserting the selected one of the plurality of output instance into the merged document.

11. A system comprising at least one non-transitory computer-readable medium storing computer program instructions, wherein the computer program instructions are executable by at least one computer processor to perform a method, the method comprising:
(A) receiving a merge template comprising a plurality of elements;
(B) for each element in the plurality of elements:
(B)(1) determining whether the element is an action definition;
(B)(2) if the element is determined to be an action definition:
(B)(2)(a) applying the action definition to generate output, comprising providing a prompt specified by the action definition to a language model;
(B)(2)(b) inserting the generated output into a merged document;
(B)(3) if the element is not determined to be an action definition, then determining whether the element is a merge field;
(B)(4) if the element is determined to be a merge field:
(B)(4)(a) obtaining a value for the merge field;
(B)(4)(b) inserting the obtained value into the merged document;
(B)(5) if the element is not determined to be a merge field:
(B)(5)(a) copying the element into the merged document.

12. The system of claim 11, wherein applying the action definition to generate output comprises providing merge data to the language model along with the prompt specified by the action definition.

13. The system of claim 11, wherein the method further comprises repeating the method multiple times using different merge data to generate a plurality of merged documents.

14. The system of claim 11, wherein the generated output from applying the action definition comprises hybrid content that includes both static text and at least one additional action definition, and wherein the method further comprises applying the at least one additional action definition to generate additional output.

15. The system of claim 14, wherein the method further comprises providing structured output specifications to the language model alongside content generation requests to ensure the generated content includes both static text and dynamic elements in appropriate locations.

16. The system of claim 11, wherein the merge template comprises a plurality of action definitions, and wherein the method comprises:
applying a first action definition in the plurality of action definitions to generate first output; and
applying a second action definition in the plurality of action definitions to the first output to generate second output.

17. The system of claim 16, wherein the first action definition appears at a first location in the merge template that is earlier than a second location of the second action definition, and wherein the method comprises executing the second action definition before executing the first action definition.

18. The system of claim 17, wherein the method further comprises analyzing references between the plurality of action definitions to identify dependencies, building a dependency graph of action definitions, and determining an execution sequence that satisfies all dependencies.

19. The system of claim 11, wherein the action definition includes a tokenized prompt comprising at least one token that is replaced with a corresponding value during application of the action definition.

20. The system of claim 11, wherein the action definition includes an alternative take prompt comprising a plurality of component prompts, and wherein applying the action definition comprises:
applying each component prompt in the plurality of component prompts to generate a corresponding plurality of output instances; and
selecting one of the plurality of output instances; and
wherein (B)(2)(b) comprises inserting the selected one of the plurality of output instances into the merged document.
